(19) United States
(12) Patent Application Publication
(10) Pub. No.: US 2003/0095421 A1
(43) Pub. Date: May 22, 2003

(54) Power factor correction circuit

(76) Inventors: Anatoly F. Kadatskyy, Odessa (UA); Yevgen V. Karpov, Odessa (UA); Vyacheslav Y. Soynikov, Odessa (UA); Naum I. Volovets, South San Francisco, CA (US)

Correspondence Address: Twin Oaks Office Plaza, Suite 112, 477 Ninth Avenue, San Mateo, CA, 94402-1854, US

(21) Appl. No.: 09/785,348

(22) Filed: Feb. 14, 2001

Related U.S. Application Data
(63) Continuation-in-part of application No. 09/578,180, filed on May 23, 2000, now Pat. No. 6,381,155.
(63) Continuation-in-part of application No. 09/677,717, filed on Sep. 30, 2000, now Pat. No. 6,341,076.

(51) Int. Cl. H02M 1/00

(52) U.S. Cl. 363/65

(57) ABSTRACT

A family of Power Factor Corrected switching type AC-DC power converters of multi-channel configuration and a method of efficient AC-DC power conversion are proposed. The overall power conversion process used in the traditional single-channel AC-DC power converter configuration designed for high power applications is subdivided into N>1 number of sub-processes of proportionally lower performance such that each power conversion channel delivers its 1/N-portion of power from the AC primary power source to the system load. Avoiding the high loss continuous current mode inherent in the usual single-channel configurations in traditional high power applications, the discontinuous or critical current mode is used within each power conversion channel. A power factor value, an efficiency of the power conversion process and a total amount of converted power increase proportionally to the number of power conversion channels combined. A multi-phase operation arrangement provides high quality continuous currents from the primary AC power source and to the system load. Utilizing the discontinuous current mode within each power conversion channel results in reduction of the voltage spikes and peak currents to which the switching devices are subjected to within conventional AC-DC power converters. Actively developing soft-switching zero-voltage-across/zero-current-through conditions while operating the power switching devices eliminates the power losses occurring during switching transitions. To provide efficient, power factor corrected operation of any number of power conversion channels combined, a single conventional PFC-controller is employed within a system control circuit. This may be of any existing design aimed to provide discontinuous, or continuous, or critical current mode within the traditional single-channel AC-DC power converter.

### RELATED APPLICATIONS AND/OR PRIORITY CLAIMS

This application is continuation-in-part and incorporates herein in its entirety U.S. patent application Ser. No. 09/578,180 filed May 23, 2000 entitled METHOD FOR CLUSTERIZED POWER SHARING CONVERSION AND REGULATION OF A PRIMARY POWER SOURCE WITHINA CONVERTING AND REGULATING POWER SUPPLY, AND SYSTEM, and U.S. patent application Ser. No. 09/677,717 filed Sep. 30, 2000 entitled LOSS REDUCTION CIRCUIT FOR SWITCHING POWER CONVERTERS, and claims any and all benefits and priorities of said earlier filings to which it is entitled therefrom.

### FIELD OF THE INVENTION

The present invention relates to electrical power conversion techniques, and, more specifically, to AC-DC power converters provided with active power factor correction circuits.

More particularly, the present invention relates to switching-mode AC-DC power converters which convert the power supplied by the alternating-current primary source to an output direct-current power with close-to-unity power factor.

### BACKGROUND OF THE INVENTION

It is well known in the power industry that for maximum efficiency any AC powered device should draw an AC current waveform that is strictly in phase with the supplied AC voltage. The AC power consuming loads should appear as a resistive impedance to the primary AC power source, i.e. the power factor should be equal to unity.

However, most AC power consuming loads depart from the ideal resistive impedance.

Instead, these loads exhibit reactive, i.e. inductive or capacitive, properties such that the AC current may be substantially out of phase with the AC voltage , thereby decreasing the power factor to less than unity.

In addition, most AC power consuming loads exhibit non-linear electrical properties which bring the non-linear and harmonic distortion of the AC current, such that both the AC current and AC voltage waveforms may substantially depart from pure sine-wave.

At higher power conversion frequencies, the problem of harmonic distortion becomes even more severe. The considerable EMI noise affects the electric devices connected into the power distribution system and causes undesirable heat dissipation within the metal parts, therefore, decreasing the overall power conversion efficiency, i.e. the power factor.

In general, for the AC systems, assuming that voltage and current are purely sinusoidal, the power factor value K_{PF} is defined as:

K_{PF}=P_{AC}/SAC, [1]

where: P_{AC} is true power

S_{AC} is apparent power

True power is defined as:

P_{AC}=U_{AC}I_{AC1} cos φ₁, [2]

where: U_{AC} is a RMS (root-mean-square) value for voltage produced by the AC primary source,

I_{A1} is a RMS value for first harmonic of current consumed,

φ₁ is a value for an angle of the phase-shift between the waveforms of the voltage supplied by the AC primary source and of the first harmonic of current consumed.

An absolute power consumed may be defined as:

$${S}_{A C} = {U}_{A C} \cdot {I}_{A C} = {U}_{A C} \sqrt{{I}_{A C}^{2} + {\sum }_{n = 1}^{∞} {I}_{ACn}^{2}} , \qquad [ 3 ]$$

where: I_{AC} is a RMS value for the current consumed,

I_{ACn} is a RMS value for an n-th harmonic of the current consumed.

Therefore, the power factor value may be defined as:

$${K}_{PF} = {I}_{AC1} \cdot cos {ϕ}_{1} / \sqrt{{I}_{AC1}^{2} + {\sum }_{n = 1}^{∞} \cdot {I}_{ACn}^{2}} . \qquad [ 4 ]$$

The sine-wave conformity of the current consumed may be evaluated by the distortion factor value K_{HF} that may be defined as:

$${K}_{H F} = {I}_{AC1}^{2} / \sqrt{{I}_{AC1}^{2} + {\sum }_{n = 1}^{∞} {I}_{ACn}^{2}} . \qquad [ 5 ]$$

Traditionally, AC power consuming devices were commonly designed to provide high values of power factor, i.e. the current consumed should not be substantially phase-shifted with respect to the voltage applied.

For example, in a device exhibiting inductive properties, a capacitor was added such that inductive and capacitive current components would compensate for each other.

However, the size and weight of the passive components traditionally employed for the correction of the power factor are proportional to the amount of power consumed.

Therefore, recently, a number of active techniques for Power Factor Correction have been proposed to eliminate the limits inherent in traditional approaches.

According to these techniques, a switching-mode AC-DC power converter including active power factor correction (APFC) should be incorporated into AC consuming devices.

However, in terms of total efficiency, the benefits gained by power factor improvement are negated by the core drawbacks inherent in conventional AC-DC power converters, i.e. substantial high frequency input and output ripple, and power losses caused by the switching transitions within the solid-state components.

These drawbacks increase proportionally to the amount of power drawn from the primary AC source. Therefore, in high power applications, losses caused by the AC-DC power converter may exceed the losses prevented by the improved power factor correction.

This is due to the fact, that the amount of power processed (as well as lost!) by the AC-DC power converter is proportional to its operational frequency.

Most common AC-DC power converter designs are based on a primary power storage inductor or transformer, at least one controllable power switch, at least one power blocking rectifier, and an output smoothing filter capacitor. However, these prior art designs appear with large numbers of parts of a substantial size, weight, volume and power loss, and with a limited power conversion density, i.e. ratio of the number of watts per cubic inch or in regards to the overall cost.

Attempts to increase the power conversion density by increasing the operational frequency have been ineffective. Primarily, because the proportional increase in power loss results in extensive heat dissipation which undermines component reliability.

Therefore, present state-of-the-art AC-DC power conversion techniques still exhibit the unavoidable constraints placed on efficient high power application development.

However, these are to be eliminated by the present invention in accordance with the following considerations. These are to be described with the Boost Converter Topology being chosen as an example to demonstrate the advantages of the present invention, although it is applicable equally to many other existing AC-DC power converter topologies.

Our first consideration concerns the reduction of the inherent power losses within the present state-of-the-art AC-DC converters comprising the switching-mode AC-DC power conversion channels.

It is known that increasing the operational frequency of AC-DC power conversion results in reduction of total weight, size and cost as well as an increase of the converted power density, i.e. number of watts per cubic inch.

However, the solid-state switches of the AC-DC power converters are subjected to high power losses as a result of being changed from one state to another (i.e. when the switch turns on or off). This is due to the simultaneous current-through it and voltage-across it. This results in excessive heat dissipation within the switch during the switching transitions.

For “off-on” transition the switching losses may be defined as:

Wₒₙ=0.5VₛₘIₛₘtₒₙ; [6]

for “on-off” transition the switching losses may be defined as:

W_{off}=0.5VₛₘIₛₘt_{off}; [7]

where: Vₛₘ is a voltage-across maximum value during the transition,

Iₛₘ is a current-through maximum value during the transition,

tₒₙ is a time-duration of the “off-on” transition,

t_{off} is a time-duration of the “on-off” transition.

The switching transition losses place substantial constraints on the potentially available performance rate of the existing AC-DC power converters where the bipolar junction transistors (BJT), the insulated gate bipolar transistors (IGBT) and the metal-oxide-semiconductor field-effect transistors (MOSFET) are used as the controllable power switches.

Fast switching speeds, low power gate drive and low on-state resistance of the MOSFETs have made them a popular choice. However, the MOSFETs exhibit a large drain-to-source capacitance Cₒₛₛ. It reduces the dV/dt factor on turn-off and minimizes the power loss at this transition, but increases power loss at the turn-on transition since the power stored in Cₒₛₛ is fully dissipated as heat within the MOSFET, which may be defined as:

Pₒₙ=0.5CₒₛₛV²f_{PS}, [8]

where: f_{PS} is a controllable power switch operation frequency value.

The output voltage of the boost converter is always higher than the peak value of the AC primary voltage, and would be typically between 300 and 400 volts. At these high voltage levels the switching transition losses are unavoidably great, and the voltage transients and the current spikes may well damage the solid-state semiconductor devices. For this reason, a fast-recovery blocking power rectifier is required. At a high operational frequency, a fast-recovery rectifier is subjected to substantial reverse-recovery current and, therefore, produces a significant reverse-recovery loss when operated under “hard-switching” conditions, i.e. when simultaneous overlapping of non-zero-voltage-across with non-zero-current-through during the switching transition.

Besides being galvanically non-isolated from the primary power source, the boost converters are quite sensitive to the reverse-recovery transients, which may destroy internal components. . As a result, the “hard-switched” AC-DC power converters are operated at relatively low switching frequencies.

To reduce switching transition losses while increasing the switching frequency and, therefore, to improve the efficiency of the AC-DC power conversion, a number of “soft-switching” techniques have been proposed within the prior art.

A “soft-switching” condition occurs when no voltage appears across the solid-state device and/or no current flows through it during the switching transition.

Turning the solid-state device into a conducting state at zero-voltage-across it (ZVS=Zero-Voltage-Switching) results in the elimination of two kinds of switching transition losses: the first is caused by the blocking power rectifier reverse-recovery loss as defined in [7] and the second is caused by the controllable power switch stray capacitance discharge as defined in [8].

Turning the solid-state device into a non-conducting state at zero-current-through it (ZCS=Zero-Current-Switching) results in an elimination of an inductively stored power loss which may be defined as:

P_{off}=0.5LIₛₘf_{PS}, [9]

where: L is the inductance value of the power storage inductor.

To reduce switching transition power losses within AC-DC power converters, the prior art utilized numerous passive, i.e. inductive and capacitive components only, and active, i.e. solid-state semiconductor devices and snubber circuits.

These optimally shape the operating point trajectories of the switching devices, i.e. adjust the shape-of-change of the voltage-across and of the current-through to minimize their overlap during the switching transition.

Passive snubbers are hardly attractive since the power absorbed within their passive components is dissipated as heat. Active snubbers are more efficient since the absorbed power may be re-circulated back to the primary source or forwarded to the load.

Shaping the operating point trajectories of the solid-state devices becomes extremely important with the increase of operational frequency, operational voltages and overall power conversion output.

As well as the power switches of the AC-DC power converters, the switching devices within prior art active snubbers are also subjected to power losses described in [6] and [7].

Minimizing these “snubber” losses is no less important a function both for the high and the low rates of power conversion since in the latter case the “snubber” losses may be of the same magnitude as the power conversion Output.

Our second consideration concerns increasing the total power conversion output.

To increase the power conversion density and the overall power conversion performance, a number of multiple converter topologies have been developed. These are power-sharing techniques utilizing the multiple arranged in-parallel AC-DC power converting units that are of a relatively small size. Each AC-DC converting unit delivers only a portion of the overall power. Moreover, it is cost effective to design and manufacture the standardized individual power converting units that may be combined into an array to feed a particular load, rather than to design and manufacture the specific AC-DC power converters to fit each application.

The power-sharing AC-DC power conversion system includes at least one primary AC power source, a multi-channel AC-DC power converter and a load. The multi-channel AC-DC power converters may be of any existing topology provided that it contains N>1 number of internal switching-mode power conversion channels. The early prior art designs provide a simultaneous operation of the paralleled power converting units. For a multi-channel AC-DC power converter this means that each internal channel delivers its 1/N-portion of power from the primary AC power source to a load in a synchronously coincidental (syn-phase) mode of operation, provided that all power conversion channels have a common operating frequency to trigger the power-on cycles.

In a syn-phase mode of power conversion, all internal channels operate synchronously and simultaneously to each other. This synchronous operation creates large current pulses. These current pulses create additional problems by introducing substantial input and output ripple. The ripple is caused by the simultaneous overlay of similar non-linear responses within corresponding circuits due to the non-linearity of any power conversion process.

Different multi-channel converter configurations introduce different ripple components. In the case of parallel combined inputs and outputs, the input and output currents are summed within the respective input and output circuits. The amplitude of the resultant primary source voltage drop increases proportionally to the N>1 number of combined inputs. The resulting input and output currents have N>1 times multiplied direct and ripple components as compared to the single power conversion channel.

In the case of series combined input and/or output power conversion channels circuits, the amplitude of the primary source voltage drop increases proportionally to the number of combined inputs. The resultant delivery voltage has N>1 times multiplied direct and ripple components as compared to the same single power conversion channel.

Another disadvantage of the syn-phased power conversion is very slow response to the changes in the load. The time required to respond to a change in the load is limited to no less than one switching frequency period. In addition, the rate of response of the feedback circuit used to control the power-on cycle interval is severely limited to avoid oscillations.

Therefore our third consideration concerns the quality of the totally processed power.

Since all power conversion channels of the system have a common operating frequency, it was considered reasonable to operate the individual channels with staggered timing their power-on cycles, i.e. in a multi-phase mode. In this way a power demand is also staggered over the time thus reducing the large input current pulses.

In a multi-phase mode all channels operate with their power-on cycles time-staggered such that there is a time displacement Δt_{dspl} interval between the start-on points of the sequential cycles.

Provided that all power conversion channels have the same operational frequency, the resultant input and output currents show substantial reduction of input and output ripple. Due to the non-coincidental overlap of similar non-linearities, summing the time-staggered 1/N-portions of converted power produces a filtering effect within the input and output circuits of the combined power conversion channels.

Since all power conversion channels are driven out-of-phase in respect to each other, their non-linear responses are superimposed in a non-simultaneous and non-coincidental order. The result is a staggered inter-related compensation of overlapped portions of non-linear responses. Such kind of overlay decreases the non-linearity of the summed current.

It is therefore considered inappropriate to increase the output power by increasing the number of parallel syn-phased power conversion channels since it produces a proportional increase of the input and output ripple components. However, increasing the number of multi-phased power conversion channels produces a substantial decrease of the input and output ripple components as compared with a single power conversion channel.

Our fourth consideration concerns the fact that recently a variety of specialized PFC-aimed controllers have been designed and manufactured to satisfy the need of the low-capacity AC-DC power conversion applications. According to the present invention, these may be used for the high power applications as well, thus eliminating the need to employ any nonstandard or custom-made devices.

In view of the discussed considerations, the present invention aims to eliminate the drawbacks and constraints persistent in the present state-of-the-art.

### SUMMARY AND ADVANTAGES OF THE INVENTION

The benefits of the proposed invention may be better disclosed through the appraisal of the present state-of-the-art power factor correction circuits.

FIG. 1 illustrates the circuit diagram of the prior art traditional full-bridge AC-DC rectifier.

The indexed structures to be considered are listed below:

10: a primary AC power source;

11: an input AC-DC rectifier;

14: a load;

17: an output smoothing filter.

The cited device operates in the following fashion:

The primary AC power source 10 supplies the u_{AC}(t) voltage of sine-wave shape to the input of the full-bridge AC-DC rectifier 11. The rectified voltage is then applied to the output smoothing filter 17 and the load 14, thus being transformed into the resulting output voltage u_{OUT}(t).

The shapes of the output voltage u_{OUT}(t) waveform and, most significantly, of the waveform of the i_{AC}(t) current consumed from the primary AC power source 10, substantially depend on the circuit design and the properties of the output smoothing filter 17 and the load 14, i.e. on the circuit impedance which is substantially capacitive in the discussed case.

Both the circuit design and the nature of the impedance involve non-linear electric phenomena within the circuit, thus producing its non-linear response to the AC power source together with a non-linear impact upon the AC power source.

As shown in FIG. 2, due to the non-linear response exhibited by the circuit design and its capacitive impedance, the shape of the time-scaled waveform of the i_{AC}(t) current differs drastically from the shape of the waveform of the u_{AC}(t) voltage.

Accordingly, the power factor is considerably less than 100%, i.e. considerably less than unity value.

Another prior art circuit design for the AC-DC power conversion is shown in FIG. 3 which illustrates the circuit diagram of single-channel switching-mode AC-DC power converter 100 of conventional boost topology comprising the means for an active power factor correction (APFC). Although many other existing converter topologies may be equally usable, the boost topology is the most applicable due to the simplicity of the design and better efficiency as compared with other topologies.

The indexed structures to be considered are listed below:

10: a primary AC power source;

11: an input AC-DC rectifier;

12: a single-channel DC-DC power converter;

14: a load;

17: an output smoothing filter;

20: an input noise inhibiting filter;

21: a current sensor;

22: a power storage inductor;

23: a controllable power switch;

24: a power blocking rectifier;

26: an active soft-switching conditioner;

27: a shunting rectifier;

28: a slope-shaping capacitor;

29: a damp/resonant choke;

30: a controllable commutating switch;

31: a separating rectifier;

100: an AC-DC power converter;

200: a control circuit;

201: an active power factor correction (APFC) controller.

The cited device operates in the following fashion.

The primary AC power source 10 supplies u_{AC}(t) voltage of sine-wave shape to the input of the full-bridge AC-DC rectifier 11 producing a rectified voltage u_{IN}(t) of half-sine-wave shape. The rectified voltage is then applied to the input of a single-channel DC-DC power converter 12.

The control circuit 200 operates the controllable power switch 23 by providing ON-OFF control signals for turning the switch into alternating closed/conducting and open/non-conducting states.

FIGS. 6(a,b) illustrate the nature of the operational cycle within the single-channel DC-DC power converter 12. It should be noted that the following illustration, in general, concerns a “continuous current mode” to be discussed in the later paragraphs.

In the quasi-steady state at some reference time, for example to, as shown in FIGS. 6(a,b), the controllable power switch 23 is closed/conducting, the power storage inductor 22 is connected across the input AC-DC rectifier 11, the power blocking rectifier 24 is non-conducting while being reverse-biased by the voltage stored across the output smoothing filter 17, therefore the load 14 is disconnected from the input AC-DC rectifier 11 and is powered by the energy stored within the output smoothing filter 17.

While the input voltage u_{IN}(t) of the input AC-DC rectifier 11 is applied across the power storage inductor 22, the current i₂₂(t) through it increases in a linear fashion and, thus accumulating the magnetically stored energy within the power storage inductor 22, reaches its maximum value i₂₂ₘₐₓ at time t₀₁. Therefore, the power storage inductor 22 absorbs the input current during the absorption time interval t_{ABS}=t₀₁−t₀.

Then the controllable power switch 23 is turned into open/non-conducting state, the power blocking rectifier 24 turns into forward-biased/conducting state, and the energy magnetically stored within the power storage inductor 22 is transferred via the power blocking rectifier 24 to the output smoothing filter 17 and to the load 14. The current i₂₂(t) through the power storage inductor 22 starts decreasing in a linear fashion and reaches its minimum value i₂₂ₘᵢₙ by the end of operational cycle at time t₀₂. Therefore, the power storage inductor 22 releases the magnetically stored energy during the release time interval t_{RLS}=t₀₂−t₀₁.

Subsequently the operational cycle is re-started.

To start the next operational cycle the controllabe power switch 23 is turned into closed/conducting state again thus reverse-biasing the power blocking rectifier 24.

The controllable power switch operating frequency f_{PS} of the single-channel DC-DC power converter 12 is many times higher than the frequency f_{AC} of the AC voltage provided by the AC primary source 10.

Therefore, during the interval 0.5T_{AC} attributed to the half-sine-wave of the rectified voltage u_{IN}(t) the single-channel DC-DC power converter 12 performs a series of operating cycles.

FIGS. 4(a,b,c) illustrate the time-scaled waveforms of the discussed phenomena, thus illustrating the nature of the high-frequency AC-DC conversion process performed by the cited device.

During every operational cycle the single-channel DC-DC power converter 12 absorbs a portion of current i_{ABS}(t) from the primary AC power source 10 via the input AC-DC rectifier 11, and then releases an accumulated portion of energy as a release current i_{RLS}(t) delivered to the load 14. Both the i_{ABS}(t) and i_{RLS}(t) currents sequentially follow through the power storage inductor 22 thus producing a resultant waveform of the current i₂₂(t).

During the interval 0.5T_{AC} attributed to the half-sine-wave of the rectified voltage u_{IN}(t) the summed portions of currents i_{ABS}(t) and i_{RLS}(t) produce an integrated waveform of the average value of i_{ACav}(t) current consumed from the primary AC power source 10.

To provide a high power factor value, the control circuit 200 incorporates an active power factor correction (APFC) controller 201 producing a u₂₀₁(t) ON-OFF control signal, shown in FIGS. 4(a,b,c), to operate the controllable power switch 23.

An ON-state duration of the u₂₀₁(t) ON-OFF control signal is equal to t_{ABS} absorption time interval corresponding to the conducting state of the controllable power switch 23 while the power storage inductor 22 accumulates the power absorbed from the AC primary power source 10 via the input AC-DC rectifier 11.

The time interval T_{PS}, i.e. the controllable power switch operating period, between the leading edges of the sequential ON-state pulses of the u₂₀₁(t) ON-OFF control signal is a period of the controllable power switch operation frequency f_{PS}, i.e. T_{PS} is the operating cycle period.

According to the teaching of the art, there may be three main modes of the current flow within the power storage inductor 22.

A discontinuous current mode is illustrated in FIG. 4(a).

Its emphasis is that the current i₂₂(t) within the power storage inductor 22 is equal to zero-value in the quasi-steady state prior to any reference time t₀ corresponding to the leading edge of any u₂₀₁(t) sequential pulse, as shown in FIG. 4(a), and reaches its zero-value at any reference time t₀₂ prior to any reference time t′₀ of the next operational cycle, i.e. prior to the leading edge of the u₂₀₁(t) successive ON-state pulse.

Therefore, in the discontinuous current mode, a pause interval t_{PAU}=t′₀−t₀₂ of zero-current exists.

During the absorption time interval t_{ABS}=t₀₁−t₀ the power storage inductor 22 absorbs the input current i_{IN}(t) from the input AC-DC rectifier 11, thus the current i₂₂(t) increases.

According to the teaching of the art, such a state is ascribed with an “absorption factor” K_{ABS}:

K_{ABS}=t_{ABS}/T_{PS}. [10]

During the release time interval t_{RLS}=t₀₂−t₀₁ the power storage inductor 22 releases its magnetically stored energy, thus the current i₂₂(t) decreases.

According to the teaching of the art, such a state is ascribed with a “release factor” K_{RLS}:

K_{RLS}=t_{RLS}/T_{PS}. [11]

During the pause time interval t_{PAU}=t′₀−t₀₂ the power storage inductor 22 is current-free.

According to the teaching of the art, such a state is ascribed with a “pause factor” K_{PAU}:

K_{PAU}=t_{PAU}/T_{PS},

0<K_{PAU}<1. [12]

Referring to FIG. 4(a), it is evident that:

t_{ABS}+t_{RLS}+t_{PAU}=T_{PS}, [13]

and:

K_{ABS}+K_{RLS}+K_{PAU}=1. [14]

A critical conduction mode is illustrated in FIG. 4(b).

Its distinguishing feature is that the current i₂₂(t) within the power storage inductor 22 is equal to zero-value in the quasi-steady state at any reference time t₀, as shown in FIG. 4(b), and reaches its zero-value at any reference time t₀₂ coincidental to the reference time t′₀ of the next operating cycle such that no pause time interval t_{PAU} of zero-current exists.

Therefore, at time t₀₂=t′₀ the current i₂₂(t) starts to increase again. A continuous current mode is illustrated in FIG. 4(c).

Its distinguishing feature is that the current i₂₂(t) within the power storage inductor 22 may not be equal to zero-value in the quasi-steady state prior or at any reference time t₀, as shown in FIG. 4(c), and may not reach its zero-value at any reference time t₀₂ coincidental to the reference time t′₀ of the next operating cycle such that a non-zero current i₂₂(t) may exist during the sequential operating cycles, i.e. during the sequential T_{PS} periods.

Referring to FIGS. 4(b,c), it is evident that there is no pause interval t_{PAU} both in the critical and the continuous current modes, i.e.:

t_{PAU}=0, K_{PAU}=0,

therefore:

K_{ABS}+K_{RLS}=1

The illustrations provided in FIGS. 4(a,b,c) propose a conclusion that, to the distinction of the circuit design shown in FIG. 1, in the latter case the power factor and the shape of the integrated waveform of the average value of i_{ACav}(t) current consumed from the primary AC power source 10 do not depend substantially on the properties of the output smoothing filter 17 and the load 14. These depend mostly on the AC input properties of the AC-DC power converter 100 as related to the AC primary power source 10.

It is evident that monitoring the duration of the T_{PS}, t_{ABS}, t_{RLS} and t_{PAU} intervals, i.e. operating the controllable power switch 23 in an appropriate fashion provides an opportunity to shape the integrated waveform of the average value of i_{ACav}(t) current proportionally and synchronously to the u_{AC}(t) voltage provided by the AC primary power source 10, thus bringing the power factor very close to the unity value.

However, the switching-mode process of power conversion results in substantial input and output ripple reducing the value of the power factor. To inhibit the ripple sufficiently, the filtering components must be of a substantial size and weight.

It is evident that an increase of the controllable power switch operation frequency f_{PS} may result in reduction of the ripple and, therefore, in reduction of the filtering components size and weight.

However, an increase of the controllable power switch operating frequency f_{PS} results in an increase of the switching transition power losses in accordance with [6] and [7].

The previous discussion may be true for an ideal case only when the on/off-turn transition time of the controllable power switch 23 and of the power blocking rectifier 24 may be considered negligibly short in comparison with the operating cycle duration.

Under real circumstances, the semiconductor devices exhibit inertia properties as a result of the residual stored charge, parasitic capacitance, etc.

As an example, the excessive carriers within the base of the power blocking rectifier 24 cannot dissipate immediately after the power blocking rectifier 24 having been reverse-biased thus resulting in a short-time loss of its rectifying properties.

This leads to an excessive reverse current and an excessive heat dissipation within the power blocking rectifier 24 due to a large reverse voltage drop across it, and to an excessive current stress through the controllable power switch 23 during its turn-on transition due to discharging the capacitor within the output smoothing filter 17 through the effective short-circuit of rectifier 24.

Power blocking rectifier 24 regains its reverse blocking capability only after the excess carriers in its base have dissipated.

Therefore the amount of switching losses within the controllable power switch 23 and the power-blocking rectifier 24 substantially depends on the excessive carriers dissipation time.

The fact that the switching power losses restrict the maximum operating frequency and power factor improvement, constitutes the first substantial drawback of the prior art to be eliminated by the present invention.

To minimize switching transition power losses, a variety of the “soft-switching” conditioning or “snubber” circuitry has been proposed within the prior art, such as one of them shown in FIG. 3 with an index 26.

The purpose of incorporating an active soft-switching conditioner 26 into the DC-DC power converter 12 is to provide the zero-voltage-across condition to the controllable power switch 23 during its transition into the conducting state, and to limit the rate-of-change of the current through the blocking power rectifier 24 during its transition into the non-conducting state.

To secure the reliable soft-switching conditioning, the APFC controller 201 produces a ZV(t) (zero-voltage-condition) ON-OFF control signal to operate the controllable commutating switch 30 in an appropriate fashion.

As a result, incorporating the active soft-switching conditioner 26 into conventional boost converter configuration substantially improves its efficiency due to the reduction of the switching transition power losses within the controllable power switch 23 and the power-blocking rectifier 24.

However, when the continuous current mode is secured within the power storage inductor 22, the controllable commutating switch 30 operates under hard-switching condition since it is turned-off into the non-conducting state while carrying a current greater than the input current, and subsequently turned-on into conducting state while the voltage across it is equal to the output voltage. Since, to satisfy the zero-voltage soft-switching condition for the controllable power switch 23, the peak resonant current within the damp/resonant choke 29 may be twice greater as within the power storage inductor 22, then tuning-off the controllable commutating switch 30 into the non-conducting state is accomplished with a considerable power loss.

It should be emphasized that the damp/resonant choke 29 and the controllable commutating switch 30 are the main components of the active soft-switching conditioner 26. These are common to every soft-switching conditioning circuit.

The nodes of the active soft-switching conditioner 26, as shown in FIG. 3, are connected across the controllable power switch 23 and across the power-blocking rectifier 24.

With the active soft-switching conditioner 26 being incorporated into the DC-DC power converter 12 maintaining the continuous current mode within the power storage inductor 22 its operation is as follows being accompanied with the illustrations shown in FIG. 4(d).

In the quasi-steady state prior to time t₁ the controllable power switch 23 is open/non-conducting; the power blocking rectifier 24 is forward-biased/conducting thus providing the power path from the AC primary power source 10 and from the power storage inductor 22 to the output smoothing filter 17 and the load 14. The controllable commutating switch 30 within the active soft-switching conditioner 26 is open/non-conducting.

The regulated output DC voltage U_{OUT} is applied across the controllable power switch 23 shunted with the slope-shaping capacitor 28.

At time t₁ the leading edge of the U_{ZVT-201}(t) ON-state pulse triggers the controllable commutating switch 30 into the closed/conducting state, and now the regulated output DC voltage U_{OUT} is applied across the network of series-connected power blocking rectifier 24 and a damp/resonant choke 29.

Now the power blocking rectifier 24 is still forward-biased/conducting, the controllable commutating switch 30 is also conducting since being closed, and, with assumption that forward voltage drops across each of them may be neglected, the regulated output DC voltage U_{OUT} is therefore applied across the damp/resonant choke 29 ascribed with a current i₂₉(t).

The current i₂₉(t) through the damp/resonant choke 29 starts increasing at the rate of:

di₂₉dt=−U_{OUT}/L₂₉ [15]

where: L₂₉ is an inductance value of the damp/resonant choke 29.

The rate of current i₂₉(t) increase defines the rate of the simultaneous decrease of the current i₂₄₍t) carried by power blocking rectifier 24, thus resulting in dissipation of the excessive carriers within its base. Therefore, the damp/resonant choke 29 performs a damping function while defining the rate of dissipation of the excessive carriers within the base of the power rectifier 24.

With an appropriate choice of the inductance value L₂₉, it is possible to decrease the power losses associated with switching the power blocking rectifier 24 into the reverse-biased/non-conducting state.

The current i₂₉(t) would proceed undergoing its own way according to [15] well past the current i₂₄(t) falling down to zero at time t₂, i.e. i₂₄(t₂)=0.

The time interval t_{diss24} of the excessive carriers dissipation within the base of the power rectifier 24 may be defined as:

t_{diss24}=i₂₂ₘₐₓL₂₉/U_{OUT}, [16]

When the excess carriers within the base of the power rectifier 24 have dissipated, its reverse blocking capability is restored. During the reverse resistance recovery process the power rectifier 24 carries a reverse recovery current.

After that, at time t₃ the power blocking rectifier 24 becomes reverse-biased/non-conducting and disconnects the load 14 from the power storage inductor 22 and the primary AC power source 10.

Since prior to time t₃ the power blocking rectifier 24 has been conducting, the voltage across the controllable power switch 23 and across the slope-shaping capacitor 28 within the active soft-switching conditioner 26 is still very close to the U_{OUT} level.

Past time t₃ the on-going process is defined by the LC-resonant tank consisting of parallel-connected damp/resonant choke 29 and the slope-shaping capacitor 28 within the active soft-switching conditioner 26. Current i₂₉(t) continues to increase which results in decrease of the voltage applied across the controllable power switch 23 and across the slope-shaping capacitor 28:

i₂₉(t)=i₂₂(t₃)+i₂₄(t₃)−C₂₈dU₂₈/dt,

u₂₃(t)=u₂₈(t)=L₂₉di₂₉/dt, [17]

where: i₂₂(t₃) is the value of current carried by the power storage inductor 22 at time t₃;

i₂₄(t₃) is the value of current carried by the power rectifier 24 at time t₃ of its tum-off/non-conducting.

Respecting the component parameters of the active soft-switching conditioner 26 the equation [17] may be regarded as:

i₂₉(t)=i₂₂(t₃)+i₂₄(t₃)−U_{OUT} sin ω₀t/(L₂₉/C₂₈)^{0.5},

u₂₈(t)=U_{OUT} cos ω₀t, [18]

where: ω₀=(L₂₉C₂₈)^{0.5} is a natural resonant frequency of the LC-tank consisting of the damp/resonant choke 29 coupled to the slope-shaping capacitor 28;

C₂₈ is a capacitance value of the slope-shaping capacitor 28.

The sine waveform of the current through the damp/resonant choke 29 and the cosine waveform of the voltage across the slope-shaping capacitor 28 would last until time t₄, when the voltage u₂₃(t))=u₂₈(t) across this capacitor and across the controllable power switch 23 reaches zero and the shunting rectifier 27 becomes forward-biased/conducting.

Therefore during the interval between time t₃ and time t₄ the damp/resonant choke 29 performs a resonant inductor function within the L₂₉C₂₈ resonant tank. During this interval the cosinusoidal fashion of discharging the capacitor 28 within the active soft-switching conditioner 26 is provided as a preparation for switching the controllable power switch 23 into closed/conducting state under zero-voltage-across condition past time t₄.

The duration of the preparation time interval is defined with a quarter of the period of the natural resonant frequency of LC-tank consisting of the damp/resonant choke 29 coupled to the slope-shaping capacitor 28, i.e.:

t₄−t₃=0.5 π(L₂₉C₂₉)^{0.5} [19]

Starting from time t₄, the controllable power switch 23 may be turned into the closed/conducting state under zero-voltage-across condition at any time prior to the controllable commutating switch 30 being turned into the open/non-conducting state.

Therefore, the favorable condition of soft-switching is provided to the controllable power switch 23 by time t₅ when it is triggered into the closed/conducting state with a leading edge of the u₂₀₁(t) ON-state pulse, and the absorption time interval t_{ABS} starts. Thus, an advance time interval t_{A}=t₅−t₁ should be provided for turning the controllable commutating switch 30 into the closed/conducting state prior to the controllable power switch 23 being turned into the closed/conducting state.

The absorption time interval t_{ABS} lasts till time t₇ when the controllable power switch 23 is triggered into the open/non-conducting state.

Since being previously discharged to zero, the slope-shaping capacitor 28 pulls the voltage stress off the controllable power switch 23 thus providing the soft-switching zero-voltage-across condition.

Meanwhile, turning the controllable commutating switch 30 into open/non-conducting state at time t₆ produces substantial switching losses.

At time t₆ the current through the controllable commutating switch 30 reaches its maximum value defined as:

i₂₉ₘₐₓ(t₆)=i₃₀ₘₐₓ(t₆)=i₂₂ₘₐₓ(t₆)+i₂₄(t₆)+u₂₈ₘₐₓ(t₆)/(L₂₉/C₂₈)^{-0.5}, [20]

where: u₂₈ₘₐₓ=U_{OUT} is a maximum value of the voltage across the slope-shaping capacitor 28.

Therefore, the maximum values of currents flowing through the components of the active soft-switching conditioner 26 exceed the maximum value of current i₂₂ₘₐₓ flowing through the power storage inductor 22.

The fact that in the continuous current mode within the power storage inductor 22 the components of any active soft-switching conditioner are subjected to substantial electric stress and power losses exhibits second substantial drawback of the prior art to be eliminated by the present invention.

Moreover, the choice of the inductance value L₂₉ depends on the properties of the power-blocking rectifier 24 and on its reverse recovery time. Employing the low-frequency, i.e. so-called “slow” rectifiers would result in increase of the inductance value L₂₉, therefore, in increase of the stored (and lost!) energy within the damp/resonant choke 29, in increase of the duration of the closed/conducting state of the controllable commutating switch 30.

Further, in a continuous current mode the duration of the switching transitions within the power-blocking rectifier 24 depends on the carried current.

Therefore, to reduce the impact of the carried current variations upon the switching transition losses, the control circuit should comprise the means to monitor and control the zero-voltage-switching conditions.

The current mode chosen for the power carrying components of the AC-DC converter depends on the output power draw demand.

The discontinuous current mode is chosen usually for the low output power applications.

Nevertheless, due to the pause interval t_{PAU} it features some important advantages as compared with the continuous current mode. These are as follows:

the controllable power switch 23 may be turned into the closed/conducting state under the zero-current-through condition since the power storage inductor 22 is current-free during the pause interval tPAU;

the power blocking rectifier 24 recovers its reverse resistance under the low rate-of-change of the current through it;

the components of the active soft-switching conditioner 26 are subjected to less switching transition stresses;

the total switching transition power losses are relatively low.

Setting the discontinuous current mode within the unitary DC-DC power converter 16 provides zero-current-through condition to the power storage inductor 22 and the power blocking rectifier 24 by the time of turning the controllable power switch 23 into closed/conducting state.

As a result, the maximum values of currents flowing through the components of the active soft-switching conditioner 26, i.e. through the damp/resonant choke 29 and the controllable commutating switch 30 are defined only by the properties of the LC-tank L₂₉ C₂₈:

i₂₉ₘₐₓ=i₃₀ₘₐₓ=u₂₈ₘₐₓ/(L₂₉/C₂₈)^{-0.5}. [21]

Besides, due to the fact that in the discontinuous current mode the reverse recovery loss is expired, the “discontinuous” circuit is less sensitive to the impact of the carried current variations.

Thus, the need to monitor and control the zero-voltage-switching conditions is expired, and the overall control circuitry is substantially simplified.

The listed above important advantages of the discontinuous current mode are employed by the present invention.

However, increasing the output power draw in the discontinuous current mode results in substantial increase of the ripple and, therefore, decrease of the power factor.

The critical current mode features the same drawbacks as the discontinuous current mode.

These facts exhibit third and fourth substantial drawbacks of the prior art to be eliminated by the present invention.

For the high output applications the continuous current mode is used by the prior art designs.

It may provide substantially higher quality of the converted power draw, i.e. the close-to-zero ripple and the close-to-unity power factor.

However, in this case the prior art AC-DC converter feature all the switching transition drawbacks as above described.

Besides, operating the AC-DC converter in the continuous current mode needs more complicated and expensive control circuit 200 as well as a high value of inductance for the power storage inductor 22.

This fact exhibits fifth substantial drawback of the prior art to be eliminated by the present invention.

The main, i.e. sixth substantial drawback of the prior art to be eliminated by the present invention is exhibited by the fact that all listed above drawbacks joined in common unbreakably limit an increase of the converted power draw.

To increase the output power draw the multiple converter topology may be proposed.

FIG. 5 illustrates a schematic circuit diagram of a switching-mode AC-DC converter of the modular multi-channel architecture.

The structures to be considered are listed below:

10: a primary AC power source;

11: an input AC-DC rectifier;

12: a multi-channel DC-DC power converter;

14: a system load;

16: a unitary DC-DC power conversion channel;

17: a system output smoothing filter;

20: a channel input noise inhibiting filter;

22: a power storage inductor;

23: a controllable power switch;

24: a power blocking rectifier;

While discussing the operation of the cited device, the further advantage employed by the present invention will be discussed through a comparative appraisal of the syn-phased versus multi-phased modular power conversion systems.

As shown in FIG. 5, the multi-channel DC-DC power converter 12 contains N>1 number of unitary DC-DC power conversion channels 16, which are sequentially indexed as 16(1), . . . ,16(k), . . . ,16(N). Each unitary DC-DC power conversion channel 16(k) consumes and delivers only a 1/N-portion of the overall power draw.

FIGS. 6(a,b) illustrate the nature of the power conversion process within the DC-DC power converter 12 containing N=1 number of unitary DC-DC power conversion channels 16. It is the same as above described for the single-channel DC-DC power converter 12.

It is evident that for satisfying the overall power draw demand in case of N=1, the components of the unitary DC-DC power conversion channel 16 should be performed of a considerably big size, weight and current carrying capability. The current commutating devices should withstand the maximum values of current delivered to the system load 14 as well as the huge electrical stresses.

In case of N>1 number of the unitary DC-DC power conversion channels 16(k) the components of each may be performed of a relatively small size, weight and of less current carrying capability.

The maximum values of currents delivered via the commutation devices as well as the degree of electrical stresses are also correspondingly reduced.

Accordingly, the overall power draw conversion process should be subdivided into N>1 number of unitary sub-processes of the proportionally less performance each, i.e. 1/N-portion, and of the same nature as illustrated in FIGS. 6(a,b).

In FIG. 5 the unitary DC-DC power conversion sub-processes are ascribed with the input currents i₂₂₍ₖ₎(t) being absorbed by power storage inductors 22(k) within the corresponding unitary DC-DC power conversion channels 16(k), and with output currents i₂₄₍ₖ₎(t) being delivered to the system load 14 via the corresponding power blocking rectifiers 24(k).

In a syn-phased system all unitary DC-DC power conversion channels 16(k) operate synchronously and simultaneously to each other, i.e. each unitary DC-DC power conversion channel 16(k) delivers its 1/N-portion of power from the AC primary power source 10 and the input AC-DC rectifier 11 to a system load 14 in a synchronously coincidental (syn-phase) fashion. The syn-phased operation also assumes that all unitary DC-DC power conversion channels 16(k) have common operating frequency of the power-on cycles.

In the case of in-parallel combined inputs and outputs, as shown at FIG. 5, the input i₂₂₍ₖ₎(t) and output i₂₄₍ₖ₎(t) currents are summed within respective input and output circuits, i.e. the total i_{Σ22}(t) amount of current consumed from the primary AC power source 10 may be regarded as:

$${i}_{\sum 22} ( t ) = {\sum }_{k = 1}^{N} {i}_{22 ( k )} ( t ) , \qquad [ 22 ]$$

and the total i_{Σ24}(t) amount of current delivered to the system load 14 may be regarded as:

$${i}_{\sum 24} ( t ) = {\sum }_{k = 1}^{N} {i}_{24 ( k )} ( t ) \qquad [ 23 ]$$

As shown in FIG. 6(a,b), the resultant consumption i_{Σ22}(t) and delivery i_{Σ22}(t) currents have N>1 times multiplied direct I_{Σ22}, I_{Σ24} and ripple ΔI_{Σ22}, ΔI_{Σ24} constituents as compared with those of the single unitary DC-DC power conversion channel, i.e. indexed as i_{1/N}.

As related to the primary AC power source 10 and to the system load 14, the syn-phased multi-channel DC-DC power converter 12 features the same electrical properties as the single-channel DC-DC converter of an equal performance but made of components of a large size, weight and power carrying capacity.

The main drawback of the syn-phased power conversion systems is that the coincidental operation of the unitary channels creates large instantaneous power draws and large drops in the voltage of the primary power source with the substantial input and output ripple. The amplitude of the resultant primary source voltage drops increases proportionally to the number of the combined inputs. The ripple is caused by the simultaneous overlay of similar non-linear responses from all conversion channels. This is due to the non-linearity of any power conversion process.

Therefore, this drawback would be eliminated by the present invention.

In a multi-phase mode of power conversion all channels operate with their power-on cycles time-staggered such that there is a time displacement Δt_{dspl} interval between the start-on points of the sequential power-on cycles such that:

Δt_{dspl}=T_{PS}/N. [24]

Provided that all unitary DC-DC power conversion channels have similar operating frequency, the resultant summed input and output currents S show substantial improvement from the standpoint of the primary power stress and output ripple constituents. Summing the time-staggered portions of the converted power produces a filtering effect within the input and output circuits of the combined power conversion channels. This is due to the time-staggered overlay of the similar non-linear responses from all conversion channels.

Therefore, an advantageous low-loss discontinuous current mode may be beneficially employed within the multiple unitary DC-DC power conversion channels combined into a multi-phase AC-DC power conversion system to provide the high quality power draw.

The important advantage of the multi-phase mode to be employed into the present invention is best illustrated in FIGS. 6, 7 with the comparative appraisal of the nature and features of the power conversion processes performed by the multi-phased DC-DC power converters 12 of equal performance but comprising the different N numbers of unitary DC-DC power conversion channels 16(k).

The common equal conditions are as follows: The value of the input AC voltage supplied by the primary AC power source 10 is:

U_{AC}=120 volts;

the value of the output power supplied by the DC-DC power converter 12 is:

P_{OUT}=1200 watts.

For better comparison, FIGS. 6(a,b) illustrate the nature and features of the power conversion process within the single-channel DC-DC power converter 12 containing N=1 number of unitary DC-DC power conversion channel 16. To secure the continuous current mode of operation, the inductance value of the power storage inductor 22 is chosen as:

L_{22(N=1)}=180 μH.

FIGS. 6(c,d) illustrate the nature and features of the power conversion process within the multi-channel DC-DC power converter 12 containing N=2 number of unitary DC-DC power conversion channels 16(k), i.e. k=1, 2. To insure a discontinuous current mode of operation, the inductance value of the power storage inductors 22(k) is chosen as:

L₂₂₍ₖ₎=55 μH.

FIGs. 6(e,f) illustrate the nature and features of the power conversion process within the multi-channel DC-DC power converter 12 containing N=4 number of unitary DC-DC power conversion channels 16(k), i.e. k=1, 2, . . . , 4. To insure the discontinuous current mode of operation, the inductance value of the power storage inductors 22(k) is chosen as:

L₂₂₍ₖ₎=110 μH.

FIGS. 6(g,h) illustrate the nature and features of the power conversion process within the multi-channel DC-DC power converter 12 containing N=8 number of unitary DC-DC power conversion channels 16(k), i.e. k=1, 2, . . . , 8. To insure the discontinuous current mode of operation, the inductance value of the power storage inductors 22(k) is chosen as:

L₂₂₍ₖ₎=180 μH.

As may be evident in FIGS. 6(a,b), while employing the single-channel DC-DC power converter 12, it is possible to secure the continuous current i₂₂(t) mode at its input only, but not at the output, where the discontinuous i₂₄(t) current mode is persistent at any inductance value of the power storage inductor 22.

Conversely, as may be evident in FIGS. 6(c,d, e,f, g,h), due to the employment of the multi-phased multi-channel DC-DC power converters 12 it is possible to provide the continuous i_{Σ22}(t) current mode at the system input and the continuous i_{Σ24}(t) current mode at the system output while securing the low-loss discontinuous currents i₂₂₍ₖ₎(t), i₂₄₍ₖ₎(t) modes within each of the separate unitary DC-DC power conversion channels 16(k).

Besides, referring to FIGS. 6(a,b), it is evident that increasing the output power draw by increasing the number of parallel syn-phased power conversion channels produces a proportional increase of the input and output ripple constituents.

Referring to FIGS. 6(c,d, e,f, g,h), it is evident that, conversely, an increase of the number of multi-phased power conversion channels produces a substantial decrease of the input and output ripple constituents as compared with a single unitary power conversion channel of the same row.

FIG. 7 illustrates the comparative factorized ripple spectrum analysis attributed to the above described power conversion processes performed by the multi-phased DC-DC power converters 12 of an equal performance but of the different N numbers of unitary DC-DC power conversion channels 16(k).

The values of ripple factor K_{RPL} are defined as follows:

$$\begin{matrix}{K}_{RPL \sum 22} ( n ) = \frac{{\sum }_{k = 1}^{N} {\dot{I}}_{22 ( k ) n}}{{I}_{INDC}} & [ 25 ] \\ {K}_{RPL \sum 24} ( n ) = \frac{{\sum }_{k = 1}^{N} {\dot{I}}_{24 ( k ) n}}{{I}_{OUTDC}} & [ 26 ]\end{matrix}$$

where: n is a harnonic number;

K_{RPLΣ22}(n) is a value for the input ripple factor of an n-th harmonic;

K_{RPLΣ24}(n) is a value for the output ripple factor of an n-th harnonic;

I₂₂₍ₖ₎ₙ is an amplitude of an n-th harmonic constituent of the i_{22(K)}(t) current of the power storage inductor 22(k) within the k-th unitary power conversion channel 16(k);

I₂₄₍ₖ₎ is an amplitude of an n-th harmonic constituent of the i_{24(K)}(t) current of the power blocking rectifier 24 within the k-th unitary power conversion channel 16(k);

I_{INDC} is a value of the direct current constituent of the current consumed by the DC-DC power converter 12;

I_{OUTDC} is a value of the direct current constituent of the current delivered by the DC-DC power converter 12.

Referring to FIG. 7 it is evident that the discontinuous-mode multi-channel multi-phased AC-DC conversion systems exhibit the substantially reduced values of the input and output ripple factors as compared with a continuous-mode single-channel systems performance.

Moreover, the comparison of the factorized ripple spectrums corresponding to different N numbers of multi-phased AC-DC conversion channels, as shown in FIGS. 7(c,d, e,f, g,h), exposes the substantial reduction of the amount of the ripple harmonics, i.e. EMI noise within the input and output spectrums correspondingly to the increase of N number.

It is evident that correspondingly to the N number increase the overall system power factor increases.

Therefore, securing the discontinuous current mode within each of the multiple unitary AC-DC power conversion channels and arranging their operation in a multi-phase fashion provides the substantial reduction of ripple constituents within the input and output power draws as compared with the continuous-mode single-channel system of the same overall performance. The degree of such a reduction is also corresponding to the N number of channels combined.

Besides, the important advantages of the low-loss discontinuous current mode, as described above, may be exploited in a full scale.

The further important advantages of the multi-channel multi-phase system design are as follows:

a provision of an opportunity to develop the systems of a substantially increased overall performance;

an increase of the current carrying capability of the commutating components;

an employment of the components of a less power carrying capability;

a reduction of the overall power losses;

a provision of an even dissipation of residual power losses;

a provision of an even dissipation of heat dissipating localities;

an elimination of the local over-heat spots;

a reduction of the components temperature;

an elimination of the need to employ the complex cooling systems;

an increase of the overall system efficiency;

an increase of the overall system reliability;

a simplicity of increasing the overall system performance by purely connecting the additional modules;

a simplicity of maintenance and repair by purely replacing the faulty module;

a reduction of the system failure factor;

a reduction of the complexity of manufacture;

a reduction of the design and manufacture costs due to the enhanced standardization of the routine procedures.

Therefore, what is needed in the art is a circuit concept and a method of the AC-DC power conversion to embrace all above described advantages in a beneficially synergetic fashion.

It is, therefore, an object of the present invention to provide a multi-channel multi-phase AC-DC power conversion system of the enhanced performance in sense of the overall capacity and efficiency increase.

Implementations of the present invention may feature the following beneficial properties: an increase of the power factor up to the unity value; the degree of the increase is proportional to the quantity of the power conversion channels combined; a boundless increase of the overall system capacity proportionally to the quantity of the power conversion channels combined; an expiration of all sorts of constraints upon the system capacity increase; a reduction of the harmonic and non-linear distortions regardless of the discontinuous current mode within the unitary AC-DC power conversion channels; the degree of the reduction is proportional to the amount of the power conversion channels combined; an additional reduction of the output ripple due to the opportunity to increase the value of the auto-transformation factor assigned to the power storage inductors within the unitary AC-DC power conversion channels; a reduction of the EMI noise;

an improvement of the filtering efficiency;

a provision of the soft-switching conditions for the current commutating components within the power conversion channels combined;

a reduction of the complexity of the soft-switching conditioning circuitry due to the expiration of a need to monitor the zero-voltage-across conditions;

an increase of the overall efficiency due to the low-loss discontinuous current mode within each of the unitary AC-DC power conversion channels; the degree of the increase is proportional to the quantity of the power conversion channels combined;

an increase of the power conversion operating frequency assigned for the separate unitary power conversion channels due to the low-loss discontinuous current mode within each of them;

1) a reduction of the filtering components volume;

a reduction of other components size, weight and power carrying capacity;

a better employment of the components properties due to the reduction and even distribution of the heat dissipation;

a better employment of the components capacities resulted of their electric parameters due to reduction of the electrical stress upon the current carrying components;

a employment of the conventional off-the-shelf micro-chip APFC-controllers designed for the single-channel AC-DC power converters.

In general, in one aspect of the present invention, the listed advantages may be achieved through the following approaches.

As compared with a traditional single-channel AC-DC power converter employing the continuous current mode within the power storage inductor, the corresponding single power draw conversion process of the desired capacity should be subdivided into N>1 number of the unitary sub-processes of the proportionally (1/N-portion) less performance each.

Further, each unitary sub-process should be assigned to a separate unitary AC-DC power conversion channel designed of the less capacitive components as compared with a traditional single-channel AC-DC power converter.

This is to eliminate the constraints produced by the components power carrying capacity upon the operating frequency and overall power draw increase, which are persistent to the prior art. Moreover, this is to resolve the opportunity of employing the components though of the less power carrying capacity but of the better specific properties.

Besides, these components may be of a substantially smaller size, and, due to the modern micro-technologies, and regardless of their quantity increase, may be enclosed into the substantially smaller package.

Each unitary power conversion channel should incorporate a power storage inductor of a tapped auto-transformatory choke design. This is to reduce the degree of the electrical stress upon the power carrying components, therefore, to provide a better use of the components capacities resulted of their electric parameters. Besides, this is to reduce all sorts of high frequency output ripple due to the fact that the auto-transformatory choke design of the power storage inductor provides an increase of the release factor value [11], i.e. better release of the magnetically stored energy.

Each unitary power conversion channel should incorporate a soft-switching conditioning circuit.

Further, the multiple unitary power conversion channels should be combined into a resultant AC-DC power conversion system of the desired capacity, i.e. equal to that of the traditional single-channel AC-DC power converter.

Further, the discontinuous current mode should be provided to each of the multiple unitary power conversion channels. This is to reduce the electrical stress upon the power carrying components and the switching transition losses within the soft-switching conditioning circuits. The components of these circuits may be, therefore, of a less power carrying capacity.

Further, the multi-phase mode of operating the unitary channels should be provided to the resultant AC-DC power conversion system. This is to increase the power factor value and the system efficiency.

Further, the soft-switching conditions should be provided to the current commutating components within the unitary channels. This is to eliminate the switching transition losses within these components.

The further, i.e. a synergetic advantage of the present invention is that the discontinuous current mode within each of the unitary DC-DC power conversion channels naturally provides an optimal distribution of the overall power draw.

Conversely to the continuous current mode, the discontinuous one eliminates the need to employ the additional feedback loops and corresponding complex circuitry.

The amount of power delivered by each unitary DC-DC power conversion channel depends on the inductance value of the power storage inductor and on the power absorption time-interval.

Naturally, provided that all power storage inductors are of the same inductance value and power absorption time-intervals are of the same duration, the overall power draw is evenly distributed among the unitary power conversion channels.

In general, in another aspect of the present invention, the modified AC-DC power converters should comprise at least:

an input means for being connected to the primary AC power source;

an output means for being connected to the system load;

a common return bus for being connected between the AC-DC power converter and a system load;

an input AC-DC rectifier to transform the sine-wave of the AC primary power source voltage into a half-sine-wave of the rectified voltage;

a multi-channel DC-DC converter;

a system output smoothing filter;

a system control means;

a system synchronization means;

a multi-channel DC-DC converter should comprise an N>1 number of the unitary DC-DC power conversion channels;

the input nodes of the unitary DC-DC power conversion channels should be parallel-connected to the output node of the input AC-DC rectifier;

the output nodes of the unitary DC-DC power conversion channels should be parallel-connected to the input node of the system output smoothing filter;

a unitary DC-DC power converter should comprise at least:

a channel noise inhibiting filter;

a power storage inductor to accumulate the power absorbed from the primary AC power source and to release the magnetically stored energy to the system load;

an inductance value L of the power storage inductor should be chosen definitely for securing the discontinuous current mode of operation within each unitary DC-DC power conversion channel, and, therefore, for minimizing the switching transition losses within the current commutating devices;

a controllable power switch operated in an ON-OFF fashion and alternatively turned into conducting state to provide the power absorption from the primary AC power source into the power storage inductor, and turned into non-conducting state to provide th of the magnetically stored energy from the power storage inductor to the system load;

a power blocking rectifier to disconnect the system load from the power storage inductor and from the primary AC power source while the controllable power switch is conducting, and to provide a power release path from the power storage inductor to the system load while the controllable power switch is non-conducting;

a channel output smoothing filter to store the power delivered to the system load and to absorb the ripple component of the delivered power;

an active soft-switching conditioner connected via its nodes across both the controllable power switch and the power blocking rectifier to provide an active shaping their operating points trajectories through an active development of the soft-switching zero-voltage-across/zero-current-through conditions during the time intervals of the alternative transitions between the conducting and non-conducting states;

an active soft-switching conditioner should comprise at least:

a slope-shaping capacitor;

a damp-resonant choke;

a controllable commutating switch;

a shunting rectifier;

a separating rectifier;

a system control means should comprise at least:

an active power factor correction (APFC) controller to accept the functional input signals and to provide the AC-DC power conversion system with an output ON-OFF control signal such that each unitary DC-DC power conversion channel should maintain its proper performance to secure the overall system output quality, i.e. high power factor value and output voltage stability;

an ON-state pulse duration of the ON-OFF control signal should be equal to the absorption time interval t_{ABS}, i.e. to correspond to the close/conducting state of the time-staggered operated controllable power switches, and the period of the ON-state pulses of the ON-OFF control signal should be equal to the controllable power switch operation period T_{PS}, i.e. to the period of the common operating frequency;

this ON-OFF control signal should be further applied to the system synchronization means;

the system synchronization means should conformly reproduce N times the ON-OFF control signal produced by the APFC-controller, and should timely stagger its conformable copies for being distributed to all unitary DC-DC power conversion channels of the system; these copies should form a first set of the synchronizing signals, i.e. the set of the ON-OFF t_{ABS}-signals which are timely staggered such that a time-displacement interval Δt_{dspl}=T_{PS}/N should exist between the leading edges of the ON-state pulses of the sequential time-staggered copies;

the system synchronization means should conformly produce the second set of the synchronizing ON-OFF signals; the second set should contain N number of the ON-OFF signals; these signals should be evenly time-staggered such that a time-displacement interval Δt_{dspl}=T_{PS}/N should exist between the leading edges of the ON-state pulses of the sequential time-staggered signals; the ON-state pulse duration of such a signal should be equal to the soft-switching time interval t_{SS}, i.e. to correspond to the closed/conducting state of the controllable commutating switch within the active soft-switching conditioner, and the period of the ON-state pulses of these t_{SS}-signals should be also equal to T_{PS};

the system synchronization means should provide the AC-DC power conversion system with two sets of the ON-OFF synchronizing signals for operating the unitary DC-DC power conversion channels in a time-staggered fashion; each set should contain N number of signals;

the synchronizing signals of the first set should operate the controllable power switches within the corresponding unitary DC-DC power conversion channels; as a result, the unitary power conversion processes within the sequential unitary DC-DC power conversion channels should be timely staggered such that a time-displacement interval Δtspl=T_{PS}/N should exist between the start-points of the power-on cycles within the sequential channels in the row;

the synchronizing signals of the second set should operate the controllable commutating switches within the active soft-switching conditioners within the corresponding unitary DC-DC power conversion channels;

the system synchronization means should distribute the synchronizing signals across the AC-DC power conversion system such that one Δt_{ABS}-signal of the first set and one t_{SS}-signal of the second set should be provided to each unitary DC-DC power conversion channel;

each pair of one t_{ABS}-signal and one t_{SS}-signal should be timely arranged such that a leading edge of the ON-state pulse of the t_{SS}-signal should precede the leading edge of the ON-state pulse of the t_{ABS}-signal for an advance time interval t_{A} as a result, the controllable commutating switch of the active soft-switching conditioner should be turned into the close/conducting state prior to the controllable power switch being turned into the closed/conducting state;

therefore, within the advance time interval t_{A} the slope-shaping capacitor within the active soft-switching conditioner should discharge in a resonant fashion thus providing a zero-voltage-across condition to the controllable power switch during its transition from the open/non-conducting to the closed/conducting state;

the ON-state pulse of the t_{SS}-signal should cease past the ON-state pulse of the t_{ABS}-signal having started, i.e. the controllable commutating switch of the active soft-switching conditioner should be turned into open/non-conducting state past the controllable power switch having been reliably turned into the closed/conducting state;

therefore, the trailing edge of the ON-state pulse of the t_{SS}-signal should recede the leading edge of the ON-state pulse of the t_{ABS}-signal in a lag time interval t_{L};

the control means of the AC-DC power conversion system should comprise the means for preventing the operation of all controllable switches within all unitary DC-DC power conversion channels, i.e. for inhibiting the power conversion process in case the value of the system output voltage incidentally exceeds the preset maximum threshold,

and for encouraging the operation of all controllable switches within all unitary DC-DC power conversion channels as soon as the system output voltage recovers the operating value, i.e. for restoring the power conversion process as soon as the system output voltage falls below the preset minimum threshold in a hysteresis fashion.

In general, according to the discussed aspect of the present invention, the power storage inductors within all unitary DC-DC power conversion channels may be of a tapless choke design. This may be appropriate for the cheapest embodiments of the present invention. Due to the multi-phased operation and the discontinuous current mode secured within the multiple power conversion channels, the bulk of the discussed advantages will be also provided.

In general, in another aspect of the present invention, the power storage inductors within all unitary DC-DC power conversion channels may be of a tapped auto-transformatory choke design ascribed with the auto-transformation factor n_{2/1}>1;

an inductance value L₁ of the primary power carrying winding within the power storage inductor should be chosen definitely for securing the discontinuous current mode of operation within each unitary DC-DC power conversion channel, therefore, for minimizing the switching transition losses within the current commutating devices, and for reducing the electrical stress upon the power carrying components, and for employing the components with less power carrying capability, and for enhancing the employment of components capacities resulted of their electric parameters, and for reducing the output ripple due to the opportunity to increase the value of the auto-transformation factor n_{2/1}.

In general, in another aspect of the present invention, to secure the low-loss discontinuous current mode, each unitary DC-DC power conversion channel should comprise a means to detect the non-zero i_{RLS}(t) release current flow within the power storage inductor during the release time interval t_{RLS} of releasing the magnetically stored energy to the system load; the synchronization means of the AC-DC power conversion system should comprise the means to postpone the successive operating cycle for indefinite postponement time interval tₚₚ, i.e. to eliminate turning the controllable switches within any unitary DC-DC power conversion channel into conducting state, prior to the i_{RLS}(t) release current flow within the corresponding power storage inductor reaches zero.

In general, due to the fact that various APFC-controllers have been designed to satisfy the special applications needs, these may be successfully employed within the embodiments of the present invention, therefore, expiring the need to design the specialized control circuitry for any special embodiment of the present invention.

According to the primary application aim, there are several main types of the APFC-controllers.

Each type is designed to secure the corresponding mode of the current conduction within the single monitored power conversion channel, i.e. the discontinuous current mode, or critical current mode, or continuous current mode, or any combination of these.

All types of the existing APFC-controllers may be easily accommodated to the embodiments of the present invention.

To employ the APFC-controller available or preferred for any special reason, the control means of the AC-DC power converter may be simply modified according to the special case.

Therefore, in another aspect of the present invention, the control means may comprise a conventional “off-the-shelf” APFC-controller designed to secure the discontinuous current mode within the traditional single-channel AC-DC power converter; to provide such a conventional “discontinuous current mode” APFC-controller with appropriate feed-back signals, the first-in-the-row appointed unitary DC-DC power conversion channel should comprise a current-sensing means to monitor the current flow within its power storage inductor through monitoring the current flows within both its controllable power switch and power blocking rectifier; further, the ON-OFF control signal produced by such a conventional “discontinuous current mode” APFC-controller should be conformly reproduced N times and its conformable copies should be timely staggered and distributed to all other unitary DC-DC power converters of the row.

In another aspect of the present invention, the control means may comprise a conventional “off-the-shelf” APFC-controller designed to secure the continuous current mode within the traditional single-channel AC-DC power converter;

to provide such a conventional “continuous current mode” APFC-controller with appropriate feed-back signals, the first-in-the-row appointed unitary DC-DC power conversion channel should comprise a current-sensing means to monitor the current flow within its power storage inductor through monitoring the current flows within both its controllable power switch and power blocking rectifier, a current sensing means to monitor the total current consumed by the multi-channel DC-DC converter, and a current signals summator to produce a resultant feed-back signal conformable to that of the single-channel AC-DC converter of the equal capacity; further, the ON-OFF control signal produced by such a conventional “continuous current mode” APFC-controller should be conformly reproduced N times and its conformable copies should be timely staggered and distributed to all other unitary DC-DC power converters in the row.

In another aspect of the present invention, concerning the special applications, the multi-channel multi-phase AC-DC power converter may be particularly designed to maintain the critical current mode and a variable operating frequency within its unitary DC-DC power conversion channels;

accordingly, the control means of the AC-DC power conversion system should comprise a conventional “off-the-shelf” APFC-controller designed to secure the critical current mode within the traditional single-channel AC-DC power converter;

the system synchronization means should additionally comprise a voltage controlled oscillator (VCO), a frequency divider-by-M, a phase comparator and an integrating filter;

the latter should be connected in a phase-locked loop to produce a VCO output clocking signal of an M-times higher frequency than that of the ON-OFF control signal produced by the APFC-controller;

further, the ON-OFF control signal produced by such a conventional “critical current mode” APFC-controller should be conformly reproduced N times and its conformable copies should be timely staggered and distributed to all other unitary DC-DC power converters of the row.

It is evident, that there is no need to design any specialized “multi-phase” APFC-controller to embody the present invention.

Concerning the quantity, i.e. N number of the unitary DC-DC power conversion channels combined within the multi-phase DC-DC converter, it may only depend on the qualitative considerations such as an amount of power to be processed, a power factor value to be secured and a total efficiency to be provided.

Within each unitary DC-DC power conversion channel the controllable power switch and the controllable commutating switch may be performed as the solid-state semiconductor switches like MOSFETs.

The body diode of the solid-state semiconductor switch may be used as the shunting rectifier connected across the controllable commutating switch within the active soft-switching conditioner of the unitary DC-DC power conversion channel.

The high-power pulse diode may be used as the power blocking rectifier and the separating rectifier within the active soft-switching conditioners of the unitary DC-DC power conversion channels.

It is a further object of the present invention to provide an improved method of the AC-DC power conversion with an active power factor correction; the method comprises the following steps:

a) defining the overall AC-DC power conversion system configuration;

b) defining the optimal N>1 number of unitary DC-DC power conversion channels to be included into the AC-DC power conversion system;

c) defining the current mode within the unitary DC-DC power conversion channels;

d) defining the proper type and design of the APFC-controller;

defining the control means configuration;

defining the synchronization means configuration;

providing the APFC-controller with the appropriate functional input signals to provide the AC-DC power conversion system with a resultant, i.e. APFC-controller produced, ON-OFF control signal such that each unitary DC-DC power conversion channel should maintain its proper performance to secure the overall system output quality, i.e. high power factor and output voltage stability; the ON-state pulse duration of the ON-OFF control signal should be equal to the absorption time interval t_{ABS}, i.e. to correspond to the close/conducting state of the time-staggered controllable power switches, and the period of the ON-state pulses of the ON-OFF control signal should be equal to the controllable power switch operation period T_{PS}, i.e. to the period of the common operating frequency; this ON-OFF control signal should be further applied to the system synchronization means;

conformly reproducing N times the ON-OFF control signal produced by the APFC-controller and timely staggering its conformable copies to be distributed to all other unitary DC-DC power conversion channels of the system; these copies should form a first set of synchronizing signals, i.e. the set of the ON-OFF t_{ABS}-signals which are timely staggered such that a time-displacement interval Δt_{dspl}=T_{PS}/N should exist between the leading edges of the ON-state pulses of the sequential time-staggered copies; this is to be performed by the system synchronization means;

conformly producing the second set of the synchronizing ON-OFF signals; the second set should contain N number of the ON-OFF signals; these signals should be evenly time-staggered such that a time-displacement interval Δt_{dspl}=T_{PS}/N should exist between the leading edges of th ON-state pulses of the sequential time-staggered signals; the ON-state pulse duration of such a signal should be equal to the soft-switching time interval t_{SS}, i.e. to correspond to the closed/conducting state of the controllable commutating switch within the active soft-switching conditioner, and the period of the ON-state pulses of these t_{SS}-signals should be also equal to T_{PS};

providing the power conversion system with two sets of the ON-OFF synchronizing signals produced by the system synchronization means to operate the unitary DC-DC power conversion channels in a time-staggered fashion; each set should contain N number of signals operating the controllable power switches within the corresponding unitary power conversion channels with the synchronizing signals of the first set; as a result, the power conversion processes within the sequential unitary DC-DC power conversion channels should be timely staggered such that a time-displacement interval Δt_{dspl}=T_{PS}/N should exist between the start-points of the power-on cycles within the sequential channels in the row;

operating the controllable commutating switches of the active soft-switching conditioners within the corresponding unitary power conversion channels with the synchronizing signals of the second set;

m) distributing the synchronizing signals across the AC-DC power conversion system such that one t_{ABS}-signal of the first set and one t_{SS}-signal of the second set should be provided to each corresponding unitary DC-DC power conversion channel;

arranging timely each pair of one t_{ABS}-signal and one t_{SS}-signal such that a leading edge of the ON-state pulse of the t_{SS}-signal should precede the leading edge of the ON-state pulse of the t_{ABS}-signal for an advance time interval t_{A}; as a result, the controllable commutating switch of the active soft-switching conditioner should be turned into the close/conducting state prior to the controllable power switch being turned into the closed/conducting state; therefore, within the advance time interval t_{A} the slope-shaping capacitor of the active soft-switching conditioner should discharge in a resonant fashion thus providing a zero-voltage-across condition to the controllable power switch during its transition from the open/non-conducting state to the closed/conducting state;

ceasing the ON-state pulse of the t_{SS}-signal past the ON-state pulse of the t_{ABS}-signal having started, i.e. the controllable commutating switch of the active soft-switching conditioner should be turned into the open/non-conducting state past the controllable power switch having been reliably turned into closed/conducting state;

as a result of the above described steps, the individual power conversion processes within the multiple unitary power conversion channels should be evenly time-staggered across the period of the common operating frequency; therefore, while securing the discontinuous or critical current mode within the individual channels, the continuous current mode should be provided both to the primary AC power source and to the system load; the waveform of the resultant AC current consumed by the novel AC-DC power conversion system should be substantially conformable and synchronous to the sinusoidal waveform of the AC voltage provided by the primary power source; securing the discontinuous or critical current mode within the individual power conversion channels should result in minimizing the switching transition losses, i.e. the overall system efficiency is substantially high; the power carrying components may, therefore, be of a less size, weight and power carrying capacity; an effective, i.e. “virtual” power conversion frequency of the system is, therefore, N times higher than the common operating one of the separate unitary power conversion channels; the ripple should substantially low; the resultant quality of the overall power draw should be substantially high; the filtering components may be of a substantially less size and weight;

detecting the non-zero i_{RLS}(t) release current flow within the power storage inductor during the release time interval t_{RLS} of releasing the magnetically stored energy;

postponing the successive operating cycle for indefinite postponement time interval tₚₚ to eliminate turning the controllable switches within any unitary DC-DC power conversion channel into the closed/conducting state prior to the i_{RLS}(t) release current flow within the corresponding power storage inductor reaches zero, therefore, to secure the low-loss discontinuous current mode;

preventing the operation of all controllable switches within all unitary DC-DC power conversion channels, i.e. inhibiting the power conversion process in case the value of the system output voltage incidentally exceeds the preset maximum threshold, and encouraging the operation of all controllable switches within all unitary DC-DC power conversion channels, i.e. restoring the power conversion process as soon as the system output voltage falls below the preset minimum threshold in a hysteresis fashion.

An advantage of the present invention is that it provides both an improved method and a circuit concept to provide a novel multi-channel AC-DC power conversion system of the enhanced capacity, efficiency and performance.

Due to the fact that securing the discontinuous or critical current mode within the individual power conversion channels results in minimizing the switching transition losses, the overall system efficiency is substantially high. The power carrying components may, therefore, be of a less size, weight and power carrying capacity.

Due to the fact that individual power conversion processes within the multiple unitary power conversion channels are evenly time-staggered across the period of the common operating frequency while securing the discontinuous or critical current mode within the individual channels, the continuous current mode is provided both to the primary AC power source and to the system load; the waveform of the resultant AC current consumed by the novel AC-DC power conversion system is substantially conformable and synchronous to the sinusoidal waveform of the AC voltage provided by the primary AC power source. Therefore, the resultant quality of the overall power draw is substantially high.

Due to the fact that an effective, i.e. “virtual” power conversion frequency of the system is, therefore, N times higher than that of the separate unitary power conversion channel, the ripple is substantially low and the filtering components may be of a substantially less size and weight.

The foregoing and other objects, features and advantages of the present invention will become more readily apparent to those skilled in the art from the following detailed description of the preferred embodiments of the present invention which proceeds with the reference to the accompanying drawings.

Additional features of the invention will be described hereinafter that form the subject of the claims of the present invention.

Those skilled in the art should appreciate that they can readily use the disclosed concepts and specific embodiments as a basis for designing or modifying other structures for carrying out the same purposes of the present invention. Those skilled in the art should also realize that such equivalent designs and constructions do not depart from the spirit and scope of the present invention in its broadest form.

In view of the discussed considerations, the present invention aims to eliminate the drawbacks and constraints persistent in the present state-of-the-art.

The foregoing and other objects, features and advantages of the present invention will become more readily apparent to those skilled in the art from the following detailed description of the preferred embodiments of the present invention which proceeds with the reference to the accompanying drawings.

### BRIEF DESCRIPTION OF DRAWINGS

FIG. 1 illustrates the circuit diagram of the prior art traditional full-bridge AC-DC rectifier.

FIG. 2 illustrates the time-scaled waveforms of current and voltages attributed to the prior art traditional full-bridge AC-DC rectifier.

FIG. 3 illustrates the circuit diagram of the prior art switching-mode pulse-width-modulated AC-DC power converter incorporating a means for active power factor correction and soft-switching conditioning.

FIG. 4 illustrates the time-scaled waveforms of currents and voltages attributed to the prior art switching-mode pulse-width-modulated AC-DC power converter incorporating a means for active power factor correction and soft-switching conditioning.

FIG. 5 illustrates the circuit block-diagram of the prior art switching-mode pulse-width-modulated AC-DC power converter of the modular multi-channel architecture.

FIG. 6 illustrates the time-scaled waveforms of currents and voltages attributed to the prior art switching-mode pulse-width-modulated AC-DC power converter of the modular multi-phase architecture.

FIG. 7 illustrates the factorized ripple spectrum attributed to the switching-mode pulse-width-modulated AC-DC power converter of the modular multi-phase architecture.

FIG. 8 illustrates the circuit diagrams of the various embodiments of the switching-mode pulse-width-modulated AC-DC power converter according to the present invention.

FIG. 9 illustrates the timing diagrams describing the nature of the AC-DC power conversion process performed by the embodiments of the switching-mode pulse-width-modulated AC-DC power converter according to the present invention.

FIG. 10 illustrates the timing diagrams describing the operation of the synchronization circuit incorporated into the embodiments of the switching-mode pulse-width-modulated AC-DC power converter according to the present invention.

FIG. 11 illustrates the time-scaled waveforms of currents and voltages attributed to the power conversion processes within the embodiments of the switching-mode AC-DC power converter according to the present invention.

FIG. 12 illustrates the principle of operating the multiple unitary power conversion channels within the embodiments of the switching-mode AC-DC power converter according to the present invention.

FIG. 13 illustrates the principle of providing the high quality continuous current mode to the primary AC power source while securing the discontinuous current mode within the separate unitary DC-DC power conversion channels.

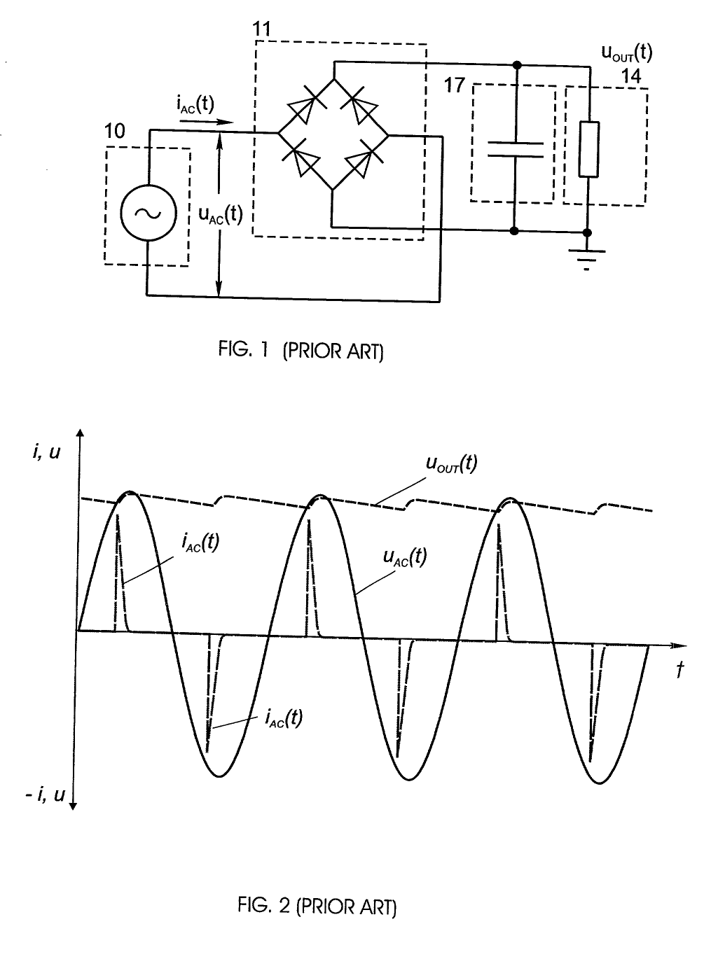

### DETAILED DESCRIPTION OF THE PREFERRED EMBODIMENTS

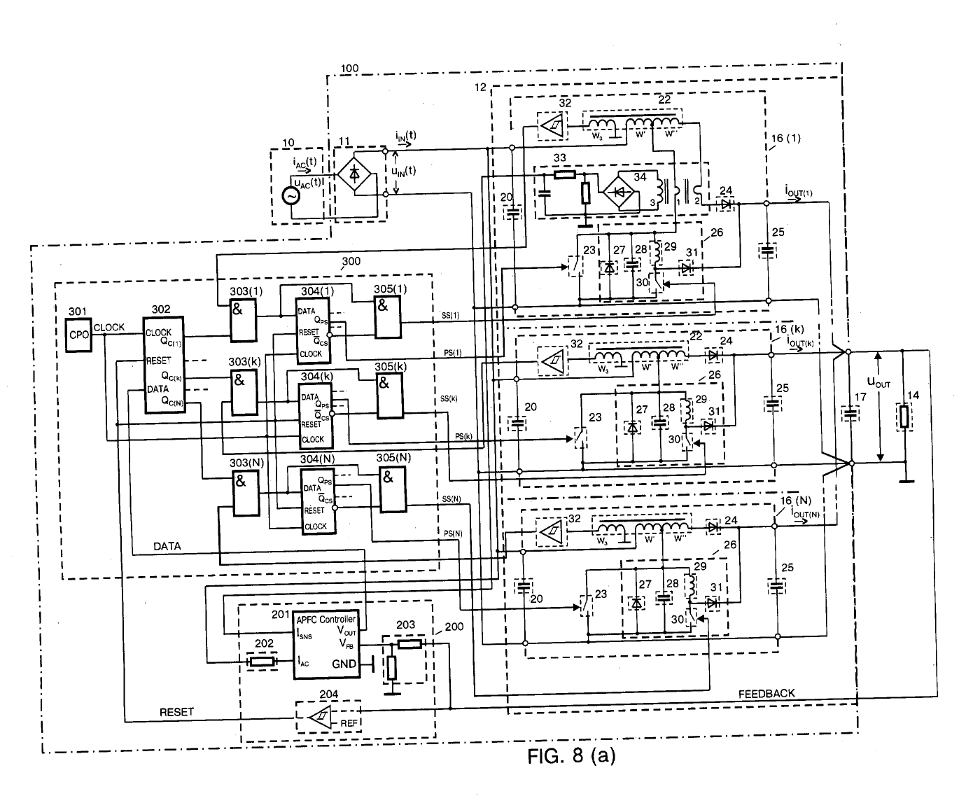

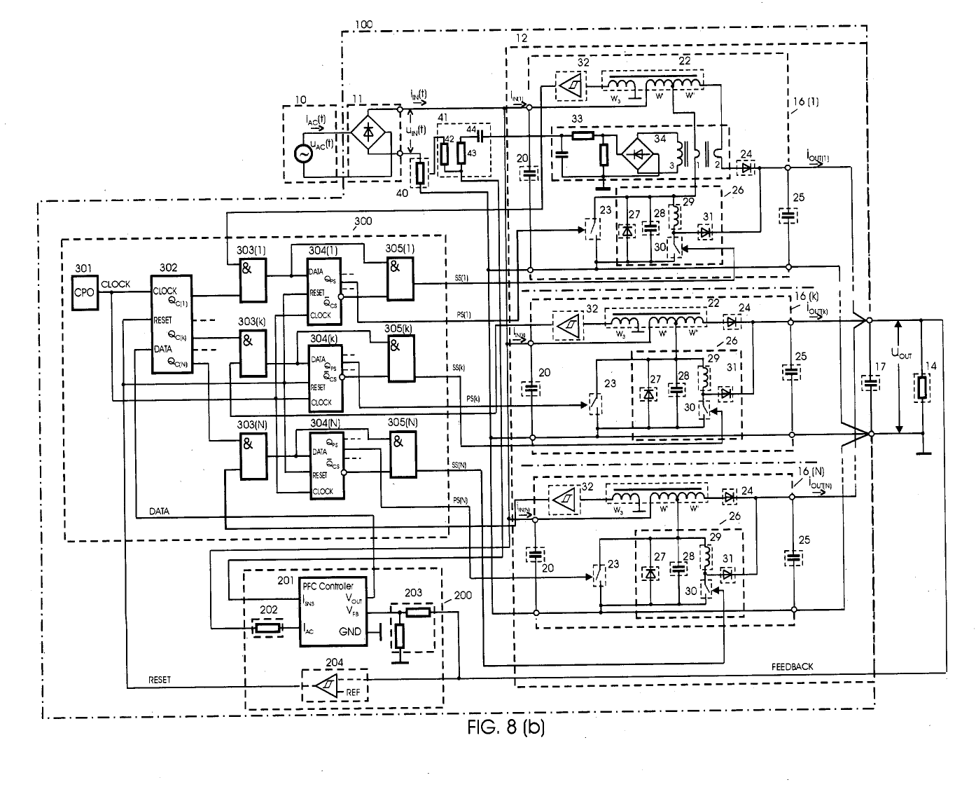

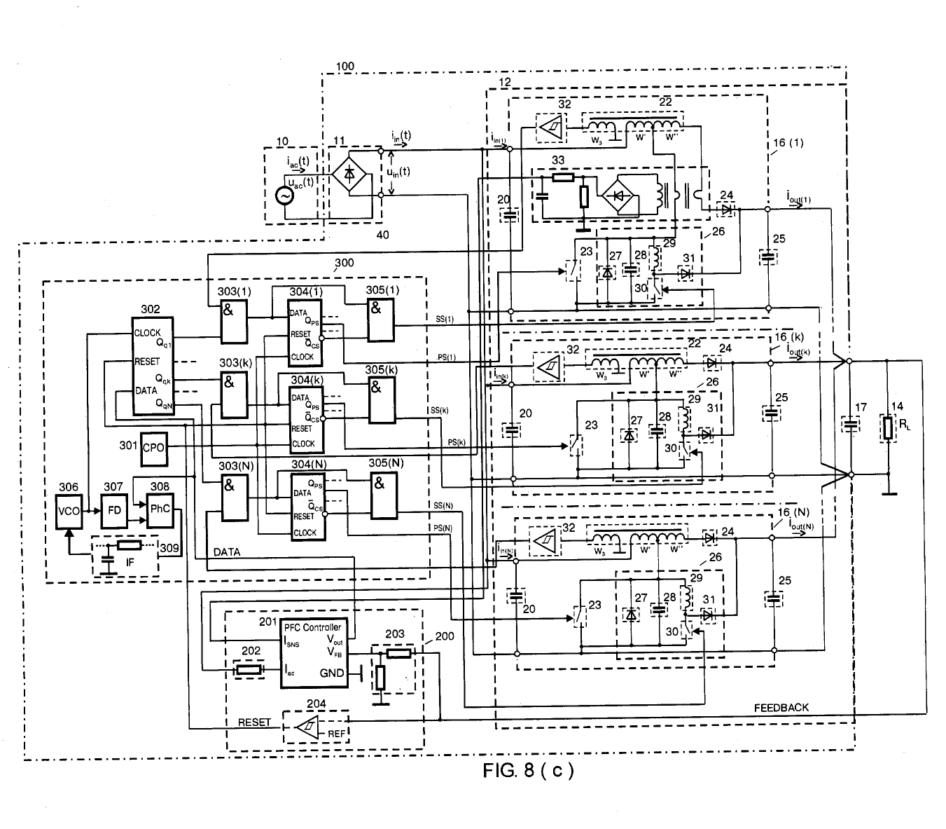

In the embodiments of the proposed invention shown in FIG. 8 the indexed structures to be considered are as follows:

10: a primary AC power source;

11: an input AC-DC rectifier;

12: a multi-channel DC-DC power converter;

14: a system load;

16: a DC-DC power conversion channel;

17: a system output smoothing filter;

20: a channel input noise inhibiting filter;

22: a power storage inductor;

23: a controllable power switch;

24: a power blocking rectifier;

25: a channel output smoothing filter;

26: an active soft-switching conditioner;

27: a shunting rectifier;

28: a slope-shaping capacitor;

29: a damp/resonant choke;

30: a controllable commutating switch;

31: a separating rectifier;

32: a zero-current detector;

33: a non-zero-current detector;

34: a current-sensing transformer;

40: a total consumption current sensor;

41: a current signal summing device

42: first summing resistor;

43: second summing resistor;

44: a DC inhibiting capacitor;

100: an AC-DC power converter;

200: a control circuit;

201: an active power factor correction (APFC) controller;

202: a signal conditioning resistor;

203: a signal conditioning resistive divider;

204: an over-voltage detector;

300: a synchronization circuit;

301: a clock pulse oscillator;

302: a primary shift register;

303: a primary logic gate;

304: a secondary shift register;

305: a secondary logic gate.

306: a voltage controlled oscillator (VCO);

307: a frequency divider;

308: a phase comparator;

309: an integrating filter.

According to the first Embodiment of the present invention, FIG. 8(a) illustrates a circuit diagram of a multi-channel AC-DC converter 100 comprising a conventional APFC controller 201 designed to implement the discontinuous current mode within a conventional single-channel AC-DC power converter of a pulse width modulation type.

Prior to the detailed description of the system design and operation, the key structures will be identified.

Referring to FIG. 8(a), the AC-DC power converter 100 includes input AC-DC rectifier 11, a multi-channel DC-DC power converter 12, a system output smoothing filter 17, a control circuit 200 and a synchronization circuit 300. The multi-channel DC-DC power converter 12 includes N>1 number of DC-DC power conversion channels 16, which are sequentially indexed as 16(1), . . . , 16(k), . . . , 16(N) such that k=1, 2, . . . , N.

Each DC-DC power conversion channel 16(k) includes a channel input noise inhibiting filter 20(k), a power storage inductor 22(k), a controllable power switch 23(k), a power blocking rectifier 24(k), a channel output smoothing filter 25(k), an active soft-switching conditioner 26(k) and a zero-current detector 32(k).

In addition, power channel 16(1) includes a non-zero-current detector 33.

The control circuit 200 consists of an active power factor correction (APFC) controller 201, a signal conditioning resistor 202, a signal conditioning resistive divider 203 and an over-voltage detector 204.

The synchronization circuit 300 consists of a clock pulse oscillator (CPO) 301, a primary shift register 302, N number of primary logic gates 303, which are sequentially indexed as 303(1), . . . , 303(k), . . . , 303(N), N number of secondary shift registers 304 which are sequentially indexed as 304(1), . . . 304(k), 304(N), and N number of secondary logic gates 305 which are sequentially indexed as 305(1), . . . 305(k), . . . , 305(N).

The input AC-DC rectifier 11, the multi-channel DC-DC converter 12 with DC-DC power conversion channels 16(k), the system output filter 17 and the system load 14 are connected each by their common return nodes to a common return bus.

The input nodes of the input AC-DC rectifier 11 are connected to a primary AC power source 10 such as AC mains.

The input nodes of the DC-DC power conversion channels 16(k) are parallel-connected to an output node of the input AC-DC rectifier 11.

The output nodes of the DC-DC power conversion channels 16(k) are parallel-connected to the system output filter 17.

The output node of the system output filter 17 is connected to the input node of the system load 14.

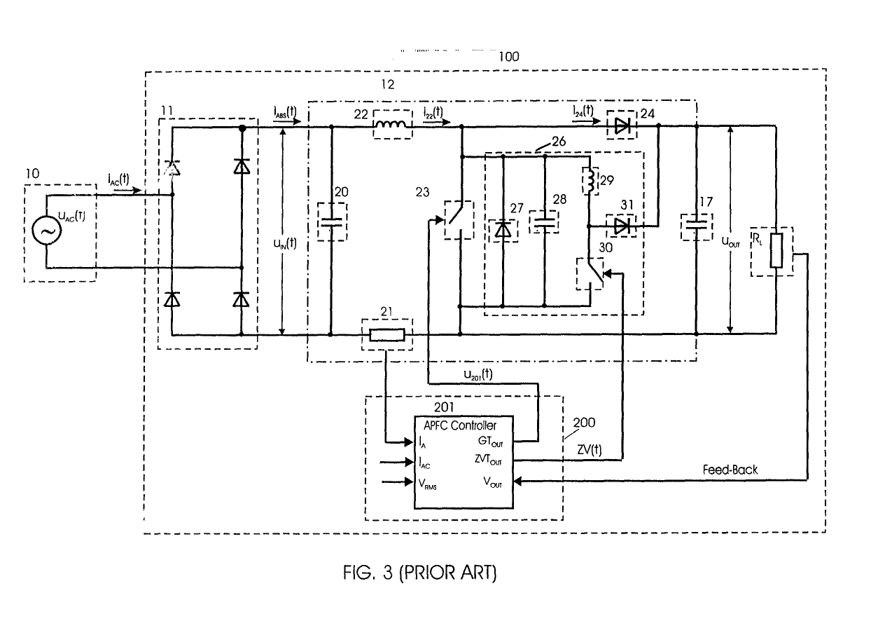

The components of each DC-DC power conversion channel 16(k) are configured in a boost converter topology featuring the following distinctions in comparison with a conventional configuration shown in FIG. 3: a power carrying coil of the power storage inductor 22(k) is of the tapped auto-transformer type consisting of two coils such that the coil W′ provides a primary auto-transformer winding and both series-connected coils W′ and W″ provide a secondary auto-transformer winding; the numbers of turns on each of the coils W′ and W″ define the auto-transformation factor n_{2/1} such that:

n_{2/1}=(w′+w″)/w′=w₂/w₁, [27]

where: w′ is the number of turns of coil W′;

w″ is the number of turns of coil W″;

w₁=w′;

w₂=w′+w″;

an inductance value L₁ of the primary power carrying winding w₁ within each power storage inductor 22(k) is chosen such that the low loss discontinuous current mode is assured within each power storage inductor over the full range of operational current variation; the method of selecting the value for L₁ will be discussed in later paragraphs;

c) Regarding auto-transformer operation, coil W′ defines an inductance value L₁ of the primary auto-transformer winding, and both series-connected coils W′ and W″ define an inductance value L₂ of the secondary auto-transformer winding such that:

L₂=n_{2/1}²L₁; [28]

the power storage inductor 22(k) includes a supplementary coil W₃ which provides a current sensing function and is connected to a zero-current detector 32(k);

an input terminal of the primary power carrying winding of the power storage inductor 22(k) is connected to the input node of the DC-DC power conversion channel 16(k);

an output terminal of the primary power carrying winding of the power storage inductor 22(k) is connected to an input terminal of the power blocking rectifier 24(k);

an output terminal of the power blocking rectifier 24(k) is connected to the channel output smoothing filter 25(k);

the controllable power switch 23(k) is connected between a tap of the power carrying coil, i.e. the common junction point of both the coils W′ and W″, of the power storage inductor 22(k) and a common return node;

switch-shunting terminals of the active soft-switching conditioner 26(k) are connected across the controllable power switch 23(k);

rectifier-shunting terminals of the active soft-switching conditioner 26(k) are connected across the power blocking rectifier 24(k);

In addition, DC-DC power conversion channel 16(1) contains a non-zero-current detector 33 with a current-sensing transformer 34:

an input-current-sensing coil 1 of the current-sensing transformer 34 is connected between a tap coils W′ and W″, on the power storage inductor 22(1), and the controllable power switch 23(1);

output-current-sensing coil 2 of the current-sensing transformer 34 is connected between the output terminal of the primary power carrying winding of the power storage inductor 22(1) and the input terminal of the power blocking rectifier 24(1).

The control circuit 200, is of conventional design.

The active power factor correction (APFC) controller 201 may be provided by any conventional off-the-shelf PFC controller microchip supplied with the resistive components 202, 203 attached for input signals conditioning.

The I_{AC} (alternative current sensing) port of the APFC controller 201 is connected to the output node of the input AC-DC rectifier 11 via signal conditioning resistor 202.

The I_{SNS} (current feedback sensing) port of the APFC controller 201 is connected to the output of the non-zero-current detector 33 within DC-DC power conversion channel 16(1).

The VFB (voltage feed-back sensing) port of the APFC controller 201 is connected to the system output of the multi-channel DC-DC converter 12 via signal conditioning resistive divider 203.

The V_{OUT} (output) port of the APFC controller 201 is connected to the DATA port of the primary shift register 302 which is part of synchronization circuit 300.

The over-voltage detector 204 may be provided by a conventional electronic circuit designed to develop a logic signal resulting from a comparison between the input voltage level and the reference level.

The sensing input of the over-voltage detector 204 is connected to the system output of the multi-channel DC-DC converter 12 via the FEED-BACK input of the control circuit 200.

The output of the over-voltage detector 204 provides a RESET output of the control circuit 200 and is connected to the RESET ports of the shift registers 302, 304(k) within the synchronization circuit 300.

The synchronization circuit 300 provides time-staggered ON-OFF control signals to the controllable power switches 23(k) and to the controllable commutating switches 30(k) within the corresponding DC-DC power conversion channels 16(k).

The synchronization circuit 300 includes N number of PS(k) (power switch) outputs which are sequentially indexed as PS(1), . . . , PS(k), . . . PS(N), being the Q_{PS(k)} outputs of the corresponding secondary shift registers 304(1), . . . , 304(k), . . . , 304(N) respectively.

Each PS(k) output is connected to the gate of the corresponding controllable power switch 23(k) within the corresponding DC-DC power conversion channel 16(k).

The synchronization circuit 300 includes N number of SS(k) (soft switching) outputs which are sequentially indexed as SS(1), . . . , SS(k), . . . SS(N), being the outputs of the corresponding secondary 2-input AND logic gates 305(1), . . . 305(k), . . . , 305(N) respectively.

Each SS(k) output is connected to the gate of the corresponding controllable commutating switch 30(k) within the corresponding DC-DC power conversion channel 16(k).

The clocking within the synchronization circuit 300 is provided by the clock pulse oscillator (CPO) 301 whose output is connected to the CLOCK ports of the shift registers 302, 304(k).

The primary shift register 302 initially includes at least D₃₀₂ quantity (where: D₃₀₂=1, 2, . . . ) of the internal flip-flop cells q sequentially combined in chain to provide sequential loading, storing and shifting the data along the flip-flop cell chain, i.e. along the shift register.

Consequently, all internal flip-flop cells q within the primary shift register 302 may be sequentially numbered according to the shift register specification, and their quantity D₃₀₂ should be regarded as a “digital” length of the prirnary shift register 302 indexed hereafter as D₃₀₂.

Along the sequential chain of the flip-flop cells q, certain outputs should be used to provide control signals for operating the DC-DC power conversion channels 16(k) in a time-staggered fashion.

Therefore, according to N number of DC-DC power conversion channels 16(k) the corresponding N number of Q_{C} (channel control) outputs are selected within the primary shift register 302 and are sequentially indexed as Q_{C(1)}, . . . , Q_{C(k)}, . . . , Q_{C(N)}. Each Q_{C(k)} output is connected to the first input of the corresponding primary logic gate 303(k).

The way to determine the “digital” length D₃₀₂ of the primary shift register 302 and to select the appropriate outputs Q_{C(k)} will be discussed in later paragraphs.

The second input of each primary 2-input AND logic gate 303)k) is connected to the output of the corresponding zero-current detector 32(k) within the corresponding DC-DC power conversion channel 16(k).

The output of each primary 2-input AND logic gate 303(k) is connected to the DATA input of the corresponding secondary shift register 304(k), and to the first input of the corresponding secondary logic gate 305(k).

Each secondary shift register 304(k) initially includes at least D₃₀₄₍ₖ₎ number (where: D₃₀₄₍ₖ₎=1, 2, . . . ) of internal flip-flop cells q sequentially combined in chain to provide sequential loading, storing and shifting the data along the flip-flop cell chain, i.e. along the shift register.

Consequently, all internal flip-flop cells q within each shift register 304(k) may be sequentially numbered according to the shift register specification, and their quantity D₃₀₄₍ₖ₎ should be regarded as a “digital” length of the secondary shift register 304(k) indexed hereafter as D₃₀₄₍ₖ₎.

The way to determine the “digital” length D₃₀₄₍ₖ₎ of the secondary shift registers 304(k) will be discussed in later paragraphs.

Along the sequential chain of the flip-flop cells q, certain outputs should be used to provide control signals for operating the corresponding controllable switches within the DC-DC power conversion channels 16(k) in an appropriately time-staggered fashion.

Therefore, according to N number of the DC-DC power conversion channels 16(k) the corresponding N number of Q_{PS} (power switch control) and N number of Q_{CS} (commutating switch control) outputs are selected and are sequentially indexed as Q_{PS(1)}, . . . , Q_{PS(k)}, . . . , Q_{PS(N)} and Q_{CS(1)}, . . . , Q_{CS(k)}, . . . , Q_{CS(N)} respectively.

Each corresponding Q_{PS(k)} output is connected to the gate of the corresponding controllable power switch 23(k) within the corresponding DC-DC power conversion channel 16(k).

Each corresponding Q_{CSk)} output is connected to the second input of each corresponding secondary 2-input AND logic gate 305(k).

The output of each corresponding secondary 2-input AND logic gate 305(k) is connected to the gate of the corresponding controllable commutating switch 30(k) within the corresponding DC-DC power conversion channel 16(k).

The way to select the appropriate outputs Q_{PS(k)} and Q_{CSk)} will be discussed in later paragraphs.

The APFC controller 201 monitors two control loops.

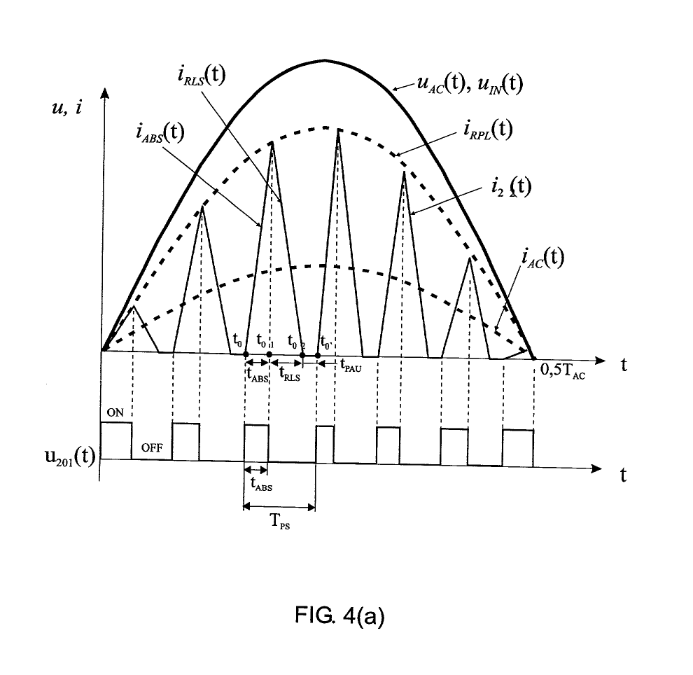

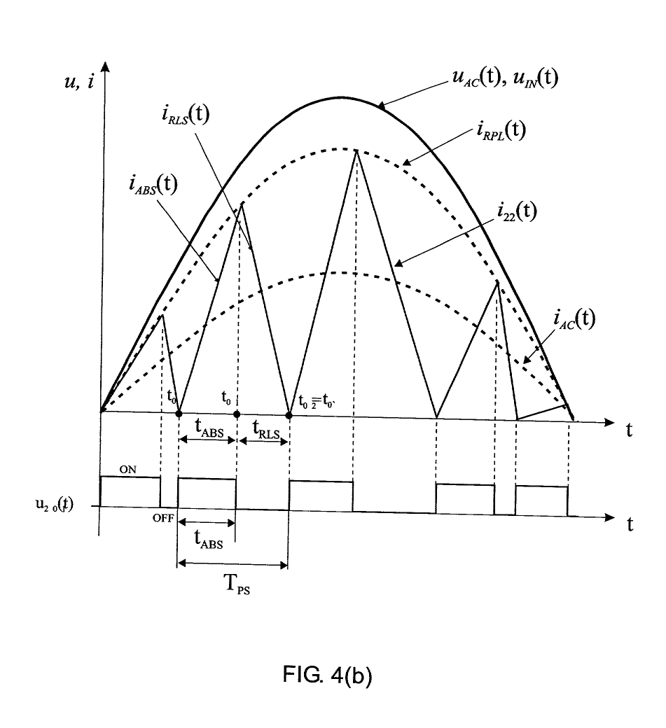

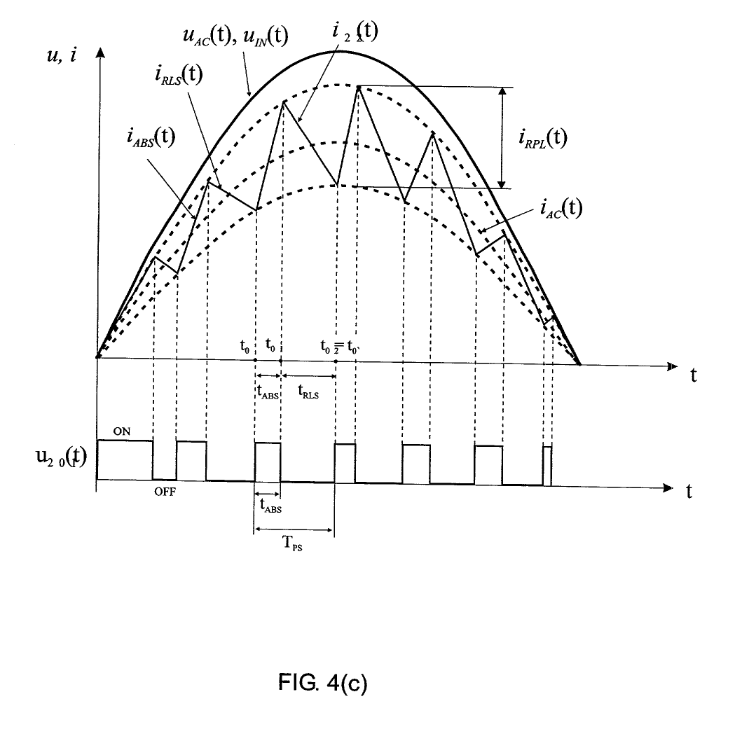

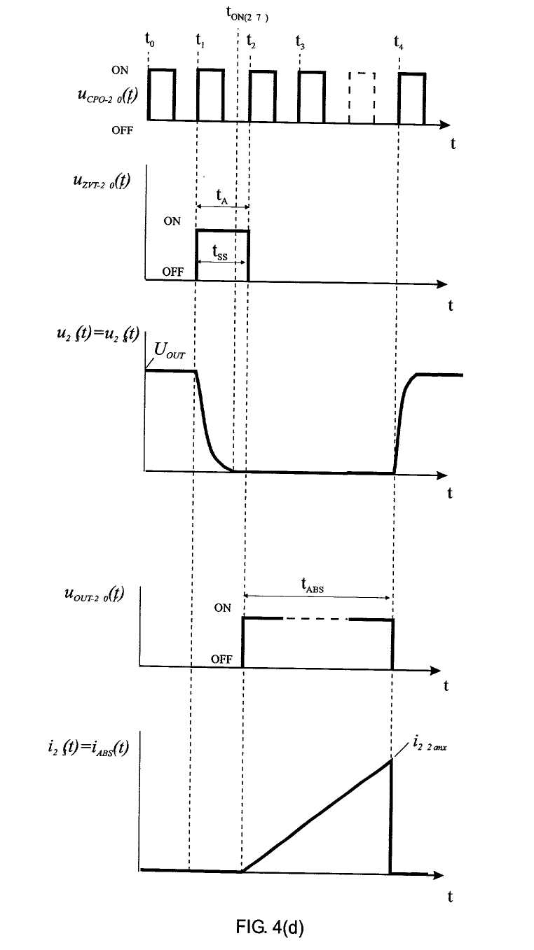

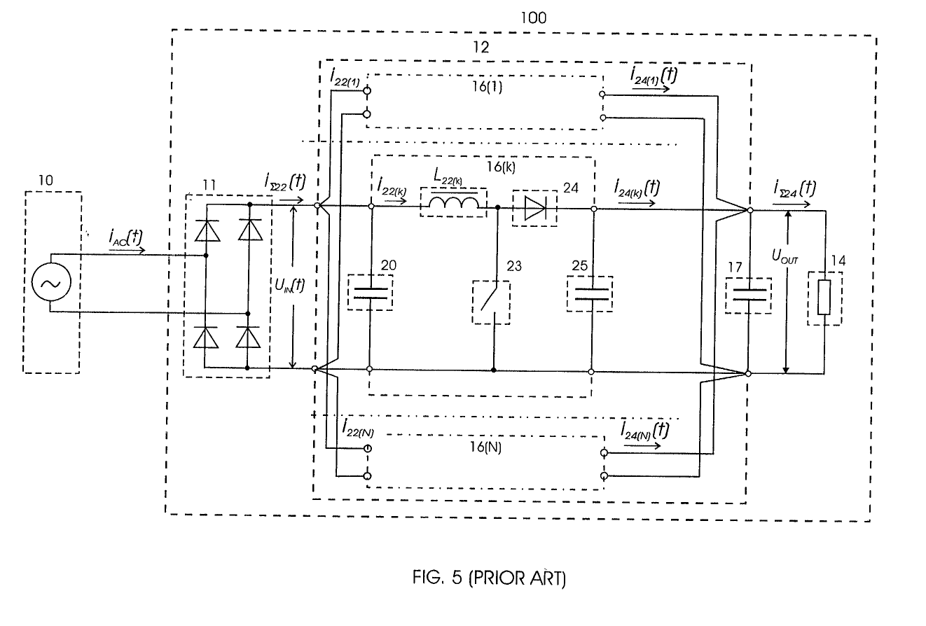

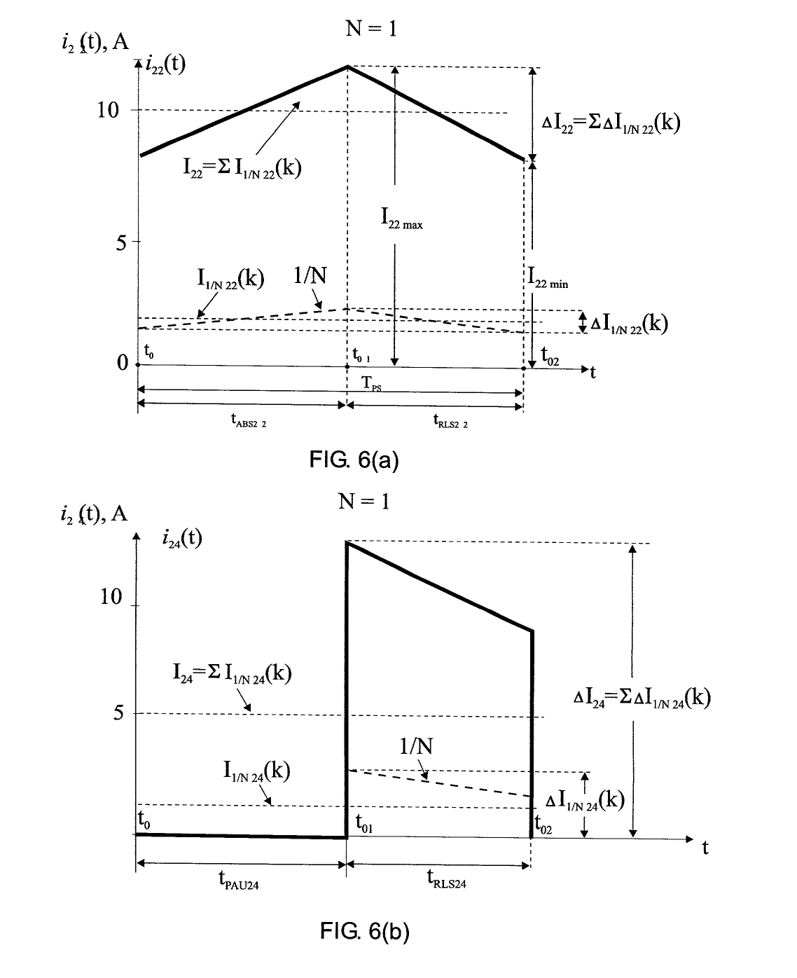

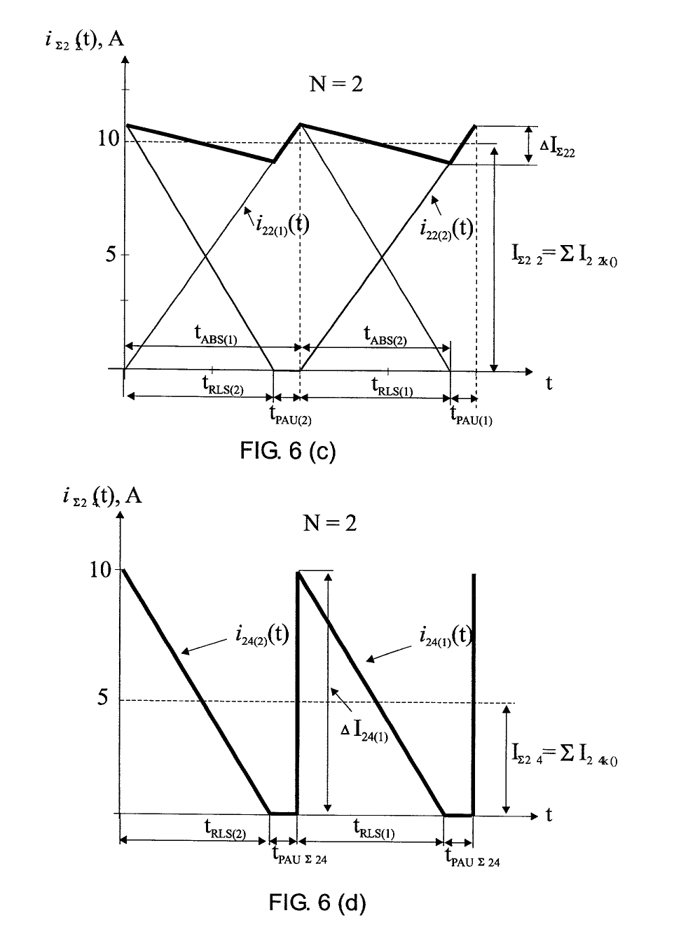

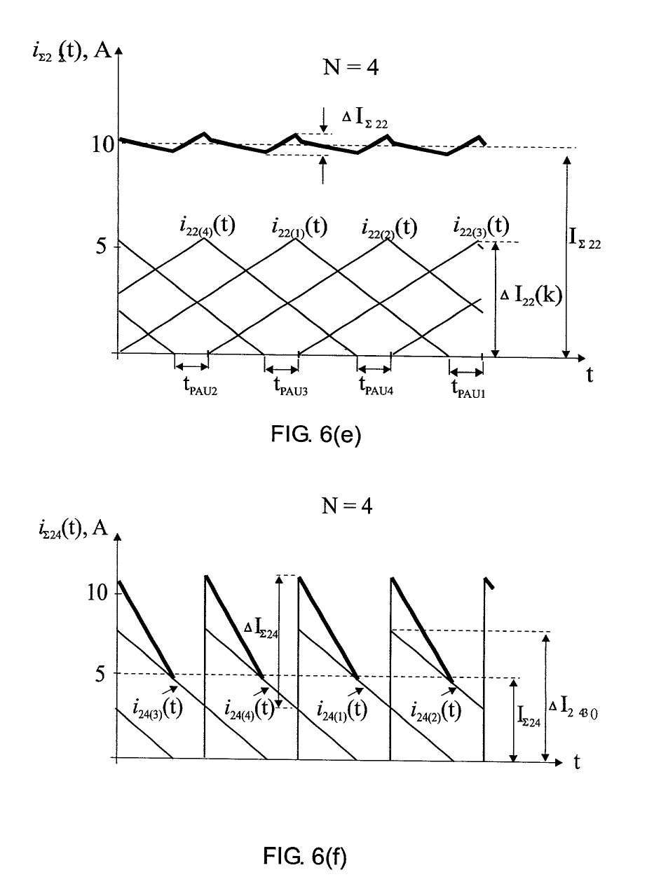

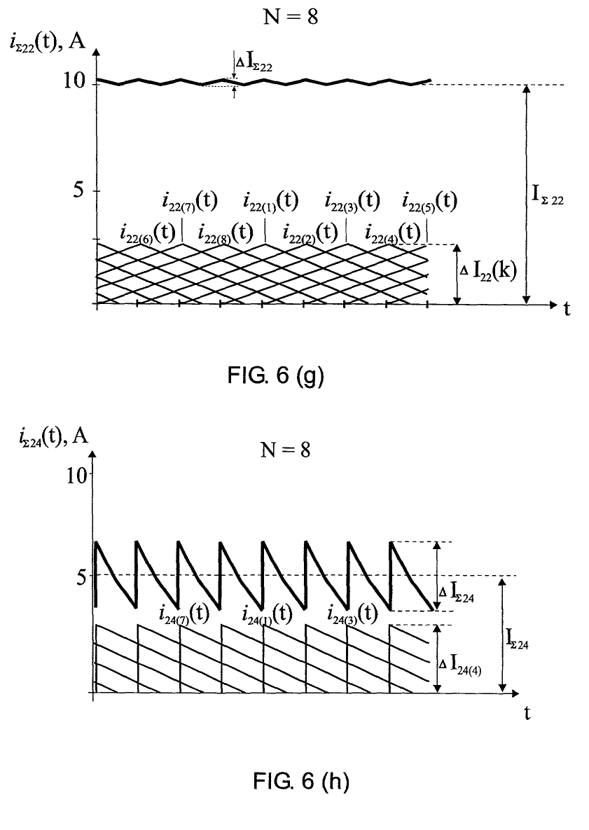

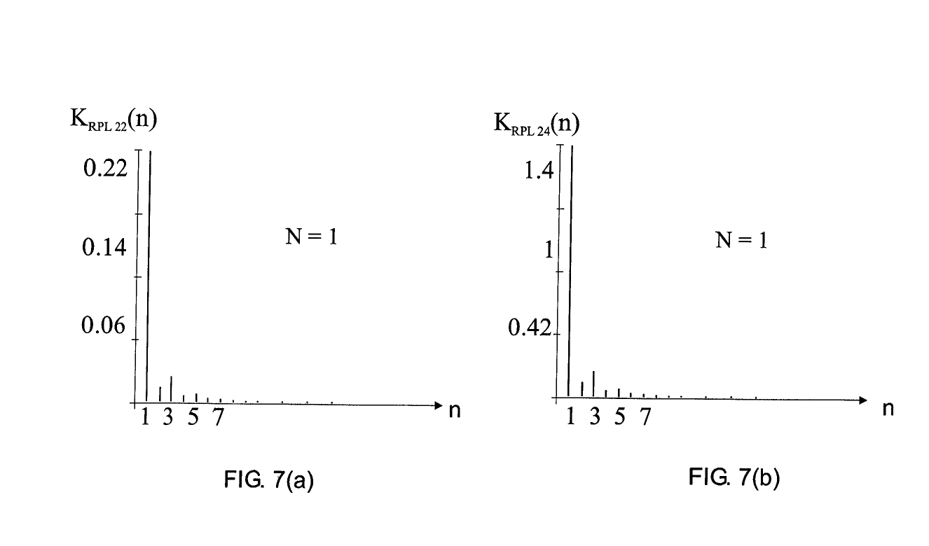

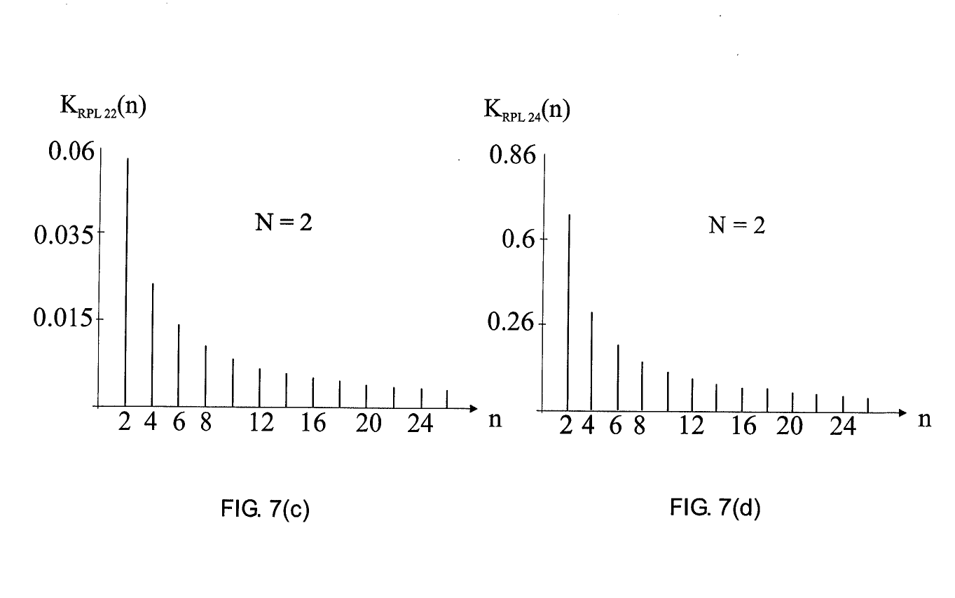

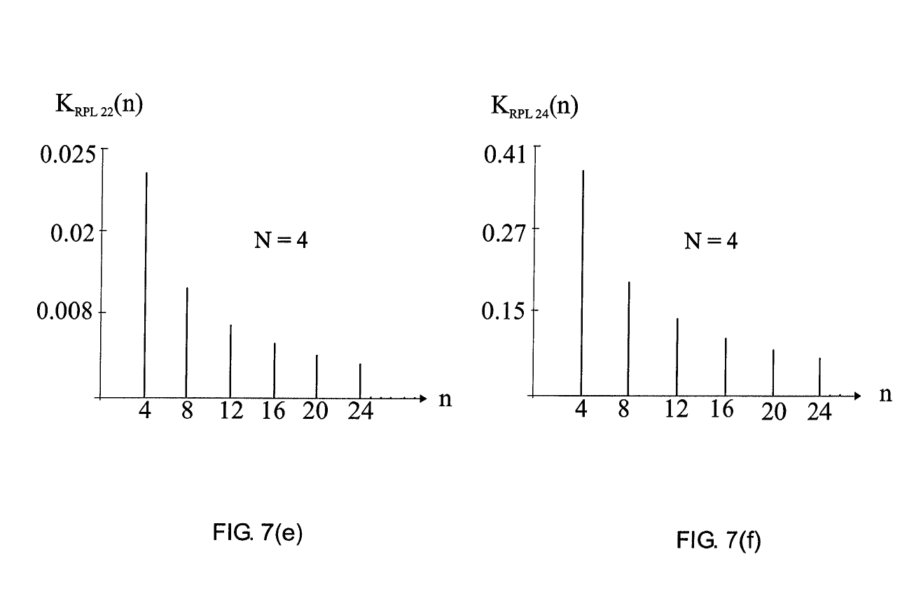

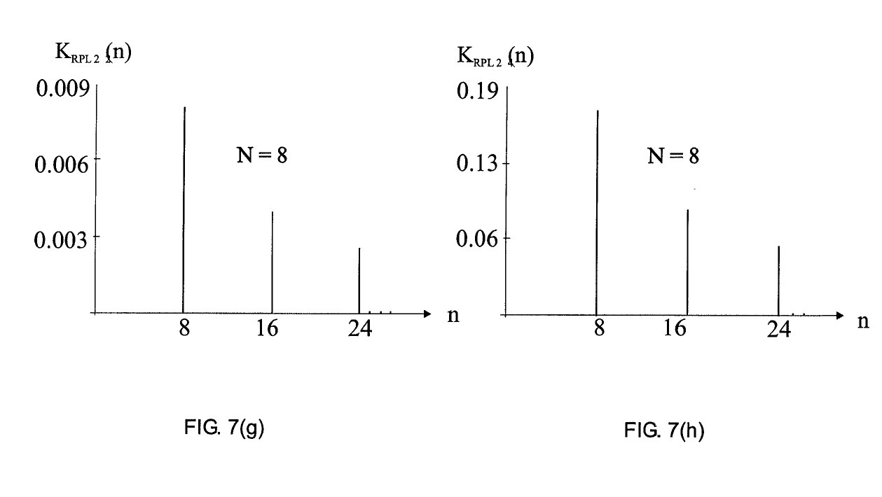

First control loop aims to insure a sinusoidal waveform of the current i_{AC}(t) consumed from the AC primary power source 10, and also to minimize phase shift between the waveforms of current i_{AC}(t) and AC voltage u_{AC}(t) provided by the AC primary power source 10, as shown in FIG. 4(a):

i_{AC}(t)=I_{ACmax} sin(2πf_{AC}t), [29]

I_{ACax}=P_{OUT}/ηU_{AC}, [30]

f_{AC}=1/T_{AC}, [31]

u_{AC}(t)=U_{ACmax} sin(2πf_{AC}t), [32]

U_{ACmax}=U_{AC} [33]

where: I_{ACmax} is a value for a maximal amplitude of the current consumed from the AC primary power source 10,

f_{AC} is a value for a frequency of the AC voltage provided by the AC primary power source 10,

T_{AC} is a value for a period of the AC voltage provided by the AC primary power source 10,

U_{AC} is a RMS value for the AC voltage provided by the AC primary power source 10,

P_{OUT} is a value for the power consumed by the system load 14, is a value for the power factor of the AC-DC converter 100

U_{ACmax} is a value for a maximal amplitude of the AC voltage provided by the AC primary power source 10.

For this purpose the sinusoidal-shape reference current waveform i_{REF}(t) is developed by applying the rectified voltage u_{IN}(t)≈|u_{AC}(t)| to the I_{AC} input port of the APFC controller 201 via the signal conditioning resistor 202.

Second control loop aims to provide a stable regulated DC output voltage U_{OUT} across the system load 14, i.e. at the output of the AC-DC converter 100.

For this purpose the feed-back signal u_{FB}(t) is developed by applying the output voltage U_{OUT} to the V_{FB} input port of the APFC controller 201 via the signal conditioning resistive divider 203.

To secure both a sinusoidal waveform of the current i_{AC}(t) consumed from the AC primary power source 10, and a stable regulated DC output voltage U_{OUT} across the system load 14, the system output current i_{OUT}(t) of the AC-DC converter 100 should be regulated in coordination with a waveform of the instantaneous AC power p_{AC}(t) consumed from the primary AC power source 10, as shown in FIG. 4(b), such that:

i_{OUT}(t)=p_{AC}(t)/U_{OUT}, [34]

p_{AC}(t)=i_{AC}(t)u_{AC}(t). [35]

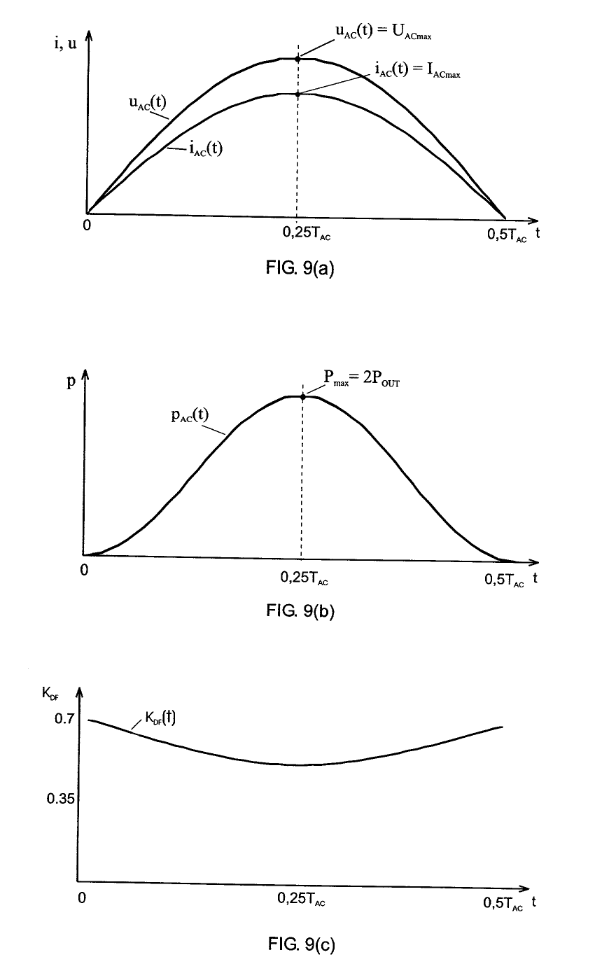

In a discontinuous current mode of operating the DC power conversion channel 16(k), the APFC controller 201 should develop the pulse-width-modulated (PWM) control signal u₂₀₁(t) with a time-controlled duty factor K_{D}(t), as shown in FIG. 9(c), such that:

$${K}_{D} ( t ) = \sqrt{2 {P}_{OUT} {L}_{1 ( K )} {U}_{OUT} - {u}_{IN} ( t ) / {T}_{PS} {U}_{OUT}} / {u}_{IN} ( t ) \qquad [ 36 ]$$

where: L₁₍ₖ₎ is an inductance value of the primary auto-transformer winding of the power storage inductor 22(k) within the DC power conversion channel 16(k);

T_{PS} is a value for a period of the controllable power switch operating frequency provided to all DC power conversion channels 16(k).

To insure discontinuous current mode for every DC power conversion channel 16(k), the value for L_{I(k)} should be defined such that:

L₁₍ₖ₎≦NT_{PS}U²_{Acmin}(U_{OUT}−U_{Acmin})/4P_{OUTmax}U_{OUT}, [37]

where: U_{ACmin} is a minimal RMS value for the AC voltage provided by the AC primary power source 10,

P_{OUTmax} is a maximal value for the power consumed by the system load 14.

In case of the tapless choke design chosen for the power storage inductors 22(k) for the cheapest embodiments of the present invention, the choke inductance value L₍ₖ₎ should be as defined in [37] considering that L₍ₖ₎=L₁₍ₖ₎.

FIGS. 9(a,b) illustrate the time-scaled waveforms of electric parameters attributed to the discussed embodiment of the proposed invention wherein the multi-channel DC-DC power converter 12 comprises N=4 DC-DC power conversion channels 16(k).

FIG. 9(c) illustrates the time-scaled diagram of the K_{D}(t) duty factor value regulation within the discussed embodiment of the proposed invention wherein the multi-channel DC-DC power converter 12 comprises N=4 DC-DC power conversion channels 16(k).

The operation of the synchronization circuit 300 will be discussed next.

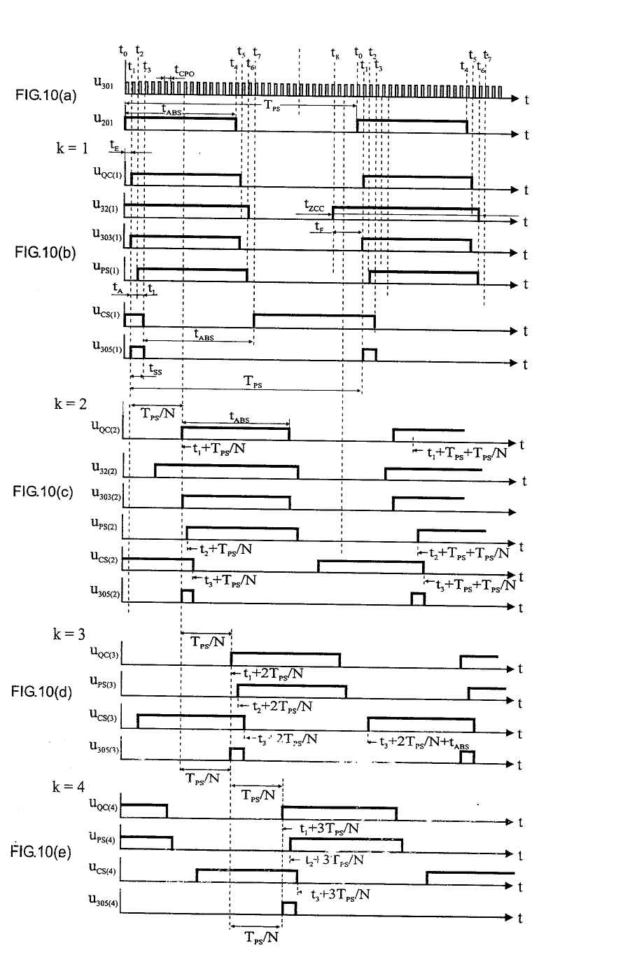

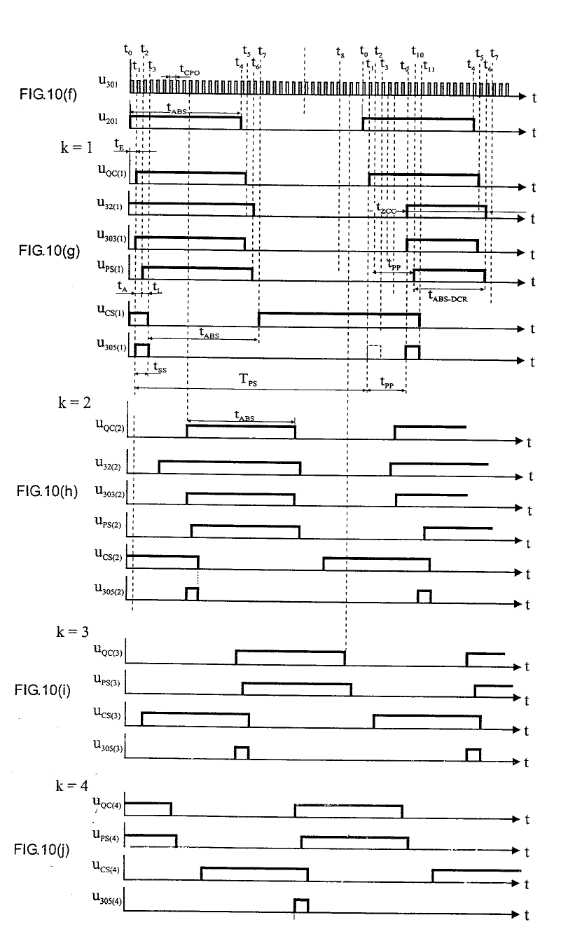

FIG. 10 illustrates the timing diagrams describing the operation of the synchronization circuit 300 incorporated into the various embodiments of the switching-mode AC-DC power converters according to the present invention.

FIG. 10(a) illustrates the time-scaled interrelationship between the ON-OFF control signal u₂₀₁(t) and the clocking signal u₃₀₁(t).

The ON-OFF control signal u₂₀₁₍t) produced by the V_{OUT} port of the APFC controller 201 is applied to the DATA port of the primary shift register 302 in the synchronization circuit 300.

Time t₀ is assigned for a leading edge of the high logic level ON-state pulse of the ON-OFF control signal u₂₀₁(t).

Time t₄ is assigned for the trailing edge of the high logic level ON-state pulse of the ON-OFF control signal u₂₀₁(t)

The time interval t₄−t₀=t_{ABS} is an absorption time interval corresponding to the conducting state of any one of the time-staggered controllable power switches 23(k) while the corresponding power storage inductor 22(k) accumulates the power absorbed from the primary AC power source 10 via the input AC-DC rectifier 11.

The time interval t′₀−t₄=t_{RLX} is a relaxation time interval corresponding to the non-conducting state of any one of the time-staggered controllable power switches 23(k) while the corresponding power storage inductor 22(k) releases the magnetically stored energy to the system load 14 via the corresponding power blocking rectifier 24(k).

The time interval t₀−t′₀=T_{PS} is the controllable power switch operation period of the high logic level ON-state pulses of the ON-OFF control signal u₂₀₁(t) corresponding to the duration of operational cycle within any one of the time-staggered DC-DC power conversion channels 16(k).

The clock pulse oscillator 301 produces a clocking signal u₃₀₁(t) shown in FIG. 10(a) to be applied to the CLOCK port of the primary shift register 302. The time interval t_{CPO} is the period of the clocking signal u₃₀₁(t), i.e. the period of the clocking frequency.

Time t₁ is assigned for a first-in-the-row appointed front edge of the high logic level ON-state pulse of the clocking signal u₃₀₁(t).

The value for the period T_{CPO} of the high logic level ON-state pulses of the clocking signal u₃₀₁(t) should be defined by the acceptable tolerance δ (in %) with which the duration t_{PS} of the high logic level ON-state pulse of the ON-OFF control signal u₂₀₁(t) should be repetitively reproduced, such that:

T_{CPO}≦0.01T_{PS}. [38]

At the leading edge of every u₃₀₁(t) high logic level ON-state clocking pulse the primary shift register 302 periodically latches the logic level of the ON-OFF control signal u₂₀₁(t) applied to its DATA port.

Since the internal clocking oscillator of the APFC controller 201 and the CPO 301 operate asynchronously with respect to each other, therefore, as shown in FIG. 10(a), the leading edge of the high logic level ON-state pulse of the ON-OFF control signal u₂₀₁(t) may be produced at time t₀, but only at time t₁ the leading edge of the consecutive u₃₀₁(t) high logic level ON-state pulse causes latching the high logic level within the internal first-bit flip-flop cell q₍₁₎ of the primary shift register 302 such that the high logic level of signal u_{Q(1)}(t) appears at its output Q₍₁₎. When the logic level of the ON-OFF control signal u₂₀₁(t) goes low at time t₄, the subsequent leading edge of the high logic level pulse of the u₃₀₁(t) signal at time t₅ causes latching the low logic level within the internal first-bit cell q₍₁₎ of the primary shift register 302 such that the low logic level of signal u_{Q(1)}(t) appears at its output Q₍₁₎.

The maximum error time interval t_{E}=Δt₀₁ between the leading edges of the high logic level ON-state pulses of the u₂₀₁(t) and u_{Q(1)}(t) signals should not exceed the duration of the period T_{CPO} of the high logic level ON-state pulses of the clocking signal u₃₀₁(t):

0≦t_{E}=Δt₀₁≦T_{CPO},

t_{E}=Δt₀₁=t₁−t₀. [39]

Further, regardless of the logic state at the DATA port of the primary shift register 302 and coincidentally with the front edge of each consecutive u₃₀₁(t) pulse, the logic state of every internal flip-flop cell q is shifted to the next cell in the chain.

As a result, the flip-flop cells q of the primary shift register 302 provide D₃₀₂ number of time-staggered high logic level ON-state pulses which are progressively delayed replicas of the high logic level ON-state pulse of the u₂₀₁(t) signal.

Further, the “channel” clocking signals should be related to those provided by the primary shift register 302 such that the time displacement interval Δt_{dspl}=T_{PS}/N according to [24] should be secured between the leading edges of the high logic level ON-state pulses of the sequential “channel” pulses.

Naturally, there should be N number of the “channel” clocking signals each assigned to the corresponding DC-DC power conversion channel 16(k).

The “channel” clocking signals are provided by the corresponding Q_{C(k)} outputs of the primary shift register 302.

Therefore, the “channel” Q_{C(k)} outputs of the primary shift register 302 produce N number of u_{QC(k)}(t) signals which conform to the u₂₀₁(t) signal and are time staggered such that the time displacement interval Δt_{dspl}=T_{PS}/N is maintained between the leading edges of the high logic level ON-state pulses of the sequential “channel” pulses.

Accordingly, the “channel” clocking signals should be indexed as u_{QC(1)}(t), . . . , u_{QC(k)}(t), . . . , u_{QC(N)}(t) respectively.

FIGS. 10(b,c,d,e) illustrate the time-scaled waveforms of the synchronization signals produced within a synchronization circuit comprising N=4 DC-DC power conversion channels (k=1, 2, 3, 4), where k is an index of the sequential channel.

As can be seen, the same-indexed signals within the sequential channels are time staggered such that the time displacement interval Δt_{dspl}=T_{PS}/N interval between their corresponding edges is constant. Therefore, the operational cycles and power conversion processes within the corresponding DC-DC power conversion channels 16(k) are sequentially time-staggered with equal time displacement intervals Δt_{dspl}=T_{PS}/N.

To provide the “channel” clocking signals u_{QC(k)}(t), the corresponding “channel” flip-flop cells q of the primary shift register 302 may be selected of those “physical” such that:

Q_{C(k)}=T_{PS}(k−1)/T_{CPO}N+1,(k=1,2, . . . ,N), [40]

where: Q_{C(k)} is a sequential number of the flip-flop cell q providing its output signal to clock the k-th channel;

and the time displacement interval Δt_{dspl(k)} between the leading edge of the high logic level ON-state pulse of the first-in-the-row appointed “channel” signal u_{QC(1)}(t) and the leading edge of the high logic level ON-state pulse of any other “channel” signal u_{QC(k)}(t) may be defined as:

Δt_{dspl(K)}=T_{PS}(k−1)/N,(k=1,2, . . . ,N), [41]

The leading edge of the high logic level ON-state pulse of the last-in-the-row appointed “channel” signal u_{QC(N)}(t) is shifted in respect to the leading edge of the high logic level ON-state pulse of the u₂₀₁(t) signal for a maximum time-delay interval Δt_{Smax} such that:

Δt_{Dmax}=T_{PS}(N−1)/N+T_{CPO}, [42]

Therefore, the “digital” length D₃₀₂, i.e. the quantity of internal flip-flop cells q within the primary shift register 302 should be defined as:

D₃₀₂=Δt_{Dmax}/T_{CPO}, [43]

or, according to [38], as:

D₃₀₂=(N−1)/0.01δN+1. [44]

Further, the corresponding u_{QC(k)}(t) time-staggered signals are applied to first inputs of the corresponding primary 2-input AND logic gates 303(1), . . . , 303(k), . . . , 303(N) respectively.

FIG. 10(b) illustrates the timing diagrams describing the logic signals developed within the first DC-DC power conversion channel, i.e. k=1, and thereafter the indexed time-points and events assigned to each subsequent channel will be reproduced for all other channels with equal time displacement interval Δt_{dspl(k)} according to [41] being maintained.

The second inputs of corresponding primary 2-input AND logic gates 303(k) are connected to the outputs of corresponding zero-current detectors 32(k) within the corresponding DC-DC power conversion channels 16(k), i.e. to the outputs of the 32(1), . . . , 32(k), . . . , 32(N) respectively. Therefore, the corresponding u₃₂₍ₖ₎(t) signals are applied to the second inputs of the corresponding primary 2-input AND logic gates 303(1), . . . , 303(k), . . . , 303(N) respectively.

During the time interval t₅−t₁≈t_{ABS} while both inputs of the corresponding primary 2-input AND logic gate 303(k) are subjected to high logic level, its output produces a high logic level ON-state pulse of the u₃₀₃₍ₖ₎(t) signal.

Naturally, the duration of the high logic level ON-state pulse of the corresponding u₃₀₃₍ₖ₎(t) signal is equal to t₅−t₁≈t_{ABS} time interval, i.e. equal to that of the corresponding u_{QC(k)}(t) signal and to that of the ON-OFF control signal u₂₀₁(t).

Therefore, as shown in FIG. 10, in the quasi-steady state the primary logic gates 303(k) produce N number of high logic level ON-state pulses of the u₃₀₃₍ₖ₎(t) output signals which conform (within limits imposed by the quantizing error caused by the period of 301) to the high logic level ON-state pulse of the U_{QC(k)}(t) output signals of the primary shift register 302.

Their duration is also equal to t_{ABS} absorption time interval, their period is also equal to T_{PS} controllable power switch operation period, and their leading edges are also sequentially shifted for a Δt_{dspl}=T_{PS}/N time interval.

Further, the corresponding u₃₀₃₍ₖ₎(t) signals are applied to the DATA ports of the corresponding secondary shift registers 304(1), . . . , 304(k), . . . , 304(N) respectively, and to the first inputs of the corresponding secondary logic gates 305(1), . . . , 305(k), . . . , 305(N) respectively.

The clock pulse oscillator 301 produces a clocking signal u₃₀₁(t) shown in FIG. 10(a) to be applied to the CLOCK ports of the secondary shift registers 304(k).

Coincidentally to the leading of every u₃₀₁(t) pulse each secondary shift register 304(k) periodically latches the data loaded to its DATA port and shifts them along the chain of its internal flip-flop cells q.

The outputs Q_{PS(k)} and Q_{CS(k)} of each secondary shift register 304(k) produce the logic pulses of the u_{PS}(t) and u_{CS}(t) output signals respectively, and the respective leading edges are time-shifted in respect to the leading edge of the high logic level ON-state pulse of the corresponding u₃₀₃(t) output signal such that:

t₂−t₁=t_{A},

t₃−t₂=t_{L},

t_{A}+t_{L}=t_{SS}, [45]

where:

t₁ is a time assigned to the leading edge of the high logic level u₃₀₃(t) pulse produced at the output of corresponding primary logic gate 303(k),

t₂ is a time assigned to the leading edge of the high logic level u_{PS}(t) pulse produced at the Q_{PS} output of the corresponding secondary shift register 304(k),

t₃ is a time assigned to the leading edge of the low logic level u_{CS}(t) pulse produced at the Q_{CS} output of corresponding secondary shift register 304(k),

t_{A} is an advance time interval of turning on the corresponding controllable commutating switch 30(k) into conducting state prior to corresponding controllable power switch 23(k) being turned into conducting state (the reason for this will be discussed in later paragraphs);

t_{L} is a lag time interval of turning the corresponding controllable commutating switch 30(k) into non-conducting state after the corresponding controllable power switch 23(k) being turned into conducting state (the reason for this will be discussed in later paragraphs);

t_{SS} is a soft-switching time interval of corresponding controllable commutating switch 30(k) being turned into conducting state (to be discussed in later paragraphs).

The “digital” length D₃₀₄₍ₖ₎, i.e. the quantity of internal flip-flop cells q within each secondary shift register 304(k) should be defined as:

D₃₀₄₍ₖ₎≧t_{SS}/0.01δT_{CPO}+1. [46]

To provide the “channel” control signals u_{PS(k)}(t) and u_{CS(k)}(t) the corresponding “channel” flip-flop cells q of the primary shift register 304 may be selected such that:

Q_{PS(k)}=t_{A}/T_{CPO}+1, [47]

and:

Q_{CS(k)}=t_{SS}/T_{CPO}+1, [48

where: Q_{PS(k)} and Q_{CS(k)} are the sequential numbers of the flip-flop cells q providing their output signals u_{PS(k)}(t) and u_{CS(k)}(t) respectively.

Therefore, as shown in FIG. 10, in a quasi-steady state the Q_{PS(k)} outputs of the secondary shift registers 304(k) produce N number of high logic level ON-state pulses of the u_{PS(k)}(t) signals which conform (within limits imposed by the quantizing error caused by the period of 301) to the high logic level ON-state pulses of the u_{QC(k)}(t) output signals of the primary shift register 302 Their duration is also equal to the t_{ABS} absorption time interval, their period is also equal to T_{PS} controllable power switch operation period of the operational cycle, and their leading edges are also sequentially shifted for a time displacement Δt_{dspl}=T_{PS}/N interval.

Consequently, as shown in FIG. 10, in a quasi-steady state the Q_{CS(k)} outputs of the secondary shift registers 304(k) produce N number of the low logic level pulses of the u_{CS(k)}(t) signals which are conform (within limits imposed by the quantizing error caused by the period of 301) to the high logic ON-state pulses (when being inversed) of the u_{QC(k)}(t) output signals of the primary shift register 302. Their duration is also quite equal to t_{ABS} absorption time interval, their period is equal to T_{PS} controllable power switch operation period of the operational cycle, and their leading edges are also sequentially shifted for a time displacement Δt_{dspl}=T_{PS}/N interval.

During the time when both inputs of the corresponding secondary 2-input AND logic gate 305(k) are subjected to high logic level, its output produces a high level logic ON-state pulse of an u₃₀₅₍ₖ₎(t) signal.

The duration of the high logic level ON-state pulse of the corresponding u₃₀₅₍ₖ₎(t) signal is quite equal to t_{SS} soft-switching time interval of corresponding controllable commutating switch 30(k) being turned into conducting state.

Consequently, as shown in FIG. 10, in a quasi-steady state the outputs of the secondary 2-input AND logic gates 305(k) produce N number of high logic level ON-state pulses of the corresponding u₃₀₅₍ₖ₎(t) signals which conform to each other (within limits imposed by the quantizing error caused by the period of 301). Their duration is equal to tss soft-switching time interval of corresponding controllable commutating switch 30(k) being turned into conducting state, their period is equal to T_{PS} controllable power switch operation period of the operational cycle, and their leading edges are also sequentially shifted for a Δt_{dspl}=T_{PS}/N time displacement interval.

The Q_{PS(k)} outputs of the corresponding secondary shift registers 304(1), . . . , 304(k), . . . , 304(N) are connected to the gates of the controllable power switches 23(k) within the corresponding DC-DC power conversion channels 16(1), . . . , 16(k), . . . , 16(N) respectively via the corresponding PS(k) (power switch) outputs of the synchronization circuit 300, i.e. PS(1), . . . , PS(k), . . . PS(N) respectively.

The outputs of the secondary 2-input AND logic gates 305(1), . . . , 305(k), . . . , 305(N) are connected to the gates of the controllable commutating switches 30(k) within the corresponding DC-DC power conversion channels 16(1), . . . , 16(k), . . . , 16(N) respectively via the corresponding SS(k) (soft switching) outputs of the synchronization circuit 300, i.e. SS(1), . . . , SS(k), . . . SS(N) respectively.

The t_{A} advance time interval should be defined such that by the time t₂ the corresponding active soft-switching conditioner 26(k) should produce a zero-voltage condition across the corresponding controllable power switch 23(k).

The t_{L} lag time interval should be defined such that by the time t₃ the corresponding controllable power switch 23(k) should be in a reliably conducting state, i.e. t_{SS}>t_{A}.

Since the Q_{PS(k)} outputs of the corresponding secondary shift registers 304(1), . . . , 304(k), . . . , 304(N) drive the gates of the controllable power switches 23(k) within the corresponding DC-DC power conversion channels 16(1), . . . , 16(k), . . . , 16(N) respectively in a uniformly time-staggered fashion, then the main electric processes within the DC-DC power conversion channels 16(k) conform to each other and are sequentially time-staggered with respect to each other with a time displacement Δt_{dspl}=T_{PS}/N interval.

FIG. 4(a) illustrates the nature of the operational cycle within the DC-DC power conversion channel 16(k).

In the quasi-steady state at some reference time, for example t₀, as shown in FIG. 4(a), the controllable power switch 23(k) is closed/conducting, the power storage inductor 22(k) is connected across the input AC-DC rectifier 11, the power blocking rectifier 24(k) is non-conducting while being reverse-biased by the voltage stored across the system output smoothing filter 17, therefore the system load 14 is disconnected from the input AC-DC rectifier 11 and is powered by the energy stored in the system output smoothing filter 17.

While the rectified input voltage u_{IN}(t) produced by the input AC-DC rectifier 11 is applied across the power storage inductor 22(k), the current i₂₂(t) through it increases in a linear fashion and, thus accumulating the magnetically stored energy within the power storage inductor 22, reaches its maximum value at time t₀₁.

Now the controllable power switch 23(k) is turned into open/non-conducting state, the power blocking rectifier 24(k) turns into forward-biased/conducting state, and the energy magnetically stored within the power storage inductor 22(k) is transferred through the power blocking rectifier 24(k) to the system output smoothing filter 17 and to the system load 14. The current i₂₂(t) through the power storage inductor 22(k) starts decreasing in a linear fashion and reaches its minimum value by the end of the operational cycle at time t₀₂. Then the operational cycle may be re-started.

To start the next operational cycle the controllable commutating switch 30(k) is turned into closed/conducting state again.

Further operation will be discussed referring to FIG. 10.

To secure the low-loss discontinuous current mode, each DC-DC power conversion channel 16(k) comprises a current sensing coil W₃(k) within each power storage inductor 22(k) and a zero-current detector 32(k) to detect the non-zero i_{RLS(k)}(t) release current flow within the power storage inductor 22(k) during the t_{RLS} release time interval of releasing the magnetically stored energy.

While the corresponding current sensing coil W₃(k) senses the non-zero i_{RLS(k)}(t) release current within its power storage inductor 22(k), the corresponding zero-current detector 32(k) produces a low logic level at its output thus preventing the corresponding primary 2-input AND gate 303(k) from loading the high logic level to the DATA port of the corresponding secondary shift register 304(k) and to the first input of the corresponding secondary 2-input AND gate 305(k).

Therefore, no high logic level is produced at the corresponding PS(k) and SS(k) outputs of the synchronization system 300 until the i_{RLS(k)}(t) release current flow within the corresponding power storage inductor 22(k) reaches zero.

At this moment the corresponding zero-current detector 32(k) produces a high logic level at its output thus enabling the corresponding primary 2-input AND gate 303(k) to load the high logic level to the DATA port of the corresponding secondary shift register 304(k) and to the first input of the corresponding secondary 2-input AND gate 305(k) provided that the corresponding “channel” output Q_{C(K)} of the primary shift register 302 also applies the high logic level to the second input of the corresponding primary 2-input AND gate 303(k).

Therefore, the synchronization circuit 300 postpones the successive operational cycle for indefinite time by preventing the controllable switches within any corresponding DC-DC power conversion channel 16(k) from being turned into conducting state prior to the i_{RLS(k)}(t) release current flow within the corresponding power storage inductor 22(k) reaching zero.

In this method, the indispensable condition of low-loss discontinuous current mode within each DC-DC power conversion channel 16(k) is insured: the i_{RLS(k)}(t) release current flow within the corresponding power storage inductor 22(k) should be equal to zero prior to the start of the next operational cycle.

FIG. 10(b,c) illustrate the u₃₂₍₁₎(t) and u₃₂₍₂₎(t) signals produced by the corresponding zero-current detectors 32(1) and 32(2) within the corresponding DC-DC power conversion channels 16(1) and 16(2).

Time t₈ is assigned for the leading edge of the high logic level pulse of the u₃₂₍₁₎(t) signal of the zero-current detector 32(1).

To secure the low-loss discontinuous current mode within each DC-DC power conversion channel 16(1), the leading edge of the high logic level pulse of the u₃₂₍₁₎(t) signal precedes the leading edge of the high logic level pulse of the corresponding U_{QC(1)}(t) signal for a time interval t_{F}=t′₁−t₈. The forward time interval t_{F} insures the t_{PAU} pause interval according to [12] while the corresponding power storage inductor 22(1) is current-free.

The same is equally applicable to all other channels in the row, and each zero-current detector 32(k) within the corresponding DC-DC power conversion channel 16(k) detects the non-zero i_{RLS(k)}(t) release current flow within the power storage inductor during the release time interval t_{RLS(k)} of releasing the magnetically stored energy to the load.

The release time interval t_{RLS(1)} starts at time t₆ and lasts until time t′₂ of the successive operational cycle.

Starting from time t₇ the zero-current detector 32(1) outputs a low logic level till time t₈ when the i_{RLS(1)}(t) release current flow within the power storage inductor 22(1) reaches zero.

This low logic level prevents producing the high logic level pulse u_{PS(1)}(t), i.e. triggering the controllable power switch 23(1) into the conducting state.

This is to provide a t_{PAU}=t′₂−t₈ pause interval before the start of the subsequent operational cycle thus insuring the discontinuous current mode within the power storage inductor 22(1).

During the switch operation allowance time interval t_{SOA} after time t₈ till time t′₆ of the sequential operational cycle the zero-current detector 32(1) outputs a high logic level thus enabling the high logic level pulse u_{PS(1)}(t), i.e. triggering the controllable power switch 23(1) into the conducting state.

FIGS. 10(f, g, h, i, j) illustrate the time-scaled waveforms of the synchronization signals within the same 4-channel AC-DC power converter provided that a i_{RLS(1)}(t) release current flow within the power storage inductor 22(1) does not reach zero at time t₈. In this case the zero-current detector 32(1) outputs a low logic level from time t₆ till time t₉ when the i_{RLS(1)}(t) release current flow within the power storage inductor 22(1) reaches zero, thus delaying the start of the next operational cycle for a time interval tₚₚ=t₁₀−t′₂. Therefore, the switch operation allowance time interval for the successive operational cycle is decreased to a t_{SOA-DCR} value, and the cycle lasts during the decreased absorption time interval t_{ABS-DCR}. The ON-state pulse of the corresponding soft-switching synchronization signal u₃₀₅₍₁₎(t) is also postponed for the same postponement time interval tₚₚ: it starts at time t₉ and ceases at time t₁₁.

Monitoring the non-zero-current i_{RLS(k)}(t) within each DC-DC power conversion channel 16(k) provides an independent initiation of the successive operational cycles thus providing the sufficient reliability of securing the low-loss discontinuous current mode regardless of all other conditions.

To prevent possible damage, the control circuit 200 includes an over-voltage detector 204 to prevent the operation of all controllable switches within all DC-DC power conversion channels 16(k), i.e. to inhibit the power conversion process in case the value of the regulated output DC voltage of the AC-DC power converter 100 exceeds the preset maximum threshold, and to enable the operation of all controllable switches within all DC-DC power conversion channels 16(k) as soon as the regulated output DC voltage recovers the correct value, i.e. to restore the power conversion process as soon as the regulated output DC voltage falls below the preset minimum threshold in a hysteretic fashion.

For this reason the over-voltage detector 204 monitors the regulated output DC voltage of the AC-DC power converter 100.

Normally, the over-voltage detector 204 outputs the low logic level to the RESET inputs of the shift registers 302, 304(k), thus enabling normal operation of the DC-DC power conversion channels 16(k).

In case the value of the regulated output DC voltage exceeds the maximum preset threshold, the over-voltage detector 204 outputs a high logic level to the RESET inputs of the shift registers 302, 304(k). This results in immediately bringing to a low logic level all PS(k) and SS(k) outputs of the synchronization circuit 300 and, therefore, in immediate turning all controllable switches within all DC-DC power conversion channels 16(k) into the non-conducting state.

As a result, the overall power conversion process is inhibited for indefinite time.

As soon as the regulated output DC voltage falls below the minimum preset threshold, the over-voltage detector 204 outputs the low logic level to the RESET inputs of the shift registers 302, 304(k), thus enabling the operation of all controllable switches within all DC-DC power conversion channels 16(k), i.e. restoring the overall power conversion process.

The hysteretic fashion of operation is provided by the corresponding design of the over-voltage detector 204.

Next, the operation of the active soft-switching conditioner 26(k) will be discussed with the reference to the time-scaled waveforms illustrated in FIGS. 10(a,b).

As for example, in the quasi-steady state prior to time t₁ the controllable power switch 23(1) is open/non-conducting, the power blocking rectifier 24(1) is reverse-biased/non-conducting thus providing no current path from the AC primary power source 10 to the power storage inductor 22(1) and to the output smoothing filters 25(1), 17 and to the load 14.

The power storage inductor 22(1) is current-free and energy-free.

The components of the active soft-switching conditioner 26(1) are current-free.

The controllable commutating switch 30(1) within the active soft-switching conditioner 26(1) is open/non-conducting.

The voltage across the slope-shaping capacitor 28(1) and across the controllable commutating switch 30(1) is equal to u_{IN}(t) produced by the input AC-DC rectifier 11. This is due to the chosen discontinuous current mode of operation. In case of continuous current mode the value of the voltage across the slope shaping capacitor 28(1) and across the controllable commutating switch 30(1) would be equal to much higher level of U_{OUT}.

The output smoothing filters 25(1), 17 and the system load 14 are powered by those DC-DC power conversion channels 16(k) currently releasing the magnetically stored energy from corresponding power storage inductors 22(k).

At time t₁ the high logic level pulse outputted by the corresponding secondary 2-input AND logic gate 305(1) triggers the controllable commutating switch 30(1) into the closed/conducting state, and now the u_{IN}(t) voltage produced by the input AC-DC rectifier 11 is applied to the network of series-connected power blocking rectifier 24(1) and a damp/resonant choke 29(1).

Past this time the process is defined by the LC resonant tank consisting of parallel-connected damp/resonant choke 29(1) and the slope-shaping capacitor 28(1) within the active soft-switching conditioner 26(1).

The current i₂₉(t) through the damp/resonant choke 29(1) starts increasing and the voltage across the slope-shaping capacitor 28(1) starts decreasing in accordance with [18].

Since the power storage inductors 22(1) and the power blocking rectifier 24(1) are current-free, then the maximum current i^{29max} defined in accordance with [21] is substantially less than that corresponding to the continuous current mode.

The sine waveform of the current through the damp/resonant choke 29(1) and the sine waveform of the voltage across the slope-shaping capacitor 28(1) would last until time t_{ON(27)}, when the voltage u₂₈(t) across this capacitor and across the controllable power switch 23(1) reaches zero and the shunting rectifier 27(1) becomes forward-biased/conducting. The components values are definitely chosen to secure the condition that t_{ON(27)}<t₂, i.e. the zero-voltage-across condition for the controllable power switch 23(1) should be provided prior to time t₂.

Therefore, during the interval between time t₁ and time t₂ the damp/resonant choke 29(1) performs a resonant inductor function within the L₂₉C₂₈ resonant tank. Within this interval the sinusoidal fashion of discharging the capacitor 28(1) within the active soft-switching conditioner 26(1) is provided as preparation for switching the controllable power switch 23(1) into closed/conducting state under zero-voltage-across condition at time t₂.

The duration of the advance time interval t_{A}=t₂−t₁ is defined at least with a quarter of the period of the natural resonant frequency of the LC-tank consisting of the damp/resonant choke 29(1) coupled to the slope-shaping capacitor 28(1).

Starting from the time t₂, the controllable power switch 23(1) may be turned into closed/conducting state under zero-voltage-across conditions at any time prior to controllable commutating switch 30(1) being turned into open/non-conducting state.

Therefore, the favorable soft-switching condition, i.e. zero-voltage-across/zero-current-through is provided for the controllable power switch 23(1) during its transition to closed/conducting state which results in zero switching losses.

Starting from the time t_{ON(27)}<t2 the damp/resonant choke 29(1) is short-shunted by the forward-biased/conducting shunting rectifier 27(1) and the closed/conducting controllable commutating switch 30(1).

Such a state would last till the time t₃ when the controllable commutating switch 30(1) is turned into open/non-conducting state by the u₃₀₅₍₁₎(t) signal.

At time t3 the separating rectifier 31(1) becomes forward-biased/conducting to provide the release of the magnetically stored energy from the damp/resonant choke 29(1) to the system load 14 up to the time when the i₂₉(t) current reaches zero.

Starting from the time t_{ON(27)} the power storage inductor 22(1) is subjected to the voltage u_{IN}(t) produced by the input AC-DC rectifier 11.

At time t₂ the controllable power switch 23(1) is turned to closed/conducting state, and the power storage inductor 22(1) starts absorbing the current from the input AC-DC rectifier 11 and accumulating the magnetically stored energy.

Within the absorption interval t_{ABS}=t₆−t₂ the i₂₂₍₁₎(t) current increases up to reaching its maximum value i₂₂₍₁₎ₘₐₓ=ΔI₂₂₍₁₎.

At time t₆ the controllable power switch 23(1) is turned to open/non-conducting state, and the cycle of absorbing the energy through it ends. The i₂₂₍₁₎(t) current starts flowing through the slope-shaping capacitor 28(1), therefore, charging it up to a voltage that exceeds the regulated output DC voltage for a voltage drop across the forward-biased/conducting power blocking rectifier 24(1).

The duration of the time interval between the controllable power switch 23(1) transition to the open/non-conducting state and the power blocking rectifier 24(1) transition to forward-biased/conducting state depends on the capacitance value of the slope-shaping capacitor 28(1) and on the value of i₂₂₍₁₎ₘₐₓ, and is chosen to provide the loss-less conditions for the controllable power switch 23(1) during its transition to open/non-conducting state.

Starting from time t₆ and during the t_{RLS}=t₈−t₆ release time interval the power storage inductor 22(1) releases the magnetically stored energy to the system load 14 up to the time t₈ when i₂₂₍₁₎(t) current reaches zero.

During the t_{RLS} release time interval the i₂₂₍₁₎(t) current flows through the power blocking rectifier₂₄₍₁₎ This current, i₂₄₍₁₎(t), decreases slowly to zero. This fact results in nearly loss-less reverse resistance recovery, i.e. elimination of the switching transition losses inherent in the power blocking rectifiers subjected to the continuous current mode.

As soon as the i₂₂₍₁₎(t) current reaches zero at time t₈, the zero-current detector 32(1) produces an output high logic level lasting during the t′₆−t₈=t_{OCA} operational cycle allowance interval to enable the next operational cycle.

Employing the tapped auto-transformer choke design for the power storage inductors 22(k) provides the additional benefits to the proposed embodiment of the present invention.

If each power storage inductor 22(k) is ascribed with an auto-transformation factor n_{2/1}=w₂/w₁ such that n_{2/1}>1, then the maximum voltage u₂₃₍ₖ₎ₘₐₓ across the open/non-conducting controllable power switch 23(k) and, accordingly, across the slope-shaping capacitor 28(k) is reduced proportionally to the n_{2/1} value:

u₂₃₍ₖ₎ₘₐₓ=u₂₈₍ₖ₎=u_{IN}(t)+(U_{OUT}−u_{IN}(t))/n_{2/1}, [49]

Reducing the voltage across the slope-shaping capacitor 28(k) results in reduction of losses occurring due to re-charging process, and in reduction of currents i₂₉₍ₖ₎ₘₐₓ, i₃₀₍ₖ₎ₘₐₓ flowing through the components of the active soft-switching conditioner 26(k).

The maximum value of i₂₄₍ₖ₎ₘₐₓ current though the power blocking rectifier 24(k) is also reduced with increasing the value of n_{2/1}:

i₂₄₍ₖ₎ₘₐₓ=i₂₄₍ₖ₎ₘₐₓ/n_{2/1}, [50]

Therefore, the reduction of electrical stress upon the current carrying components, provides an opportunity to utilize components with less power carrying capability, and to enhance the utilization of component capabilities.

Besides, the fact that increasing the n_{2/1} results in reduction of i₂₄₍ₖ₎ₘₐₓ current and in increasing the release factor K_{RLS} defined as:

i₂₄₍ₖ₎ₘₐₓ=i₂₄₍ₖ₎ₘₐₓ/n_{2/1}, [50]

results in reduction of output ripple as defined in [22] and [23].

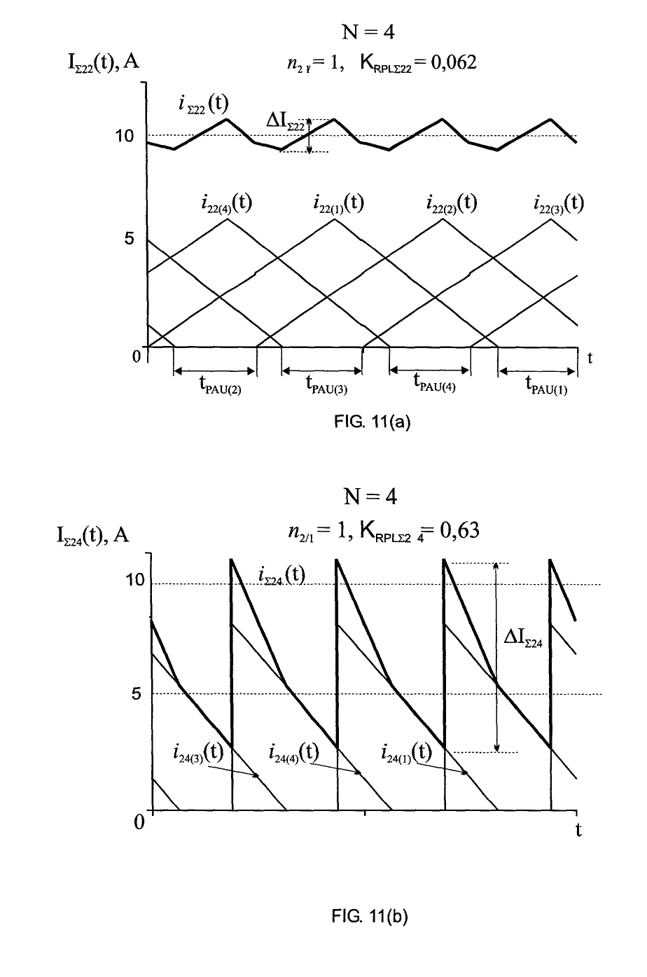

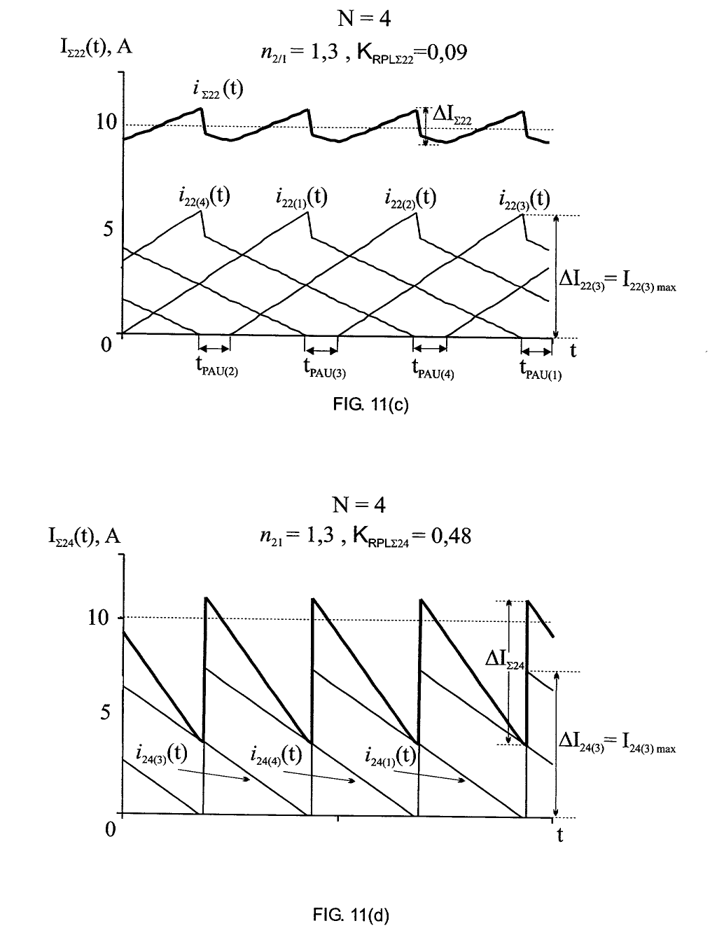

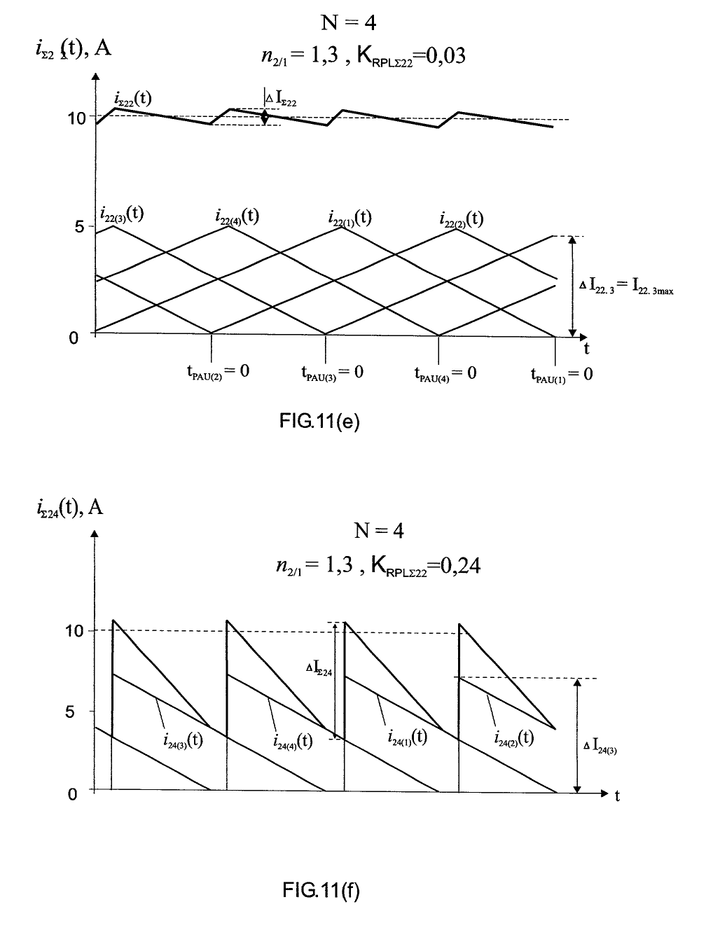

FIGS. 11(a,b) illustrate the time—scaled waveforms of currents and voltages attributed to the power conversion processes within the first embodiment of the switching-mode AC-DC power converter according to the present invention.

The value of the auto-transformation factor n_{2/1}=1 corresponds to the tapless choke design of the power storage inductor 22(k). As can be seen, regardless of the discontinuous current mode within the separate DC-DC power conversion channels, a high quality continuous current is maintained within the input and output circuitries of the AC-DC power converter.

According to the second embodiment of the present invention, FIG. 8(b) illustrates a circuit diagram of a multi-channel AC-DC converter 100 comprising a conventional APFC controller 201 designed to secure the continuous current mode within a conventional single-channel AC-DC power converter of a pulse width modulation type.

In this case a multi-channel AC-DC converter 100 additionally comprises a total consumption current sensor 40 and a current signals summator 41 including first summing resistor 42, second summing resistor 43 and a DC inhibiting capacitor 44.

The output signal of the non-zero-current detector 33(1) of the first-in-the-row DC-DC power conversion channel 16(1) monitors the value of the current flow within the power storage inductor 22(1) to produce an output signal proportional to the sum of the current flows within both the controllable power switch 23(1) and the power blocking rectifier 24(1).

This output signal is further applied to the second summing resistor 43 via the DC inhibiting capacitor 44, both of the current signals summator 41.

The total consumption current sensor 40 monitors the total input current consumed by the AC-DC power converter 100 to produce an output signal proportional to the total input current consumed by all DC-DC power conversion channels 16(k).

This output signal is further applied to the first summing resistor 42 of the current signals summator 41.

The resistance values of the summing resistors 41, 42 are chosen in proportion to the values of the summed signals such that the resultant signal at their common junction simulates a current feedback signal conforming to that of the single-channel AC-DC power converter of the same capacity as of the multi-channel AC-DC power converter 100.

This simulated current feedback signal is further applied to the current feedback input of the conventional APFC controller 201 for securing the predetermined quality of the converted power ascribed with power factor and regulated output DC voltage stability.

FIG. 11(c,d) illustrate the time—scaled waveforms of currents and voltages attributed to the power conversion processes within the second embodiment of the switching-mode AC-DC power converter according to the present invention.

The value of the auto-transformation factor n_{2/1}=1,3 corresponds to the tapped auto-transformatory choke design of the power storage inductor 22(k). As can be seen, regardless of the discontinuous current mode within the separate DC-DC power conversion channels, the high quality continuous current mode is secured within the input and output circuitries of the AC-DC power converter.

According to the third embodiment of the present invention, FIG. 8(c) illustrates a circuit diagram of a multi-channel AC-DC converter 100 comprising a conventional APFC controller 201 designed to insure the critical current mode and a variable operational frequency within a conventional single-channel AC-DC power converter.

In this case the synchronization circuit 300 additionally comprises a voltage controlled oscillator (VCO) 306, a frequency divider-by-M 307, a phase comparator 308 and an integrating filter 309 which are combined in a phase locked loop for producing a VCO 306 output signal of an M times higher frequency than that of the ON-OFF control signal produced by the APFC controller 201.

The VCO 306 output signal is further applied to the input of the frequency divider-by-M 307 for producing an output chain of pulses of an M times lower frequency than that of the VCO 306 output signal.

Both the ON-OFF control signal produced by the APFC controller 201 and the output signal of the frequency divider-by-M 307 are applied to the inputs of the phase comparator 308.

The output voltage of the phase comparator 308 is proportional to the difference between the frequencies of the signals applied to its inputs. This “error” signal is further smoothed by the integrating filter 309 to produce an “error” voltage for adjusting the VCO 306 such that the frequency of the output pulses of the frequency divider-by-M 307 will be equal to that of the ON-OFF control signal produced by the APFC controller 201.

Therefore, the frequency of the VCO 306 output pulses is automatically adjusted in accordance with that of the ON-OFF control signal produced by the APFC controller 201.

The output signal of the VCO 306 is further applied to the CLOCK input of the shift register 302.

The minimum value for the period T_{VCO} of the clocking signal u₃₀₆(t) should be defined by the acceptable tolerance δ (in %) with which the minimum operational period T_{PSmin} of the ON-OFF control signal u₂₀₁(t) should be repetitively reproduced, such that:

T_{VCOmin}≦0.01T_{PSmin}δ. [51]

An M-division factor should be defined as:

M=T_{PSmin}/T_{VCOmin}=100/δ. [52]

To operate all DC-DC power conversion channels 16(k) in a critical current mode, the APFC controller 201 produces an ON-OFF control signal of a variable operational frequency such that its period T_{PS}=var depends on the RMS and instantaneous values of the primary AC voltage, on the output current, etc.

Normally, the maximum operational period T_{PSmax} corresponds to the maximum output capacity and to the minimum value of the primary AC voltage, and the minimum operational period T_{PSmin} corresponds to zero output capacity and to the maximum value of the primary AC voltage, or to the instantaneous value of the primary AC voltage reaching zero.

An ON-OFF control signal u₂₀₁(t) is applied to the DATA input of the primary shift register 302.

Since being clocked by the VCO 306 output pulses of the M times proportional frequency, regardless of the initial frequency of the u₂₀₁(t) signal, the primary shift register 302 provides a set of evenly time-staggered output signals conformable to the u₂₀₁(t).

The leading edge of the high logic level ON-state pulse of the last-in-the-row-appointed “channel” signal u_{QC(N)}(t) is shifted in respect to the leading edge of the high logic level ON-state pulse of the u₂₀₁(t) signal for a maximum time-delay interval Δt_{Dmax} such that:

Δt_{Dmax}=T_{PSmin}(N−1)/N+T_{VCOmin}, [53]

Therefore, the “digital” length D₃₀₂, i.e. the quantity of the flip-flop cell q should be defined as:

D₃₀₂=Δt_{Dmax}/T_{VCOmin}, [54]

To provide the “channel” clocking signals u_{QC(k)}(t), the corresponding “channel” flip-flop cells q of the primary shift register 302 may be selected of those such that:

Q_{C(k)}=T_{PSmin}(k−1)/T_{VCOmin}N+1,(k=1,2, . . . , N) [55]

Therefore, all DC-DC power conversion channels are operated in an evenly time-staggered fashion.

To secure the constant t_{A} and t_{SS} intervals provided by the secondary shift register 304(k), it is clocked by the constant frequency signal outputted by the CPO 301.

The “digital” length D₃₀₄, i.e.the number of flip-flop cells q should be defined in accordance with [46].

The corresponding “channel” outputs of the secondary shift register 304(k) may be selected in accordance with [47] and [48].

Therefore, the t_{A} and t_{SS} intervals do not depend on the variable frequency of the u₂₀₁(t) signal.

This results in securing the provision of soft-switching conditions to all controllable switches regardless of the variations of the initial operational frequency.

To prevent the occurrence of continuous current mode within any power storage inductor 22(k), the zero-current detectors 32(k) postpone the starts of the successive operational cycles within the corresponding DC-DC power conversion channels 16(k).

An inductance value L₁ of the primary power carrying winding w₁ within each power storage inductor 22(k) should be chosen such that the critical current mode will be maintained over a full range of operational current variation, i.e. at least, for the minimum operational frequency, for the minimum AC input voltage and for the maximum output capacity.

FIG. 11(e,f) illustrate the time—scaled waveforms of currents and voltages attributed to the power conversion processes within the third embodiment of the switching-mode AC-DC power converter according to the present invention.

As can be seen, regardless of the critical current mode within the separate DC-DC power conversion channels, a high quality continuous current is maintained within the input and output circuitries of the AC-DC power converter.

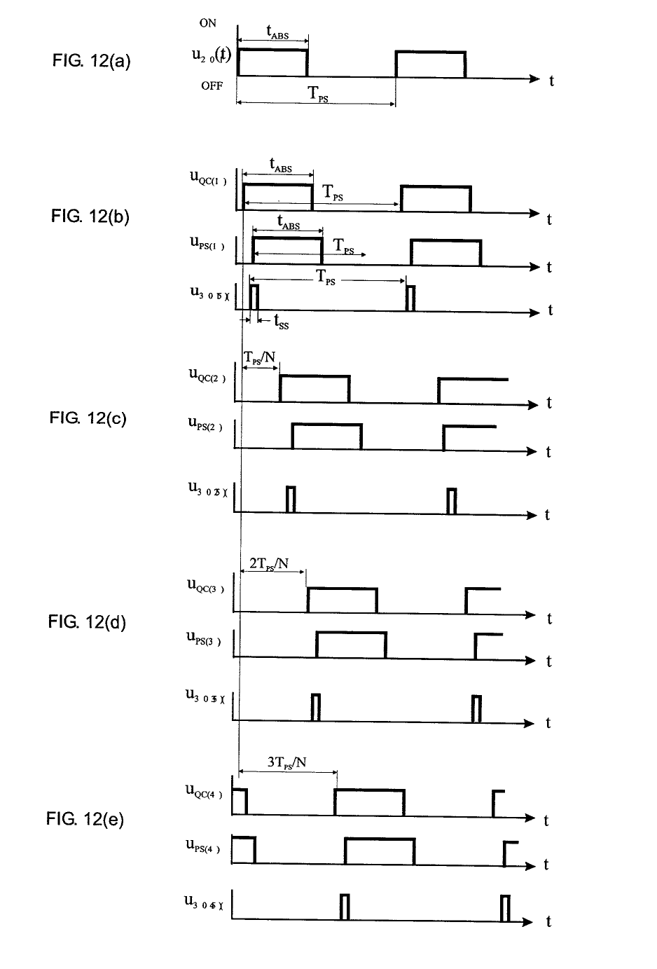

FIG. 12 illustrates the main principle of producing and arranging the time-staggered ON-OFF control signals for operating the multiple power conversion channels within the embodiments of the switching-mode AC-DC power converter according to the present invention.

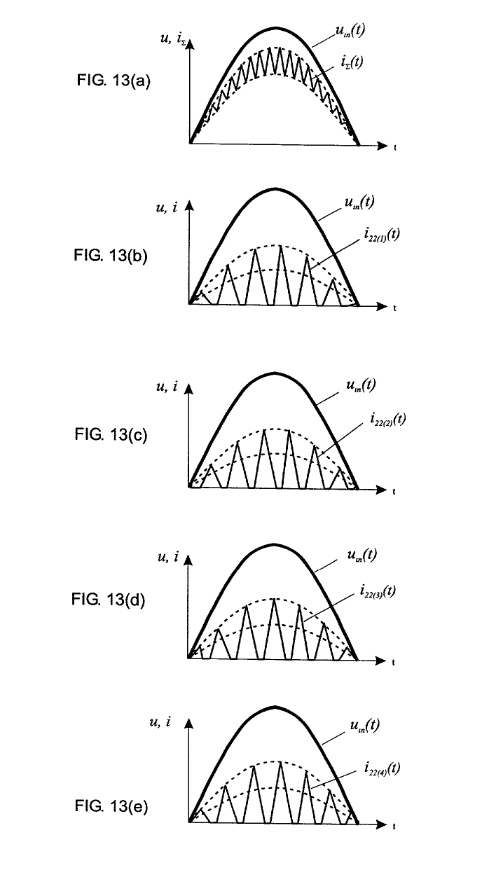

FIG. 13 illustrates the principle of providing the high quality continuous current mode to the primary AC power source while securing the discontinuous current mode within the separate DC-DC power conversion channels. The resultant input current waveform i_{Σ}(t) shown in FIG. 13(a) is produced by simultaneous summing the time-staggered input current waveforms i_{22(K)}(t) produced by the DC-DC power conversion channels.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A switching mode AC-DC power converter for converting the power from the primary AC power source into an output DC power defined by the load power consumption demand, said converter comprising at least:
an input means for being connected to the primary AC power source;
an output means for being connected to the system load;
a common return bus for providing a common return current path;
an input AC-DC rectifier for transforming the sine wave of the primary AC power source voltage into a half-sine wave of a rectified voltage;
a multi-channel DC-DC converter for converting an input rectified voltage into a regulated output DC voltage;
a system output smoothing filter for storing the power delivered to the system load and for absorbing the ripple component of the delivered power;
a control means for providing a feedback monitoring and producing the control signals;
said multi-channel DC-DC converter comprising N>1 number of unitary DC-DC power conversion channels, said unitary DC-DC power conversion channels comprising at least:
an input means for being connected to said input AC-DC rectifier;
an output means for being connected to said system output smoothing filter;
a channel noise inhibiting filter for inhibiting the high frequency ripple and electromagnetic interference;
a power storage inductor for accumulating the power absorbed from the primary AC power source via said input AC-DC rectifier and releasing the accumulated power to the system load;
a controllable power switch alternately turned into conducting state for providing the power absorption from the primary AC power source via said input AC-DC rectifier into said power storage inductor, and turned into non-conducting state for providing the power release from said power storage inductor to the system load;
a power blocking rectifier for disconnecting said channel output smoothing filter, said output means and the system load from said power storage inductor and from the primary AC power source while said controllable power switch is conducting, and providing a power release path from said power storage inductor to the system load while said controllable power switch is non-conducting;
a channel output smoothing filter for storing the power delivered to the system load and absorbing the ripple component of the delivered power;
an active soft switching conditioner connected via its nodes across said controllable power switch and across said power blocking rectifier for providing the soft switching zero-voltage-across/zero-current-through conditions within the time intervals of transitions between alternating conducting and non-conducting states, said active soft switching conditioner comprising at least:
a slope shaping capacitor;
a damp resonant choke;
a controllable commutating switch;
a shunting rectifier;
a separating rectifier; and
wherein the improvement is that:
said N>1 number of said unitary DC-DC power conversion channels is defined by increasing it up to the value such that the predetermined quality of the converted power ascribed with the power factor value, a regulated output DC voltage stability and overall efficiency is obtained, said AC-DC power converter comprises a synchronization means for providing at least two sets of synchronizing signals, and each set comprises N number of said synchronizing signals according to the number of said unitary DC-DC power conversion channels, and said synchronizing signals are timely arranged in a predetermined order; and wherein the further improvement is that:
said control means and said synchronization means operate all said controllable power switches and all said controllable commutating switches within all said unitary DC-DC power conversion channels of said multi-channel DC-DC converter such that:
low loss discontinuous current mode is maintained within each said unitary DC-DC power conversion channel; and high quality continuous current mode is maintained both within said input means and said output means of said AC-DC power converter; and low loss soft switching conditions are secured for all said controllable power switches and all said controllable commutating switches within all said unitary DC-DC power conversion channels of said multi-channel DC-DC converter.

2. A switching mode AC-DC power converter according to claim 1,
wherein the improvement is that:
said control means comprises at least:
an active power factor correction controller for accepting the functional input signals and for producing an output ON-OFF control signal such that each said unitary DC-DC power conversion channel maintains its predetermined order of operation for maintaining the predetermined quality of the converted power ascribed with power factor and regulated output DC voltage stability;
said ON-OFF control signal is a chain of ON-state pulses separated by OFF-state intervals, and each said ON-state pulse of said ON-OFF control signal has a leading edge and a trailing edge, and said leading edge and said trailing edge are timely arranged such that said trailing edge follows said leading edge, and said leading edge and said trailing edge are timely separated by a time interval of an ON-state duration of said ON-OFF control signal, and said ON-state duration of said ON-OFF control signal is equal to tABS absorption time interval corresponding to conducting state of said controllable power switch while said power storage inductor accumulates the power absorbed from the primary AC power source via said input AC-DC rectifier, and the time interval between the leading edges of the sequential ON-state pulses of said ON-OFF control signal is a period of said ON-state pulse of said ON-OFF control signal, and said period of said ON-state pulse of said ON-OFF control signal is equal to T_{ABS} power switch operation period; and wherein the further improvement is that:
said control circuit applies said ON-OFF control signal to said synchronization means, and said synchronization means precisely reproduces N times said ON-OFF control signal for producing N number of conformable ON-OFF control signal copies further named as t_{ABS}-signals for operating each said controllable power switch within each said unitary DC-DC power conversion channel, and each said t_{ABS}-signal is a chain of ON-state pulses separated by OFF-state intervals, and each said ON-state pulse of each said t_{ABS}-signal has a leading edge and a trailing edge, and said leading edge and said trailing edge are timely arranged such that said trailing edge follows said leading edge, and said leading edge and said trailing edge are timely separated by a time interval of an ON-state duration of said t_{ABS}-signal, and said ON-state duration of each said t_{ABS}-signal is equal to said t_{ABS} absorption time interval corresponding to conducting state of each said controllable power switch while each said power storage inductor accumulates the power absorbed from the primary AC power source via said input AC-DC rectifier, and the time interval between the leading edges of the sequential ON-state pulses of each said t_{ABS}-signal is a period of said ON-state pulse of said t_{ABS}-signal, and said period of said ON-state pulse of each said t_{ABS}-signal is equal to said T_{PS} power switch operation period, and
said t_{ABS}-signals form said first set of synchronizing signals for being distributed to all said unitary DC-DC power conversion channels of said multi-channel DC-DC power converter, and said synchronization means staggers timely said t_{ABS}-signals such that a time-displacement interval Δt_{dspl}=T_{PS}/N exists between the leading edges of said ON-state pulses of the sequential time-staggered t_{ABS}-signals, and said synchronization means distributes said t_{ABS}-signals to said unitary DC-DC power conversion channels of said multi-channel DC-DC power converter; and said synchronization means precisely reproduces N times a soft switching ON-OFF control signal for producing N number of conformable soft switching ON-OFF control signal copies further named as t_{SS}-signals for operating each said controllable commutating switch within each said active soft-switching conditioner, and each said t_{SS}-signal is a chain of ON-state pulses separated by OFF-state intervals, and each said ON-state pulse of said t_{SS}-signal has a leading edge and a trailing edge, and said leading edge and said trailing edge are timely arranged such that said trailing edge follows said leading edge, and
said leading edge and said trailing edge are timely separated by a time interval of an ON-state duration of said t_{SS}-signal, and
said ON-state duration of said t_{SS}-signal is equal to tss soft switching time interval corresponding to conducting state of each said controllable commutating switch within each said active soft-switching conditioner, and
the time interval between the leading edges of the sequential ON-state pulses of said t_{SS}-signal is a period of said ON-state pulse of said t_{SS}-signal, and said period of said ON-state pulse of said t_{SS}-signal is equal to said T_{PS} power switch operation period, and
said t_{SS}-signals form said second set of synchronizing signals to be distributed to all said unitary DC-DC power conversion channels of said multi-channel DC-DC power converter, and
said synchronization means time-staggers said t_{SS}-signals such that said time-displacement interval Δt_{dspl=T}_{PS/N} exists between the leading edges of said ON-state pulses of the sequential time-staggered t_{SS}-signals, and
said synchronization means distributes said t_{SS}-signals to said unitary DC-DC power conversion channels of said multi-channel DC-DC power converter, and
said synchronization means distributes said first set and said second set of said synchronizing signals across said multi-channel DC-DC power converter such that one said t_{ABS}-signal of said first set and one said t_{SS}-signal of said second set are provided to each corresponding unitary DC-DC power conversion channel, and each corresponding pair of one said t_{ABS}-signal and one said t_{SS}-signal are timely arranged such that a leading edge of each corresponding sequential ON-state pulse of said t_{SS}-signal precedes the leading edge of each corresponding sequential ON-state pulse of said t_{ABS}-signal for a t_{A} advance time interval such that each corresponding controllable commutating switch is turned into conducting state prior to corresponding controllable power switch being turned into conducting state, and
each corresponding pair of one said t_{ABS}-signal and one said t_{SS}-signal are timely arranged such that a trailing edge of each corresponding sequential ON-state pulse of said t_{SS}-signal recedes the leading edge of each corresponding sequential ON-state pulse of said t_{ABS}-signal in a t_{L} lag time interval such that each corresponding controllable commutating switch is turned into non-conducting state past to corresponding controllable power switch having been reliably turned into conducting state, and
during said t_{A} advance time interval the corresponding slope shaping capacitor within the corresponding active soft switching conditioner discharges in a resonant fashion for providing a zero-voltage-across condition to corresponding controllable power switch during its transition from non-conducting to conducting state.

3. A switching mode AC-DC power converter according to claim 2, wherein the improvement is that:
said control means further comprises at least:
an emergency monitoring means for preventing all said controllable switches within all said unitary DC-DC power conversion channels from being turned into conducting state as soon as the value of the regulated output DC voltage inadvertently exceeds the preset maximum threshold, and for enabling the operation of all said controllable switches within all said unitary DC-DC power conversion channels as soon as the value of the regulated output DC voltage falls below the preset minimum threshold in a hysteretic fashion.

4. A switching mode AC-DC power converter according to claim 3, wherein each said power storage inductor is of a tapless choke design, wherein the improvement is that:
an inductance value L of the power carrying winding within each said power storage inductor is chosen definitely such that the low loss discontinuous current mode is secured within said power storage inductor along a full range of operational current variation whereby minimizing the switching transition losses within the current commutating devices, and reducing the electrical stress upon the current carrying components, and employing the components with less power carrying capability, and enhancing the employment of components capacities resulted of their electric parameters.

5. A switching mode AC-DC power converter according to claim 3, wherein the improvement is that:
each said power storage inductor is of a tapped auto-transformer choke design, and
each said power storage inductor comprises a primary power carrying winding ascribed with w₁ number of turns, and a secondary power carrying winding ascribed with w₂ number of turns, and each said power storage inductor is ascribed with an auto-transformation factor n_{2/1}=w₂/w₁ such that n_{2/1}>1, and
wherein the improvement is that:
an inductance value L₁ of said primary power carrying winding w₁ within each said power storage inductor is chosen such that the low loss discontinuous current mode is insured within said power storage inductor over a full range of operational current variation thereby minimizing the switching transition losses within the current commutating devices, and reducing the electrical stress upon the current carrying components, and employing the components with less power carrying capability, and enhancing the employment of component s capacities resulted of their electric parameters.

6. A switching mode AC-DC power converter according to claims 4 and 5, wherein the improvement is that:
each said unitary DC-DC power conversion channel comprises a current monitoring means for detecting a non-zero release current flow within each said power storage inductor during the t_{RLS} release time interval of releasing the magnetically stored energy for securing the low loss discontinuous current mode, and
said current monitoring means comprises a zero-current detector, and
said synchronization means comprises a postponement means for postponing the successive operational cycle within any said unitary DC-DC power conversion channel for an indefinite postponement time interval tₚₚ by preventing the corresponding controllable power switch and corresponding controllable commutating switch from being turned into conducting state prior to the release current flow within the corresponding power storage inductor reaches zero whereby securing the low loss discontinuous current mode within corresponding unitary DC-DC power conversion channel.

7. A switching mode AC-DC power converter according to claim 6, wherein the improvement is that:
said power factor correction controller is a conventional power factor correction controller designed to secure the discontinuous current mode within a conventional single-channel AC-DC power converter of a pulse width modulation type;
said conventional power factor correction controller comprises a current feedback input; and
wherein the further improvement is that:
first-in-the-row appointed unitary DC-DC power conversion channel comprises at least:
an inductor current monitoring means for monitoring the current flow within corresponding power storage inductor such that:
said inductor current monitoring means monitors the current flows within both corresponding controllable power switch and corresponding power blocking rectifier, and
said inductor current monitoring means produces an output signal proportional to the current flow within said power storage inductor such that:
said inductor current monitoring means produces an output signal proportional to the current flows within said controllable power switch and said power blocking rectifier, and
said output signal of said inductor monitoring means is conformable to a current feedback signal of the single-channel AC-DC power converter of the same capacity as of recited AC-DC power converter according to claim 6, and
said output signal of said inductor current monitoring means is applied to said current feedback input of said conventional power factor correction controller for securing the predetermined quality of the converted power ascribed with power factor and regulated output DC voltage stability.

8. A switching mode AC-DC power converter according to claim 6, wherein the improvement is that:
said power factor correction controller is a conventional power factor correction controller designed to secure the continuous current mode within a conventional single-channel AC-DC power converter of a pulse width modulation type;
said conventional power factor correction controller comprises a current feedback input; and
wherein the further improvement is that:
first-in-the-row appointed unitary DC-DC power conversion channel comprises at least:
an inductor current monitoring means for monitoring the current flow within corresponding power storage inductor such that:
said inductor current monitoring means monitors the current flows within both corresponding controllable power switch and corresponding power blocking rectifier, and
said inductor current monitoring means produces an output signal proportional to the current flow within said power storage inductor such that:
said inductor current monitoring means produces an output signal proportional to the current flows within said controllable power switch and said power blocking rectifier, and
said AC-DC power converter comprises at least:
a total consumed current monitoring means for monitoring the total input current consumed by said AC-DC power converter,
said total consumed current monitoring means produces an output signal proportional to the total input current consumed by said AC-DC power converter; and
a summator of the current monitoring signals for summing the output signals both of said inductor current monitoring means and said total consumed current monitoring means,
said summator of the current monitoring signals produces a current feedback signal conformable to that of the single-channel AC-DC power converter of the same capacity as of said AC-DC power converter according to claim 6, and
said current feedback signal produced by said summator is applied to said current feedback input of said conventional power factor correction controller for securing the predetermined quality of the converted power ascribed with power factor and regulated output DC voltage stability.

9. A switching mode AC-DC power converter according to claim 6, wherein the improvement is that:
said power factor correction controller is a conventional power factor correction controller designed to secure the critical current mode and a variable operational frequency within a conventional single-channel AC-DC power converter;
said conventional power factor correction controller comprises a current feedback input; and said power factor correction controller produces a control signal of a variable operational frequency; and
wherein the further improvement is that:
first-in-the-row appointed unitary DC-DC power conversion channel comprises at least:
an inductor current monitoring means for monitoring the current flow within corresponding power storage inductor such that:
said inductor current monitoring means monitors the current flows within both corresponding controllable power switch and corresponding power blocking rectifier, and
said inductor current monitoring means produces an output signal proportional to the current flow within said power storage inductor such that:
said inductor current monitoring means produces an output signal proportional to the current flows within said controllable power switch and said power blocking rectifier, and
said output signal produced by said current monitoring means is applied to said current feedback input of said conventional power factor correction controller for securing the predetermined quality of the converted power ascribed with power factor and regulated output DC voltage stability; and
said synchronization means comprises at least:
a voltage controlled oscillator;
a frequency divider-by-M;
a phase comparator;
an integrating filter; and
said voltage controlled oscillator and said frequency divider-by-M and said phase comparator and said integrating filter are combined in a phase locked loop for producing a voltage controlled oscillator output signal of an M times higher frequency than that of said control signal produced by said power factor correction controller for driving said synchronization means producing said sets of said synchronizing signals.

10. A switching mode AC-DC power converter according to claim 9, wherein the improvement is that:
an inductance value L of the power carrying winding within each said power storage inductor is chosen such that the critical current mode is maintained within said power storage inductor along a full range of operational current variation whereby minimizing the switching transition losses within the current commutating devices, and reducing the electrical stress upon the current carrying components, and employing the components with less power carrying capability, and enhancing the employment of components capacities resulted of their electric parameters.

11. A switching mode AC-DC power converter according to claim 9, wherein the improvement is that:
each said power storage inductor is of a tapped auto-transformatory choke design, and
each said power storage inductor comprises a primary power carrying winding ascribed with w₁ number of turns, and a secondary current carrying winding ascribed with w₂ number of turns, and each said power storage inductor is ascribed with an auto-transformation factor n_{2/1}=W₂/w₁ such that n_{2/1}>1, and
an inductance value L₁ of said primary power carrying winding w₁ within each said power storage inductor is chosen such that the critical current mode is maintained within said power storage inductor along a full range of operational current variation whereby minimizing the switching transition losses within the current commutating devices, and reducing the electrical stress upon the current carrying components, and employing the components with less power carrying capability, and enhancing the employment of components capacities resulted of their electric parameters.

12. A method for a AC-DC conversion of power from the primary AC power source into an output DC power draw defined by the load power consumption demand performed in a switching mode AC-DC power converter with an active power factor correction, said converter comprising at least:
an input means for being connected to the primary AC power source;
an output means for being connected to the system load;
a common return bus for providing a common return current path;
an input AC-DC rectifier for transforming the sine wave of the primary AC power source voltage into a half-sine wave of a rectified voltage;
a multi-channel DC-DC converter for converting an input rectified voltage into a regulated output DC voltage;
a system output smoothing filter for storing the power delivered to the system load and absorbing the ripple component of the delivered power;
a control means for providing a feedback monitoring and producing the control signals;
said multi-channel DC-DC converter comprising N>1 number of unitary DC-DC power conversion channels;
each said unitary DC-DC power converters comprising at least:
an input means for being connected to said input AC-DC rectifier;
an output means for being connected to said output smoothing filter;
a channel noise inhibiting filter for inhibiting the high frequency ripple and electromagnetic interference;
a power storage inductor for accumulating the power absorbed from the primary AC power source via said input AC-DC rectifier and releasing the accumulated power to the system load;
a controllable power switch alternatively turned into conducting state for providing the power absorption from the primary AC power source via said input AC-DC rectifier into said power storage inductor, and turned into non-conducting state for providing the power release from said power storage inductor to the system load;
a power blocking rectifier for disconnecting said channel output smoothing filter, said output means and the system load from said power storage inductor and from the primary AC power source while said controllable power switch is conducting, and providing a power release path from said power storage inductor to the system load while said controllable power switch is non-conducting;
a channel output smoothing filter for storing the power delivered to the system load and absorbing the ripple component of the delivered power;
a current monitoring means for detecting a non-zero release current flow within each said power storage inductor during the t_{RLS} release time interval of releasing the magnetically stored energy for securing the low loss discontinuous current mode,
said current monitoring means comprises at a zero-current detector;
an active soft switching conditioner connected via its nodes across said controllable power switch and across said power blocking rectifier for providing the soft switching zero-voltage-across/zero-current-through conditions within the time intervals of alternative transitions between conducting and non-conducting states,
said active soft switching conditioner comprising at least:
a slope shaping capacitor;
a damp resonant choke;
a controllable commutating switch;
a shunting rectifier;
a separating rectifier;
said AC-DC power converter comprises a synchronization means for providing at least two sets of synchronizing signals, and
each set comprises N number of said synchronizing signals according to the number of said unitary DC-DC power conversion channels, and
said synchronizing signals are timely arranged in a predetermined order;
said control means and said synchronization means operate all said controllable power switches and all said controllable commutating switches within all said unitary DC-DC power conversion channels of said multi-channel DC-DC converter such that:
low loss discontinuous current mode is maintained within each said unitary DC-DC power conversion channel, and
high quality continuous current mode is maintained both within said input means and said output means of said AC-DC power converter, and
low loss soft switching conditions are maintained for all said controllable power switches and all said controllable commutating switches within all said unitary DC-DC power conversion channels of said multi-channel DC-DC converter;
said control means comprises at least:
an emergency monitoring means for preventing all said controllable switches within all said unitary DC-DC power conversion channels from being turned into conducting state as soon as the value of the regulated output DC voltage inadvertently exceeds the preset maximum threshold, and for enabling the operation of all said controllable switches within all said unitary DC-DC power conversion channels as soon as the value of the regulated output DC voltage falls below the preset minimum threshold in a hysteretic fashion;
said control means further comprises at least:
an active power factor correction controller for accepting the functional input signals and for producing an output ON-OFF control signal such that each said unitary DC-DC power conversion channel maintains its predetermined order of operation for securing the predetermined quality of the converted power ascribed with power factor and regulated output DC voltage stability;
said ON-OFF control signal is a chain of ON-state pulses separated by OFF-state intervals, and each said ON-state pulse of said ON-OFF control signal has a leading edge and a trailing edge, and said leading edge and said trailing edge are timely arranged such that said trailing edge follows said leading edge, and
said leading edge and said trailing edge are timely separated by a time interval of an ON-state duration of said ON-OFF control signal, and
said ON-state duration of said ON-OFF control signal is equal to tABS absorption time interval corresponding to conducting state of said controllable power switch while said power storage inductor accumulates the power absorbed from the AC primary power source via said input AC-DC rectifier, and
the time interval between the leading edges of the sequential ON-state pulses of ON-OFF control signal is a period of said ON-state pulse of said modulated ON-OFF control signal, and
said period of said ON-state pulse of said ON-OFF control signal is equal to Tp₅ power switch time interval; and
wherein the improvement is that:
said control circuit applies said ON-OFF control signal to said synchronization means, and
said synchronization means conformly reproduces N times said ON-OFF control signal for producing N number of conformable ON-OFF control signal copies further named as t_{ABS}-signals for operating each said controllable power switch within each said unitary DC-DC power conversion channel, and
each said t_{ABS}-signal is a chain of ON-state pulses separated by OFF-state intervals, and
each said ON-state pulse of each said t_{ABS}-signal has a leading edge and a trailing edge, and
said leading edge and said trailing edge are timely arranged such that said trailing edge follows said leading edge, and
said leading edge and said trailing edge are timely separated by a time interval of an ON-state duration of said t_{ABS}-signal, and
said ON-state duration of each said t_{ABS}-signal is equal to said tABS absorption time interval corresponding to conducting state of each said controllable power switch while each said power storage inductor accumulates the power absorbed from the AC primary power source via said input AC-DC rectifier, and
the time interval between the leading edges of the sequential ON-state pulses of each said t_{ABS}-signal is a period of said ON-state pulse of said t_{ABS}-signal, and
said period of said ON-state pulse of each said t_{ABS}-signal is equal to said T_{PS} power switch time interval, and
said t_{ABS}-signals form said first set of synchronizing signals for being distributed to all said unitary DC-DC power conversion channels of said multi-channel DC-DC power converter, and
said synchronization means staggers timely said t_{ABS}-signals such that a time-displacement interval Δt_{dspl}=T_{PS}/N exists between the leading edges of said ON-state pulses of the sequential time-staggered t_{ABS}-signals, and
said synchronization means distributes said t_{ABS}-signals to said unitary DC-DC power conversion channels of said multi-channel DC-DC power converter; and
said synchronization means conformly reproduces N times a soft switching ON-OFF control signal for producing N number of conformable soft switching ON-OFF control signal copies further named as t_{SS}-signals for operating each said controllable commutating switch within each said active soft-switching conditioner, and
each said t_{SS}-signal is a chain of ON-state pulses separated by OFF-state intervals, and
each said ON-state pulse of said t_{SS}-signal has a leading edge and a trailing edge, and said leading edge and said trailing edge are timely arranged such that said trailing edge follows said leading edge, and
said leading edge and said trailing edge are timely separated by a time interval of an ON-state duration of said t_{SS}-signal, and
said ON-state duration of said t_{SS}-signal is equal to tss soft switching time interval corresponding to conducting state of each said controllable commutating switch within each said active soft-switching conditioner, and
the time interval between the leading edges of the sequential ON-state pulses of said t_{SS}-signal is a period of said ON-state pulse of said t_{SS}-signal, and said period of said ON-state pulse of said t_{SS}-signal is equal to said T_{PS} power switch time interval, and
said t_{SS}-signals form said second set of synchronizing signals for being distributed to all said unitary DC-DC power conversion channels of said multi-channel DC-DC power converter, and
said synchronization means staggers timely said t_{SS}-signals such that said time-displacement interval Δt_{dspl}=T_{PS}/N exists between the leading edges of said ON-state pulses of the sequential time-staggered t_{SS}-signals, and
said synchronization means distributes said t_{SS}-signals to said unitary DC-DC power conversion channels of said multi-channel DC-DC power converter, and
said synchronization means distributes said first set and said second set of said synchronizing signals across said multi-channel DC-DC power converter such that one said t_{ABS}-signal of said first set and one said t_{SS}-signal of said second set are provided to each corresponding unitary DC-DC power conversion channel, and
each corresponding pair of one said t_{ABS}-signal and one said t_{SS}-signal are timely arranged such that a leading edge of each corresponding sequential ON-state pulse of said t^{SS}-signal precedes the leading edge of each corresponding sequential ON-state pulse of said t_{ABS}-signal for a t_{A} advance time interval such that each corresponding controllable commutating switch is turned into conducting state prior to corresponding controllable power switch being turned into conducting state, and
each corresponding pair of one said t_{ABS}-signal and one said t_{SS}-signal are timely arranged such that a trailing edge of each corresponding sequential ON-state pulse of said t_{SS}-signal recedes the leading edge of each corresponding sequential ON-state pulse of said t_{ABS}-signal in a t_{L} lag time interval such that each corresponding controllable commutating switch is turned into non-conducting state past to corresponding controllable power switch having been reliably turned into conducting state, and during said t_{A} advance time interval the corresponding slope shaping capacitor within the corresponding active soft switching conditioner discharges in a resonant fashion for providing a zero-voltage-across condition to corresponding controllable power switch during its transition from non-conducting to conducting state;
said synchronization means further comprises at least:
a postponement means for postponing the successive operational cycle within any said unitary DC-DC power conversion channel for a tp indefinite postponement time interval by preventing the corresponding controllable power switch and corresponding controllable commutating switch from being turned into conducting state prior to the release current flow within the corresponding power storage inductor reaches zero whereby securing the low loss discontinuous current mode within corresponding unitary DC-DC power conversion channel;
said method comprises the steps of:
a) defining the overall AC-DC power converter configuration;
c) defining the appropriate current mode within each said power storage inductor;
d) defining the appropriate type and design of said power factor correction controller;
wherein the improvement is that the following steps are:
e) defining said N>1 number of said unitary DC-DC power conversion channels by increasing it up to the value such that the predetermined quality of the converted power ascribed with the power factor value, a regulated output DC voltage stability and overall efficiency is maintained; and
e) defining said control means configuration; and
f) defining said synchronization means configuration; and
g) providing said power factor correction controller with appropriate functional input signals for providing said synchronization means with a resultant ON-OFF control signal such that each said unitary DC-DC power conversion channel maintains its proper performance to secure the overall system output quality ascribed with high power factor and regulated output DC voltage stability, and such that:
said ON-OFF control signal is a chain of ON-state pulses separated by OFF-state intervals, and each said ON-state pulse of said ON-OFF control signal has a leading edge and a trailing edge, and said leading edge and said trailing edge are timely arranged such that said trailing edge follows said leading edge, and
said leading edge and said trailing edge are timely separated by a time interval of an ON-state duration of said ON-OFF control signal, and
said ON-state duration of said ON-OFF control signal is equal to tABS absorption time interval corresponding to conducting state of said controllable power switch while said power storage inductor accumulates the power absorbed from the AC primary power source via said input AC-DC rectifier, and
the time interval between the leading edges of the sequential ON-state pulses of ON-OFF control signal is a period of said ON-state pulse of said modulated ON-OFF control signal, and said period of said ON-state pulse of said ON-OFF control signal is equal to T_{PS} power switch operation period, and said ON-OFF control signal is further applied to said synchronization means; and
h) reproducing conformly N times said ON-OFF control signal for producing N number of conformable ON-OFF control signal copies further named as tABS -signals for operating each said controllable power switch within each said unitary DC-DC power conversion channel, such that: each
said t_{ABS}-signal is a chain of ON-state pulses separated by OFF-state intervals, and each said ON-state pulse of each said t_{ABS}-signal has a leading edge and a trailing edge, and said leading edge and said trailing edge are timely arranged such that said trailing edge follows said leading edge, and
said leading edge and said trailing edge are timely separated by a time interval of an ON-state duration of said t_{ABS}-signal, and
said ON-state duration of each said t_{ABS}-signal is equal to said t_{ABS} absorption time interval corresponding to conducting state of each said controllable power switch while each said power storage inductor accumulates the power absorbed from the AC primary power source via said input AC-DC rectifier, and the time interval between the leading edges of the sequential ON-state pulses of each said t_{ABS}-signal is a period of said ON-state pulse of said t_{ABS}-signal, and said period of said ON-state pulse of each said t_{ABS}-signal is equal to said T_{PS} power switch operation period, and
said t_{ABS}-signals form said first set of synchronizing signals for being distributed to all said unitary DC-DC power conversion channels of said multi-channel DC-DC power converter; and
i) staggering timely said t_{ABS}-signals such that a time-displacement interval Δt_{dspl}=T_{PS}/N exists between the leading edges of said ON-state pulses of the sequential time-staggered t_{ABS}-signals; and
j) distributing said t_{ABS}-signals to said unitary DC-DC power conversion channels of said multi-channel DC-DC power converter; and
k) conformly reproducing N times a soft switching ON-OFF control signal for producing N number of conformable soft switching ON-OFF control signal copies further named as t_{SS}-signals for operating each said controllable commutating switch within each said active soft-switching conditioner such that:
each said t_{SS}-signal is a chain of ON-state pulses separated by OFF-state intervals, and
each said ON-state pulse of said t_{SS}-signal has a leading edge and a trailing edge, and said leading edge and said trailing edge are timely arranged such that said trailing edge follows said leading edge, and
said leading edge and said trailing edge are timely separated by a time interval of an ON-state duration of said t_{SS}-signal, and
said ON-state duration of said t_{SS}-signal is equal to tss soft switching time interval corresponding to conducting state of each said controllable commutating switch within each said active soft-switching conditioner, and the time interval between the leading edges of the sequential ON-state pulses of said t_{SS}-signal is a period of said ON-state pulse of said t_{SS}-signal, and
said period of said ON-state pulse of said t_{SS}-signal is equal to said T_{PS} power switch operation period, and
said t_{SS}-signals form said second set of synchronizing signals for being distributed to all said unitary DC-DC power conversion channels of said multi-channel DC-DC power converter, and
l) staggering timely said t_{SS}-signals such that said time-displacement interval Δt_{dspl}=T_{PS}/N exists between the leading edges of said ON-state pulses of the sequential time-staggered t_{SS}-signals; and
m) distributing said t_{SS}-signals to said unitary DC-DC power conversion channels of said multi-channel DC-DC power converter; and
n) distributing said first set and said second set of said synchronizing signals across said multi-channel DC-DC power converter such that one said t_{ABS}-signal of said first set and one said t_{SS}-signal of said second set are provided to each corresponding unitary DC-DC power conversion channel; and
o) arranging timely each corresponding pair of one said t_{ABS}-signal and one said t_{SS}-signal such that a leading edge of each corresponding sequential ON-state pulse of said t_{SS}-signal precedes the leading edge of each corresponding sequential ON-state pulse of said t_{ABS}-signal for a t_{A} advance time interval such that each corresponding controllable commutating switch is turned into conducting state prior to corresponding controllable power switch being turned into conducting state; and
p) arranging timely each corresponding pair of one said t_{ABS}-signal and one said t_{SS}-signal such that a trailing edge of each corresponding sequential ON-state pulse of said t_{SS}-signal recedes the leading edge of each corresponding sequential ON-state pulse of said t_{ABS}-signal in a t_{L} lag time interval such that each corresponding controllable commutating switch is turned into non-conducting state past to corresponding controllable power switch having been reliably turned into conducting state, and
q) discharging in a resonant fashion during said tA advance time interval the corresponding slope shaping capacitor within the corresponding active soft switching conditioner discharges in a resonant fashion for providing a zero-voltage-across condition to corresponding controllable power switch during its transition from non-conducting to conducting state;
r) monitoring the value of the regulated output DC voltage of said AC-DC power converter; and
s) detecting the value of the regulated output DC voltage inadvertently exceeding the preset maximum threshold; and
t) preventing all said controllable switches within all said unitary DC-DC power conversion channels for indefinite time from being turned into conducting state as soon as the value of the regulated output DC voltage inadvertently exceeds the preset maximum threshold, and
u) enabling the operation of all said controllable switches within all said unitary DC-DC power conversion channels as soon as the value of the regulated output DC voltage falls below the preset minimum threshold in a hysteretic fashion; and
v) monitoring the non-zero release current flow within each said power storage inductor during the tRLS release time interval of releasing the magnetically stored energy; and
w) detecting the non-zero release current flow within each said power storage inductor during the t_{RLS} release time interval of releasing the magnetically stored energy; and
x) postponing the successive operational cycle within any said unitary DC-DC power conversion channel for a tₚₚ indefinite postponement time interval by preventing the corresponding controllable power switch and corresponding controllable commutating switch from being turned into conducting state prior to the release current flow within the corresponding power storage inductor reaches zero whereby securing the low loss discontinuous current mode within corresponding unitary DC-DC power conversion channel.

13. In a method according to claim 12, wherein each said power storage inductor is of a tapless choke design, the improvement is that the following step is:
choosing an inductance value L of the power carrying winding within each said power storage inductor such that the discontinuous current mode is maintained within said power storage inductor along a full range of operational current variation whereby minimizing the switching transition losses within the current commutating devices, and reducing the electrical stress upon the current carrying components, and employing the components with less power carrying capability, and enhancing the employment of components capacities resulted of their electric parameters.

14. In a method according to claim 12, the improvement is that the following steps are:
choosing the tapped auto-transformatory choke design for each said power storage inductor such that each said power storage inductor comprises a primary power carrying winding ascribed with w₁ number of turns and a secondary current carrying winding ascribed with w₂ number of turns, and such that:
each said power storage inductor is ascribed with an auto-transformation factor n_{2/1}=w₂/w₁ such that n_{2/1}>1; and
choosing an inductance value L₁ of said primary power carrying winding w₁ within each said power storage inductor such that the low loss discontinuous current mode is maintained within said power storage inductor along a full range of operational current variation whereby minimizing the switching transition losses within the current commutating devices, and reducing the electrical stress upon the current carrying components, and employing the components with less power carrying capability, and enhancing the employment of components capacities resulted of their electric parameters.

15. A method according to claim 12, wherein said power factor correction controller is a conventional power factor correction controller designed to secure the discontinuous current mode within a conventional single-channel AC-DC power converter of a pulse width modulation type, said conventional power factor correction controller comprises a current feedback input; and wherein the improvement is that the following steps are:
including into the first-in-the-row appointed said unitary DC-DC power conversion channel at least an inductor current sensing means for monitoring the current flow within corresponding power storage inductor such that:
said inductor current sensing means monitors the current flows within both corresponding controllable power switch and corresponding power blocking rectifier, and
producing by said inductor current sensing means an output signal proportional to the current flow within said power storage inductor such that:
said inductor current sensing means produces an output signal proportional to the current flows within said controllable power switch and said power blocking rectifier, and
applying said output signal produced by said current sensing means to said current feedback input of said conventional power factor controller for securing the predetermined quality of the converted power ascribed with the power factor value and regulated output DC voltage stability.

16. A method according to claim 12, wherein said power factor correction controller is a conventional power factor correction controller designed to secure the continuous current mode within a conventional single-channel AC-DC power converter of a pulse width modulation type, said conventional power factor correction controller comprises a current feedback input; and wherein the improvement is that the following steps are:
a) including into the first-in-the-row appointed said unitary DC-DC power conversion channel at least an inductor current sensing means for monitoring the current flow within corresponding power storage inductor such that: said inductor current sensing means monitors the current flows within both corresponding controllable power switch and corresponding power blocking rectifier, and
b) producing by said inductor current sensing means an output signal proportional to the current flow within said power storage inductor such that: said inductor current sensing means produces an output signal proportional to the current flows within said controllable power switch and said power blocking rectifier, and
c) including into said AC-DC power converter at least: a total consumed current sensing means for sensing the total input current consumed by said AC-DC power converter such that said total consumed current sensing means produces an output signal proportional to the total input current consumed by said AC-DC power converter, and
a summator of current sensing signals for summing the output signals both of said inductor current sensing means and said total consumed current sensing means, and
d) summing the output signals both of said inductor current sensing means and said total consumed current sensing means such that said summator of current sensing signals produces a current feedback signal conformable to that of the single-channel AC-DC power converter of the same capacity and according to the design of the conventional power factor correction controller, and
e) applying said current feedback signal produced by said summator to said current feedback input of said conventional power factor controller for securing the predetermined quality of the converted power ascribed with power factor value and regulated output DC voltage stability.

17. A method according to claim 12 wherein said power factor correction controller is a conventional power factor correction controller designed to secure the critical current mode and a variable operational frequency within a conventional single-channel AC-DC power converter, said conventional power factor correction controller comprises a current feedback input, and said power factor correction controller produces a control signal of a variable operational frequency; and wherein the improvement is that the following steps are:
including into the first-in-the-row appointed said unitary DC-DC power conversion channel at least an inductor current sensing means for monitoring the current flow within corresponding power storage inductor such that:
said inductor current sensing means monitors the current flows within both corresponding controllable power switch and corresponding power blocking rectifier, and
producing by said inductor current sensing means an output signal proportional to the current flow within said power storage inductor such that:
said inductor current sensing means produces an output signal proportional to the current flows within said controllable power switch and said power blocking rectifier, and
applying said output signal produced by said current sensing means to said current feedback input of said conventional power factor controller for securing the predetermined quality of the converted power ascribed with the power factor value and regulated output DC voltage stability; and
including into said synchronization means at least:
a voltage controlled oscillator, and
a frequency divider-by-M, and
a phase comparator, and
an integrating filter such that:
said voltage controlled oscillator and said frequency divider-by-M and said phase comparator and said integrating filter are combined in a phase locked loop for producing a voltage controlled oscillator output signal of an M times higher frequency than that of said control signal produced by said power factor correction controller, and
driving said synchronization means with a voltage controlled oscillator output signal for producing said sets of said synchronizing signals.

18. In a method according to claim 17, wherein each said power storage inductor is of a tapless choke design, the improvement is that the following step is:
choosing an inductance value L of the power carrying winding within each said power storage inductor such that the critical current mode is maintained within said power storage inductor along a full range of operational current variation whereby
minimizing the switching transition losses within the current commutating devices, and
reducing the electrical stress upon the current carrying components, and employing the components with less power carrying capability, and enhancing the employment of components capacities resulted of their electric parameters.

19. In a method according to claim 17, wherein the improvement is that the following steps are:
a) choosing the tapped auto-transformatory choke design for each said power storage inductor such that each said power storage inductor comprises a primary power carrying winding ascribed with w₁ number of turns and a secondary current carrying winding ascribed with w₂ number of turns, and such that:
each said power storage inductor is ascribed with an auto-transformation factor n_{2/1}=w₂/w₁ such that n_{2/1}>1; and
c) choosing an inductance value L₁ of said primary power carrying winding w₁ within each said power storage inductor such that the critical current mode is maintained within said power storage inductor along a full range of operational current variation whereby minimizing the switching transition losses within the current commutating devices, and reducing the electrical stress upon the current carrying components, and employing the components with less power carrying capability, and enhancing the employment of components capacities resulted of their electric parameters.
